(19) United States
(12) Patent Application Publication
(10) Pub. No.: US 2026/0138375 A1
(43) Pub. Date: May 21, 2026

(54) LIQUID DISCHARGE APPARATUS

(71) Applicant: CANON KABUSHIKI KAISHA, Tokyo (JP)

(72) Inventors: TATSUKI SASAKI, Kanagawa (JP); TAKASHI ABE, Kanagawa (JP); KOUSUKE TANAKA, Kanagawa (JP)

(21) Appl. No.: 19/386,064

(22) Filed: Nov. 11, 2025

(30) Foreign Application Priority Data
Nov. 21, 2024 (JP) 2024-203065

(51) Int. Cl. B41J 2/19; B41J 2/055; B41J 2/17; B41J 2/175; B41J 2/18

(52) U.S. Cl. CPC B41J 2/19; B41J 2/055; B41J 2/1707; B41J 2/17523; B41J 2/17596; B41J 2/18; B41J 2202/07

(57) ABSTRACT

A liquid discharge apparatus includes a liquid discharge head including a liquid storage chamber configured to store liquid and a liquid discharge unit configured to discharge the liquid supplied from the liquid storage chamber, a connection unit for the liquid discharge head, and a depressurization mechanism communicating with the connection unit, wherein the connection unit includes a liquid channel configured to supply the liquid to the liquid storage chamber and a gas channel communicating with the depressurization mechanism, wherein the gas channel includes a valve member configured to switch gas communication between a closed state and an open state, and a biasing member configured to bias the valve member from the open state to the closed state, and wherein the valve member is configured so that its closed state and open state are switched by the depressurization mechanism pressurizing or depressurizing part of the gas channel.

### BACKGROUND

### Field of the Technology

The present disclosure relates to a liquid discharge apparatus.

### Description of the Related Art

In liquid discharge apparatuses, bubbles may get mixed in when a tank or a liquid discharge head is replaced, among other occasions. If these bubbes enter pressure chambers of the liquid discharge head, sufficient pressure for discharging liquid such as ink may fail to be obtained, and the liquid discharge performance can be affected. Moreover, if bubbles remain in the flow channels of the liquid discharge head, the bubbles may expand because of changes in the external environment of the liquid discharge apparatus, potentially causing liquid leakage and the like. To improve the use stability of the liquid discharge apparatus and the liquid discharge head, a configuration capable of expelling bubbles having entered the interior of the liquid discharge head to the outside can be employed.

Japanese Patent Laid-Open No. 2010-208188 describes a liquid discharge apparatus including a degassing unit. In the configuration described in Japanese Patent Laid-Open No. 2010-208188, a switching valve is disposed between a depressurization pump and a pressure adjustment chamber to be depressurized, and the connection between the depressurization pump and the pressure adjustment chamber is switched open and closed by controlling the switching valve. This necessitates control of the switching valve aside from the pump depressurization operation.

According to Japanese Patent Laid-Open No. 2010-208188, the need to control the switching valve aside from the pump depressurization operation complicates control.

### SUMMARY

The present disclosure is directed to improving the use stability of a liquid discharge apparatus.

A liquid discharge apparatus according to some embodiments of the present disclosure includes a liquid discharge head including a liquid storage chamber configured to store liquid and a liquid discharge unit configured to discharge the liquid supplied from the liquid storage chamber, a connection unit for the liquid discharge head, and a depressurization mechanism communicating with the connection unit, wherein the connection unit includes a liquid channel configured to supply the liquid to the liquid storage chamber and a gas channel communicating with the depressurization mechanism, wherein the gas channel includes a valve member configured to switch gas communication between a closed state and an open state, and a biasing member configured to bias the valve member from the open state to the closed state, and wherein the valve member is configured so that its closed state and open state are switched by the depressurization mechanism pressurizing or depressurizing part of the gas channel.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are diagrams for describing a liquid discharge apparatus.

FIG. 2 is a schematic diagram illustrating flow channels of an ink supply unit.

FIG. 3 is a schematic diagram for describing a pressure chamber pressurization operation.

FIG. 4 is a schematic diagram for describing a pressurization maintenance operation.

FIG. 5 is a schematic diagram for describing an ink replenishment operation.

FIG. 6 is a schematic diagram for describing a debubbling depressurization operation.

FIG. 7 is an exploded perspective view of a liquid discharge head.

FIG. 8A is a sectional view of the liquid discharge head.

FIG. 8B is a sectional view of a discharge module.

FIG. 9 is a schematic external view of a circulation unit.

FIGS. 10A and 10B are longitudinal sectional views illustrating a circulation path.

FIG. 11 is a block diagram schematically illustrating the circulation path.

FIGS. 12A to 12C are sectional views illustrating an example of a pressure adjustment unit.

FIGS. 13A and 13B are external perspective views of a circulation pump.

FIG. 14 is a sectional view of the circulation pump illustrated in FIG. 13A, taken along line XIV-XIV.

FIGS. 15A to 15E are diagrams for describing ink flow within the liquid discharge head.

FIGS. 16A and 16B are schematic diagrams illustrating a circulation path in the discharge unit.

FIG. 17 is a diagram illustrating an opening plate.

FIG. 18 is a diagram illustrating a discharge element substrate.

FIGS. 19A to 19C are sectional views illustrating ink flow in the discharge unit.

FIGS. 20A and 20B are sectional views illustrating the vicinity of a nozzle.

FIGS. 21A and 21B are sectional views illustrating a comparative example of the vicinity of a nozzle.

FIG. 22 is a diagram illustrating a comparative example of the discharge element substrate.

FIGS. 23A and 23B are diagrams illustrating a channel configuration of a liquid discharge head.

FIGS. 24A and 24B are diagrams schematically illustrating ink backflow near nozzles.

FIGS. 25A and 25B are diagrams for describing ink supply in the discharge module.

FIG. 26 is a schematic diagram illustrating how a main body unit of the liquid discharge apparatus and the liquid discharge head are connected.

FIGS. 27A and 27B are schematic diagrams illustrating a debubbling unit.

FIGS. 28A and 28B are sectional views illustrating modifications of the debubbling unit.

FIG. 29 is a sectional view illustrating a modification of a deformation suppression member.

FIGS. 30A to 30C are schematic diagrams illustrating modifications of the deformation suppression member.

FIGS. 31A to 31C are schematic diagrams illustrating initial filling and operation of the debubbling units.

FIG. 32 is a diagram schematically illustrating a first configuration example of an ink path.

FIG. 33 is a diagram schematically illustrating a first modification of the circulation path.

FIGS. 34A to 34D are diagrams schematically illustrating the vicinity of a heating circulation pump.

FIG. 35 is a diagram schematically illustrating the first modification of the circulation path.

FIG. 36 is a diagram schematically illustrating a second modification of the circulation path.

FIG. 37 is a diagram schematically illustrating the second modification of the circulation path.

FIG. 38 is a diagram schematically illustrating a third modification of the circulation path.

FIG. 39 is a diagram schematically illustrating the third modification of the circulation path.

FIG. 40 is a diagram schematically illustrating a second configuration example of the ink path.

FIG. 41 is a diagram schematically illustrating a fourth modification of the circulation path.

FIG. 42 is a diagram schematically illustrating the fourth modification of the circulation path.

FIG. 43 is a diagram schematically illustrating a fifth modification of the circulation path.

FIG. 44 is a diagram schematically illustrating the fifth modification of the circulation path.

FIG. 45 is a diagram schematically illustrating a sixth modification of the circulation path.

FIG. 46 is a diagram schematically illustrating the sixth modification of the circulation path.

FIG. 47 is a block diagram schematically illustrating another modification of the circulation path.

FIG. 48 is a block diagram schematically illustrating another modification of the circulation path.

FIG. 49 is a block diagram schematically illustrating another modification of the circulation path.

FIG. 50 is a sectional perspective view of a head-side connection member.

FIG. 51 is a sectional view illustrating a state where the head-side connection member and a main body-side connection member are coupled.

FIG. 52 is a sectional view illustrating a closed state of a degassing needle.

FIG. 53 is a sectional view illustrating an open state of the degassing needle.

### DESCRIPTION OF THE EMBODIMENTS

Various exemplary embodiments, features, and aspects of the present disclosure will be described in detail below with reference to the attached drawings. The following embodiments are not intended to limit the present disclosure, and all combinations of features described in the embodiments are not necessarily essential to the solving means of the present disclosure. The same components are denoted by the same reference numerals. The present embodiment will be described using an example where discharge elements for discharging liquid employ a thermal method of discharging liquid by producing bubbles with electrothermal transducers. However, this is not restrictive. The present embodiment is also applicable to a liquid discharge head that employs a discharge method of discharging liquid using piezoelectric elements or other discharge methods. Moreover, pumps, pressure adjustment units, and the like to be described below are not limited to the exact configurations described in the embodiments or illustrated in the drawings, either. In the following description, a basic configuration of the present disclosure will initially be described, and then characteristic parts of the present disclosure will be described.

### <Liquid Discharge Apparatus>

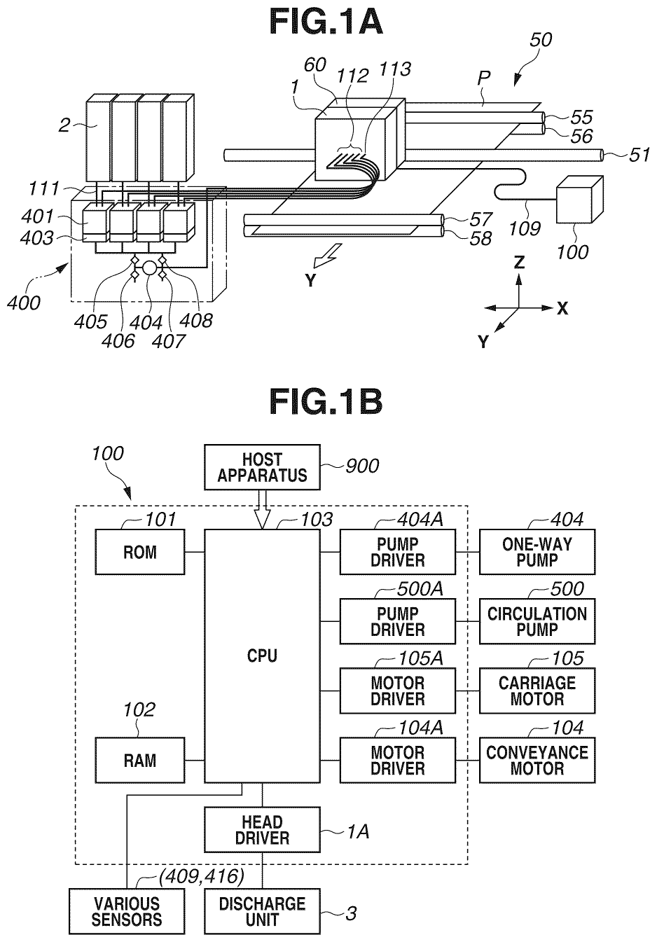

FIGS. 1A and 1B are diagrams for describing a liquid discharge apparatus. FIG. 1A is an enlarged view of a liquid discharge head of the liquid discharge apparatus and its vicinity. A schematic configuration of a liquid discharge apparatus 50 according to the present embodiment will initially be described with reference to FIGS. 1A and 1B. FIG. 1A is a perspective view schematically illustrating the liquid discharge apparatus 50 where a liquid discharge head 1 can be mounted. The liquid discharge apparatus 50 according to the present embodiment constitutes a serial inkjet recording apparatus that performs recording on recording media P by discharging ink that is liquid while scanning the liquid discharge head 1.

The liquid discharge head 1 is mounted on a carriage 60. The carriage 60 reciprocates in a main scanning direction (X direction) along a guide shaft 51. A recording medium P is conveyed in a sub scanning direction (Y direction) intersecting (in this example, orthogonal to) the main scanning direction by upstream conveyance rollers 55 and 56 and downstream conveyance rollers 57 and 58. In the diagrams to be referred to below, a Z direction represents a vertical direction, which intersects (in this example, is orthogonal to) an X-Y plane defined by the X direction and the Y direction. The liquid discharge head 1 is configured so that users can attach and detach the liquid discharge head 1 to/from the carriage 60.

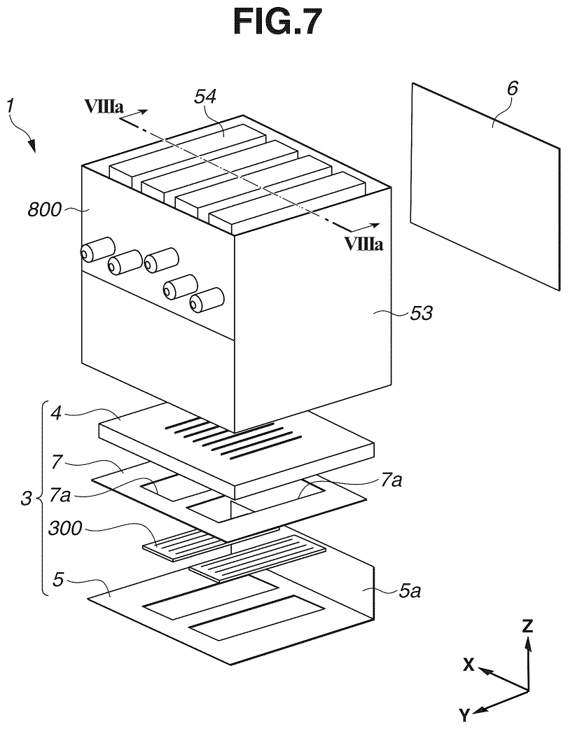

The liquid discharge head 1 includes circulation units 54 (see FIG. 7) and a discharge unit 3 (see FIG. 7) to be described below. The discharge unit 3 includes a plurality of nozzles and energy generation elements (hereinafter, referred to as discharge elements) that generate discharge energy for discharging liquid from the respective nozzles. A specific configuration thereof will be described below.

The liquid discharge apparatus 50 also includes ink tanks 2 that are ink supply sources, and an ink supply unit 400. Inks stored in the ink tanks 2 are supplied to the liquid discharge head 1 by the ink supply unit 400 via first supply paths 111 and second supply paths 112.

Gas such as bubbles occurring in the liquid discharge head 1 is exhausted out of the liquid discharge head 1 by the ink supply unit 400 via a third air channel 113.

The liquid discharge apparatus 50 forms a predetermined image on a recording medium P by repeating a recording scan and a conveyance operation. The recording scan includes performing recording by discharging ink while the liquid discharge head 1 mounted on the carriage 60 moves in the main scanning direction. The conveyance operation includes conveying the recording medium P in the sub scanning direction. The liquid discharge head 1 according to the present embodiment can discharge four types of inks, namely, black (K), cyan (C), magenta (M), and yellow (Y) inks, and can record full-color images using these inks. However, the inks that the liquid discharge head 1 can discharge are not limited to the foregoing four types. The present disclosure is also applicable to liquid discharge heads for discharging other types of inks. In other words, the types and number of inks to be discharged from the liquid discharge head 1 are not limited. For example, the number of types of inks discharged from the liquid discharge head may be one, two, three, or five or more.

The liquid discharge apparatus 50 includes a control unit 100 and a cap member (not illustrated) that can cover the nozzle surface of the liquid discharge head 1 where the nozzles are formed. The cap member is located off the conveyance path of the recording medium P in the X direction within the liquid discharge apparatus 50.

The cap member covers the nozzle surface of the liquid discharge head 1 when not in recording operations, and is used for nozzle drying prevention, nozzle protection, and ink suction operation on the nozzles. Signals output from the control unit 100 are transmitted to the liquid discharge head 1 and the like via a signal line 109.

FIG. 1B is a block diagram illustrating a control system of the liquid discharge apparatus 50. The control unit 100 of the liquid discharge apparatus 50 includes a central processing unit (CPU) 103, a random access memory (RAM) 102, a read-only memory (ROM) 101, a head driver 1A, motor drivers 104A and 105A, and pump drivers 404A and 500A. The CPU 103 plays the role of a control unit that controls operation of various components of the liquid discharge apparatus 50 based on processing procedure and other programs stored in the ROM 101. The RAM 102 is used as a work area and the like when the CPU 103 performs processing. The CPU 103 receives image data from a host apparatus 900 outside the liquid discharge apparatus 50 and controls the head driver 1A, whereby driving of the discharge elements included in the discharge unit 3 is controlled. The CPU 103 also controls drivers for various actuators included in the liquid discharge apparatus 50. For example, the CPU 103 controls the motor driver 104A that drives a conveyance motor 104 for conveying recording media P. The CPU 103 controls the motor driver 105A that drives a carriage motor 105 for moving the carriage 60. The CPU 103 controls the pump driver 500A that drives circulation pumps 500 to be described below.

The CPU 103 controls the pump driver 404A that drives a one-way pump 404 to be described below. Signals output from various sensors, including volume sensors, a pressure sensor 409, and a liquid sensor 416 to be described below, are input to the control unit 100. While FIG. 1B illustrates a configuration for processing the image data received from the host apparatus 900, the liquid discharge apparatus 50 may perform processing independently of data from the host apparatus 900.

### <Ink Supply Unit>

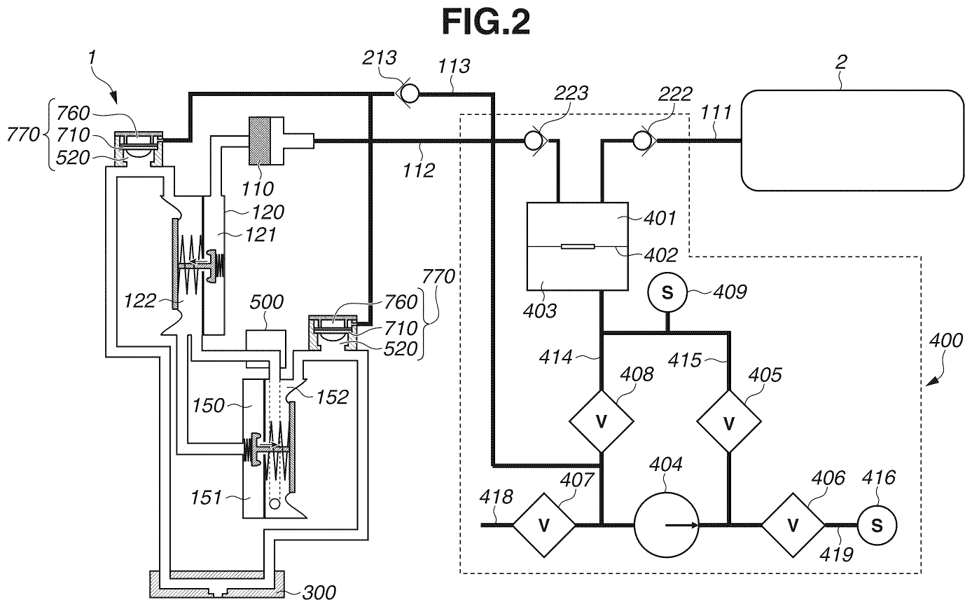

Next, a configuration of the ink supply unit 400 will be described with reference to FIG. 2. FIG. 2 is a schematic diagram illustrating flow channels of the ink supply unit 400.

The ink supply unit 400 includes an intermediate tank 401 that temporarily stores ink supplied through a first supply path 111 from each ink tank 2 that is configured to be detachably attachable to the liquid discharge apparatus 50. A first check valve 222 is disposed partway along the first supply path 111. The first check valve 222 prevents ink backflow from the intermediate tank 401 to the ink tank 2.

At least one surface of the intermediate tank 401 is formed of a flexible membrane 402, whereby the intermediate tank 401 can be changed in volume. The intermediate tank 401 includes a volume sensor (not illustrated). The volume sensor can detect the volume of the intermediate tank 401 by measuring the displacement of the flexible membrane 402. The amount of ink in the intermediate tank 401 can be estimated from the detection result of the volume of the intermediate tank 401 by the volume sensor. The amount of ink in the intermediate tank 401 may be estimated from the detection result of the volume of the intermediate tank 401 by the volume sensor and the amount of ink consumed by image formation on recording media, ink suction at the cap member, etc.

The intermediate tank 401 adjoins an air-filled pressure chamber via the flexible membrane 402. The pressure chamber of the intermediate tank 401 will hereinafter be referred to as an intermediate pressure chamber 403. The pressure of the ink stored in the intermediate tank 401 can be changed by changing the pressure of the gas (air) in the intermediate pressure chamber 403. The ink stored in the intermediate tank 401 is supplied to the liquid discharge head 1 through a second supply path 112 that is connected to the intermediate tank 401 and a filter 110 of the liquid discharge head 1. A second check valve 223 is disposed partway along the second supply path 112. The second check valve 223 prevents ink backflow from the liquid discharge head 1 to the intermediate tank 401. The ink supply unit 400 includes the one-way pump 404 that is driven by the pump driver 404A. For example, the one-way pump 404 is constituted using a diaphragm pump or the like, and can suction and eject air in one direction by the driving of the pump driver 404A.

The intermediate pressure chamber 403 and the suction side of the one-way pump 404 are connected via a first air channel 414. A first open-close valve 408 is disposed partway along the first air channel 414. The first air channel 414 can be switched between communication and shutoff by opening and closing operation of the first open-close valve 408. The first air channel 414 is provided with a first branch air channel 418 that branches off between the first open-close valve 408 and the one-way pump 404 and communicates at one end with the atmosphere. A third open-close valve 407 is disposed in the first branch air channel 418. The suction side of the one-way pump 404 can be switched between hermetically closed and open to the atmosphere by opening and closing operation of the third open-close valve 407.

The intermediate pressure chamber 403 and the ejection side of the one-way pump 404 are connected via a second air channel 415. A second open-close valve 405 is disposed partway along the second air channel 415. The second air channel 415 can be switched between communication and shutoff by opening and closing operation of the second open-close valve 405. The second air channel 415 is provided with a second branch air channel 419 that branches off between the second open-close valve 405 and the one-way pump 404 and communicates at one end with the atmosphere. A fourth open-close valve 406 is disposed in the second branch air channel 419. The ejection side of the one-way pump 404 can be switched between hermetically closed and open to the atmosphere by opening and closing operation of the fourth open-close valve 406. A liquid sensor 416 is disposed at the end of the second branch air channel 419 that is open to the atmosphere. The liquid sensor 416 can detect ink having entered the air channels. The pressure sensor 409 is located somewhere in communication with the intermediate pressure chamber 403. The pressure sensor 409 can detect the pressure of the gas (air) in the intermediate pressure chamber 403. The one-way pump 404 and depressurization chambers 760 of debubbling units 770 in the liquid discharge head 1 to be described below are connected via the third air channel 113. A third check valve 213 is disposed partway along the third air channel 113. The third check valve 213 prevents gas (air) backflow from the ink supply unit 400 to the depressurization chambers 760.

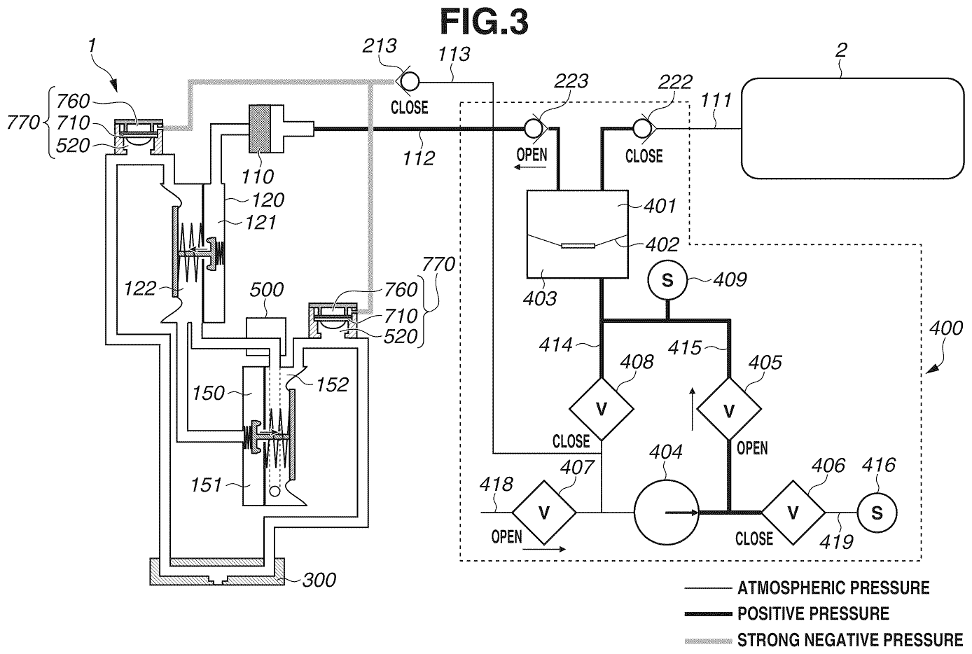

Next, operation of the ink supply unit 400 will be described with reference to FIGS. 3 to 6. In the present embodiment, to perform recording on recording media P, the ink supply unit 400 mainly performs four operations (pressure chamber pressurization operation, pressurization maintenance operation, ink replenishment operation, and debubbling depressurization operation). The pressure chamber pressurization operation, pressurization maintenance operation, ink replenishment operation, and debubbling depressurization operation to be described below are performed by the CPU 103 controlling the one-way pump 404 and the first to fourth open-close valves 408, 405, 407, and 406 based on the detection results of the volume sensor (not illustrated), pressure sensor 409, and the like.

### <Pressure Chamber Pressurization Operation>

The pressure chamber pressurization operation will initially be described with reference to FIG. 3. FIG. 3 is a schematic diagram for describing the pressure chamber pressurization operation. Thanks to the pressurized ink supply, the liquid discharge head 1 according to the present embodiment can stably discharge ink regardless of variations in ink flow rate due to differences in the amount of discharge from the liquid discharge head 1, and variations in ink pressure loss due to ink viscosity and other factors. The pressure chamber pressurization operation is an operation for pressurizing the intermediate pressure chamber 403 to pressurize the ink in the intermediate tank 401 via the flexible membrane 402, and supplying the pressurized ink to the liquid discharge head 1 through the second supply path 112. As the ink in the intermediate tank 401 is consumed and the volume of the intermediate pressure chamber 403 adjoining the intermediate tank 401 via the flexible membrane 402 increases, the gas pressure in the intermediate pressure chamber 403 decreases. When, in the ink replenishment operation to be described below, the gas pressure in the intermediate pressure chamber 403 is lowered and then the first and third open-close valves 408 and 407 are opened to open the intermediate pressure chamber 403 to the atmosphere, the gas pressure in the intermediate pressure chamber 403 becomes atmospheric pressure. In such situations where the gas pressure in the intermediate pressure chamber 403 decreases or where the gas pressure in the intermediate pressure chamber 403 becomes atmospheric pressure, the pressure chamber pressurization operation is needed. The pressure sensor 409 monitors the gas pressure in the intermediate pressure chamber 403, and if the gas pressure in the intermediate pressure chamber 403 is lower than a predetermined pressure needed for stable discharge at the liquid discharge head 1, the ink supply unit 400 performs the pressure chamber pressurization operation. During the pressure chamber pressurization operation, the ink supply unit 400 drives the one-way pump 404 to increase the gas pressure in the intermediate pressure chamber 403 with the first open-close valve 408 closed, the second open-close valve 405 open, the third open-close valve 407 open, and the fourth open-close valve 406 closed. As the gas pressure in the intermediate pressure chamber 403 increases, the ink in the intermediate tank 401 is pressurized via the flexible membrane 402, and the ink in the second supply path 112 is pressurized via the second check valve 223. This enables pressurized ink supply to the liquid discharge head 1. The pressure sensor 409 monitors the gas pressure in the intermediate pressure chamber 403, and if the gas pressure in the intermediate pressure chamber 403 is higher than or equal to a predetermined pressure, the ink supply unit 400 stops driving the one-way pump 404. In the meantime, the depressurization chamber 760 is shut off by the third check valve 213, whereby the pressure in the depressurization chamber 760 is maintained at low pressure (negative pressure).

### <Pressurization Maintenance Operation>

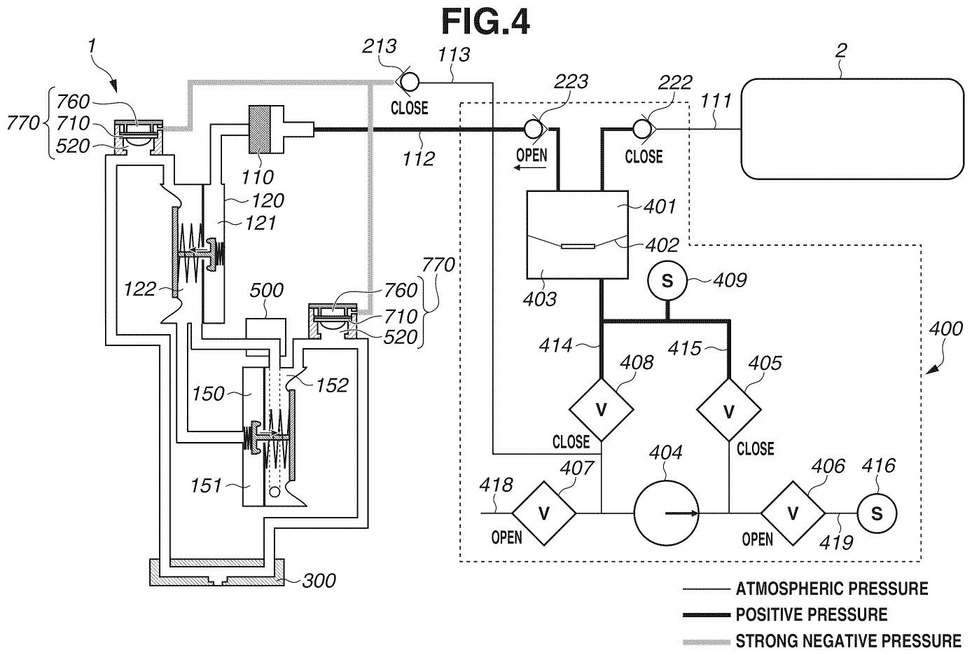

Next, the pressurization maintenance operation will be described with reference to FIG. 4. FIG. 4 is a schematic diagram for describing the pressurization maintenance operation. The pressurization maintenance operation is an operation for maintaining the high gas pressure in the intermediate pressure chamber 403 increased by the pressure chamber pressurization operation. In performing recording on a recording medium P, the ink supply unit 400 performs the pressurization maintenance operation if the gas pressure in the intermediate pressure chamber 403 is higher than or equal to a predetermined pressure. If the gas pressure in the intermediate pressure chamber 403 is still high upon starting next recording, the next recording can be started more quickly without performing the pressure chamber pressurization operation. For such a reason, the gas pressure in the intermediate pressure chamber 403 is desirably maintained high. Even during a standby period when recording is not performed on recording media P, the ink supply unit 400 therefore performs the pressurization maintenance operation if the gas pressure in the intermediate pressure chamber 403 is higher than or equal to the predetermined pressure. When, after the pressure chamber pressurization operation is performed, the gas pressure in the intermediate pressure chamber 403 is higher than or equal to the predetermined pressure, the ink supply unit 400 switches the first open-close valve 408 to closed and the second open-close valve 405 to closed as the pressurization maintenance operation. Here, the third open-close valve 407 and the fourth open-close valve 406 may be closed or open. The high gas pressure in the intermediate pressure chamber 403 increased by the pressure chamber pressurization operation can thereby be maintained. The pressure sensor 409 then monitors the intermediate pressure chamber 403 for pressure variations due to changes in volume, and if the gas pressure in the intermediate pressure chamber 403 is lower than a predetermined pressure, the ink supply unit 400 performs the pressure chamber pressurization operation again. In the meantime, the depressurization chamber 760 is shut off by the third check valve 213, whereby the pressure in the depressurization chamber 760 is maintained at low pressure (negative pressure).

### <Ink Replenishment Operation>

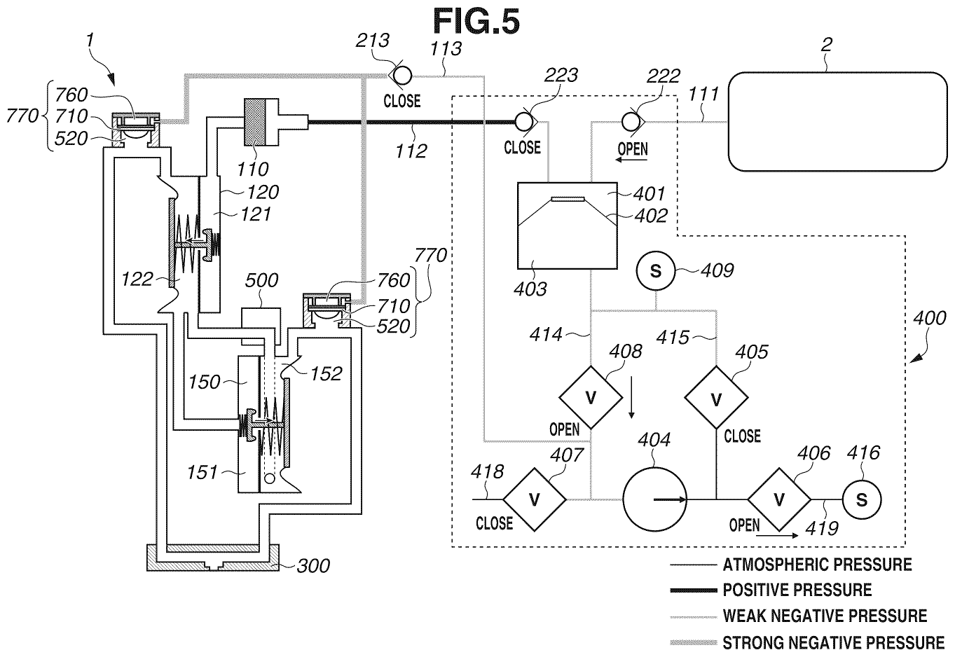

Next, the ink replenishment operation will be described with reference to FIG. 5. FIG. 5 is a schematic diagram for describing the ink replenishment operation. The ink replenishment operation is an operation for drawing the ink stored in the ink tank 2 into the intermediate tank 401 via the first supply path 111 when the amount of ink within the intermediate tank 401 falls below an ink level sufficient for recording. If the detection result of the volume of the intermediate tank 401 by the volume sensor (not illustrated) shows that the amount of ink in the intermediate tank 401 falls below the predetermined ink level sufficient for recording, the ink supply unit 400 performs the ink replenishment operation. In the ink replenishment operation, the ink supply unit 400 drives the one-way pump 404 to reduce the gas pressure in the intermediate pressure chamber 403 with the first open-close valve 408 open, the second open-close valve 405 closed, the third open-close valve 407 closed, and the fourth open-close valve 406 open. As the gas pressure in the intermediate pressure chamber 403 decreases, the pressure of the ink in the intermediate tank 401 decreases via the flexible membrane 402. Reducing the ink pressure in the intermediate tank 401 to low pressure (negative pressure) enables drawing of the ink stored in the ink tank 2 into the intermediate tank 401 via the first supply path 111. If the detection result of the volume of the intermediate tank 401 by the volume sensor shows that the amount of ink in the intermediate tank 401 reaches or exceeds a predetermined ink level, the ink supply unit 400 stops driving the one-way pump 404. The ink supply unit 400 further opens the first open-close valve 408 and the third open-close valve 407 to open the intermediate pressure chamber 403 to the atmosphere, thereby stopping drawing the ink into the intermediate tank 401. After the interior of the intermediate pressure chamber 403 is opened to the atmosphere, the ink supply unit 400 performs the foregoing pressure chamber pressurization operation to increase the gas pressure in the intermediate pressure chamber 403 from atmospheric pressure. In the meantime, the depressurization chamber 760 is shut off by the third check valve 213, whereby the pressure in the depressurization chamber 760 is maintained at low pressure (negative pressure).

### <Debubbling Depressurization Operation>

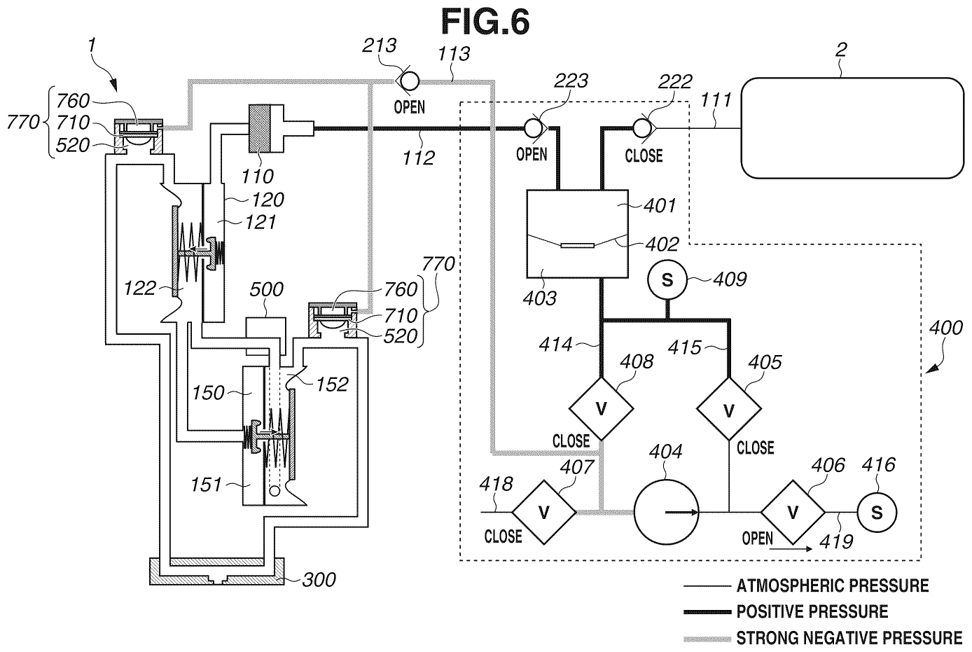

Next, the debubbling depressurization operation will be described with reference to FIG. 6. FIG. 6 is a schematic diagram for describing the debubbling depressurization operation. The debubbling depressurization operation is an operation for reducing the pressure in the depressurization chamber 760.

The rate of gas transfer from a bubble accumulation chamber 520 of the debubbling unit 770 to the depressurization chamber 760 through a gas permeable membrane 710 in the liquid discharge head 1 is proportional to a difference between the pressure in the bubble accumulation chamber 520 and the pressure in the depressurization chamber 760. The pressure in the depressurization chamber 760 is therefore desirably maintained at low pressure. The third check valve 213 disposed partway along the third air channel 113 prevents gas flow from the third air channel 113 into the depressurization chamber 760. However, the pressure in the depressurization chamber 760 gradually increases over time due to the inflow of gas from the bubble accumulation chamber 520 via the gas permeable membrane 710 and slight permeation of gas through the members constituting the depressurization chamber 760. In such situations where the pressure in the depressurization chamber 760 gradually increases over time, the debubbling depressurization operation for reducing the pressure in the depressurization chamber 760 is needed. If the pressure in the depressurization chamber 760 is estimated to be higher than a predetermined pressure from factors such as the elapsed time from the previous debubbling depressurization operation, the ink supply unit 400 performs the debubbling depressurization operation. During the debubbling depressurization operation, the ink supply unit 400 drives the one-way pump 404 to reduce the pressure in the depressurization chamber 760 with the first open-close valve 408 closed, the second open-close valve 405 closed, the third open-close valve 407 closed, and the fourth open-close valve 406 open. When a predetermined time elapses from the driving of the one-way pump 404 and the pressure in the depressurization chamber 760 is estimated to have fallen to or below a predetermined pressure, the ink supply unit 400 stops driving the one-way pump 404. In the meantime, the first open-close valve 408 and the second open-close valve 405 are closed, whereby the gas pressure in the intermediate pressure chamber 403 is maintained at positive pressure. After the debubbling depressurization operation, the pressure in the depressurization chamber 760 is maintained at low pressure (negative pressure) since the third check valve 213 is closed, even if the pressure within the intermediate pressure chamber 403 and the first to third air channels 414, 415, and 113 varies due to the foregoing pressure chamber pressurization operation, pressurization maintenance operation, ink replenishment operation, etc. The debubbling depressurization operation according to the present embodiment is performed once a day. However, this is not restrictive. For example, the debubbling depressurization operation may be performed more often after delivery of the liquid discharge apparatus 50, after cleaning, and on other occasions when bubbles are likely to occur. The frequency of the debubbling depressurization operation may be reduced with a lapse of time after delivery or cleaning. The frequency of the debubbling depressurization operation may also be changed depending on temperature, usage, and the like.

### <Description of Head-Side Connection Member>

FIG. 50 is an exploded perspective view of a head-side connection member 800 that connects the circulation units 54 and a main body-side connection member 470. The head-side connection member 800 integrates degassing channels from respective sub tanks into one channel by joining two members. The joining method is not limited in particular. Examples include thermal welding, adhesive bonding, and molten resin bonding. Instead of providing degassing needles 820 for exhausting bubbles occurring in the respective circulation units 54, an integrated degassing channel 830 is disposed with a single degassing needle 820. This can reduce the contact area with seal portions 940 and reduce the insertion/removal force. In the present embodiment, the head-side connection member 800 has the needles 810 and 820 and the main body-side connection member 470 has the seal portions 940, whereas the combination of needles 810 and 820 and seal portions 940 may be reversed.

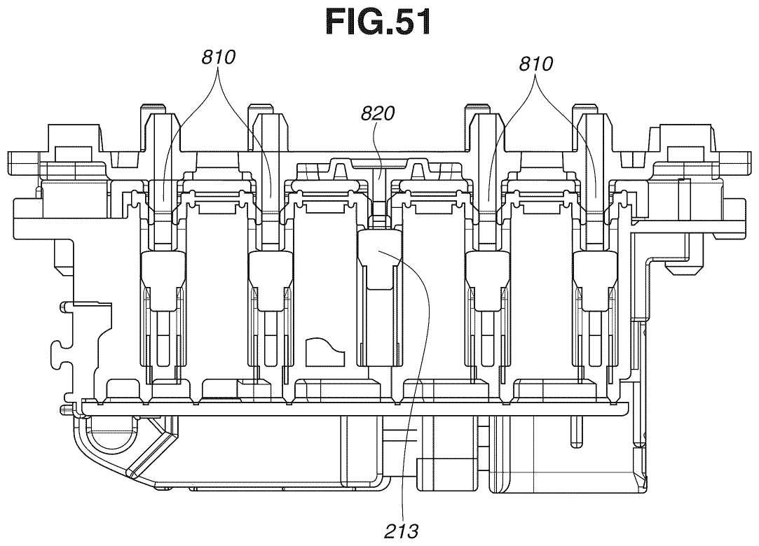

FIG. 51 is a sectional view illustrating a state where the head-side connection member 800 and the main body-side connection member 470 are coupled.

With the degassing channel 830 in a non-depressurized state, the third check valve 213 is pressed against the seal portion 940 by a biasing member. Meanwhile, the ink needles 810 push the valves forward against the biasing force of biasing members, whereby the ends of the ink needles 810 are pressed against the valves. The ends of the ink needles 810 are notched so that inks can be supplied through the notches even when the needle ends are pressed against the valves. In removing the head-side connection member 800, the valves are pressed against the seal portions 940 by the biasing force of the biasing members as the ink needles 810 recede. This prevents ink leakage from the main body-side connection member 470 when the ink needles 810 are removed.

In the present embodiment, the ink needles 810 and the degassing needle 820 of the head-side connection member 800 have different lengths. Specifically, the degassing needle 820 is shorter than the ink needles 810. The degassing needle 820 therefore will not push the third check valve 213 (valve), and the degassing channel 830 is kept sealed. Configuring the ink needles 810 and the degassing needle 820 in different lengths and notching only the ink needles 810 enables use of common biasing members and valve components for respective different functions even when the desired biasing forces are different. The ink needles and the degassing needle, if provided on the main body-side connection member 470, may also have different lengths.

### <Detailed Description of Operation of Third Check Valve During Debubbling Depressurization Operation>

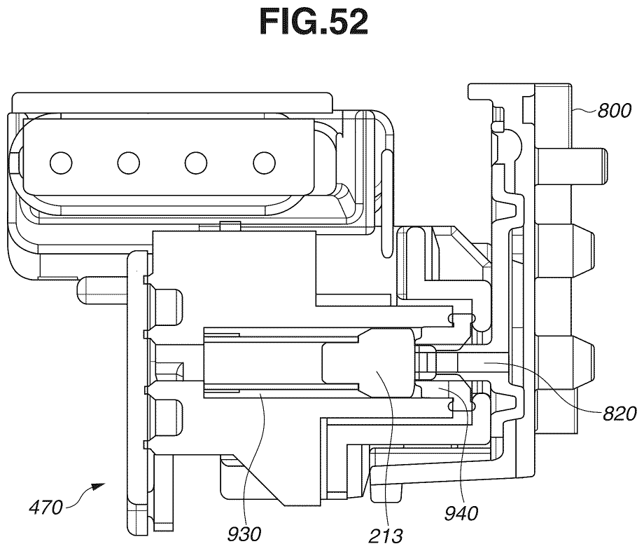

As described above, during the debubbling depressurization operation, the one-way pump 404 is driven to reduce the pressure of the depressurization chamber 760 (see FIG. 6). The third check valve 213 is disposed between the one-way pump 404 and the depressurization chamber 760. As illustrated in FIG. 52, the third check valve 213 is pressed against the seal portion 940 by a biasing member 930 to seal the degassing channel 830 of the head-side connection member 800. Even if the third air channel 113 is pressurized while the one-way pump 404 is performing a pressurization operation or opened to the atmosphere, the third check valve 213 thus seals the degassing channel 830 of the head-side connection member 800. This can maintain the depressurization chamber 760 at negative pressure without being affected by the pressurization.

When the pressure of the depressurization chamber 760 has increased over time, the debubbling depressurization operation is performed.

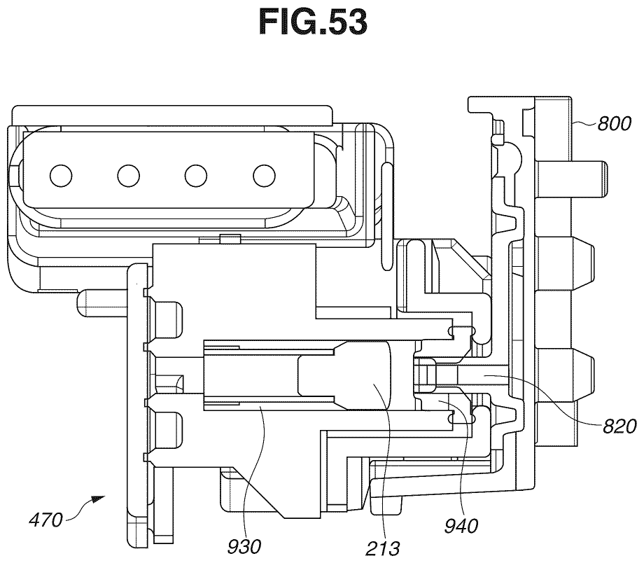

When the one-way pump 404 depressurizes the third air channel 113 and the negative pressure of the third air channel 113 exceeds the biasing force of the biasing member 930, the third check valve 213 recedes and is disengaged from the pressed state against the seal portion 940 as illustrated in FIG. 53. As the one-way pump 404 continues the depressurization operation in such a state, the depressurization chambers 760 are depressurized through the third air channel 113. When the depressurization chambers 760 fall to or below a predetermined pressure, the depressurization operation of the one-way pump 404 is stopped. When the biasing force of the biasing member 930 exceeds the force from the negative pressure of the third air channel 113, the third check valve 213 advances to seal the degassing channel 830 of the head-side connection member 800, whereby the negative pressure of the depressurization chamber 760 is maintained as illustrated in FIG. 51.

Since the third check valve 213 operates with such depressurization, pressurization, and atmospheric release operations of the one-way pump 404, the pressure of the depressurization chamber 760 can be maintained without providing the third air channel 113 with electrical or other mechanisms solely for switching a switching valve.

As described above, as an alternative configuration to the switching valve described in the foregoing Japanese Patent Laid-Open No. 2010-208188, the valve that opens to establish communication of the degassing channel when part of the gas channel is depressurized by the one-way pump 404 is provided between the connection portion of the liquid discharge head 1 and the depressurization mechanism. This enables both the degassing operation and the open-close switching of the gas channel through pump control alone, without the need for control components solely for opening and closing the channel, such as a switching valve.

### <Liquid Discharge Head>

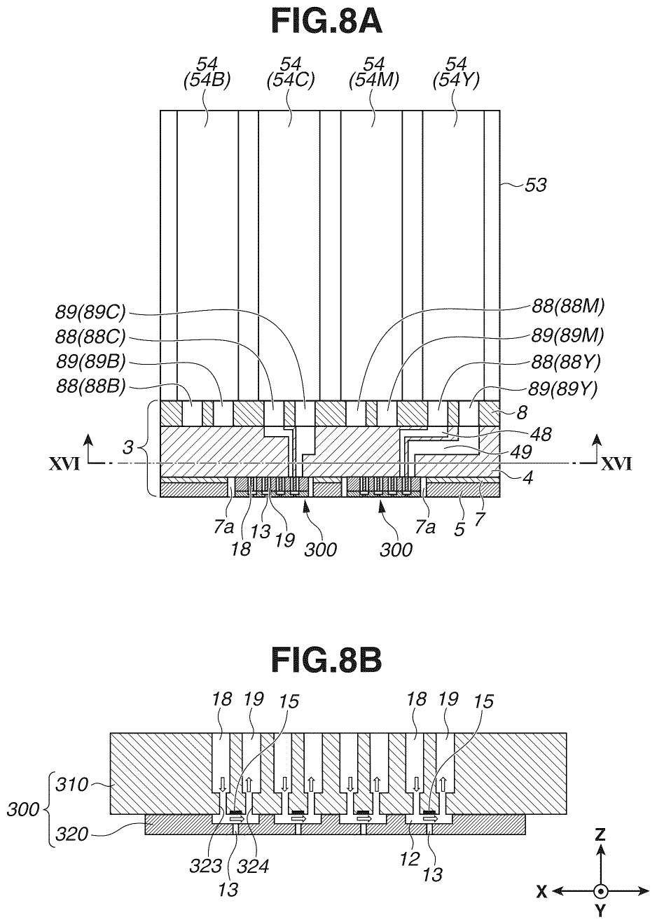

FIG. 7 is an exploded perspective view of the liquid discharge head 1 according to the present embodiment. FIGS. 8A and 8B are sectional views of the liquid discharge head 1 and discharge modules 300. FIG. 8A is a sectional view of the liquid discharge head 1 illustrated in FIG. 7, taken along line VIIIa-VIIIa. FIG. 8B is an enlarged sectional view of one of the discharge modules 300 illustrated in FIG. 8A. A basic configuration of the liquid discharge head 1 according to the present embodiment will now be described mainly with reference to FIGS. 7, 8A, and 8B, and to FIG. 1 as appropriate.

As illustrated in FIG. 7, the liquid discharge head 1 includes the circulation units 54 and the discharge unit 3 for discharging ink supplied from the circulation units 54 to recording media P. The liquid discharge head 1 according to the present embodiment is fixed and supported on the carriage 60 of the liquid discharge apparatus 50 by not-illustrated positioning units and electrical contacts disposed on the carriage 60. The liquid discharge head 1 performs recording on recording media P by discharging ink while moving in the main scanning direction (X direction) illustrated in FIG. 1 with the carriage 60.

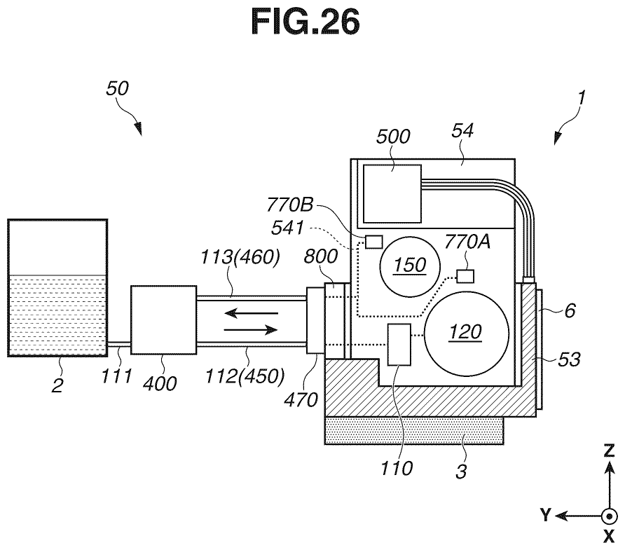

The ink supply unit 400 connected to the ink tanks 2 serving as ink supply sources is equipped with the first supply paths 111 and the second supply paths 112. The main body-side connection member 470 (see FIG. 26) is disposed at the ends of the second supply paths 112. When the liquid discharge head 1 is mounted in the liquid discharge apparatus 50, the main body-side connection member 470 disposed at the ends of the second supply paths 112 is detachably connected to the head-side connection member 800 disposed on a head housing 53 of the liquid discharge head 1. This forms ink supply paths (first supply paths 111 and second supply paths 112) leading from the ink tanks 2 to the liquid discharge head 1 through the ink supply unit 400. In the present embodiment, since four types of inks are used, four sets of ink tanks 2, first supply paths 111, second supply paths 112, and circulation units 54 are provided to correspond to the inks, whereby four independent ink supply paths corresponding to the respective inks are formed. The liquid discharge apparatus 50 according to the present embodiment thus includes an ink supply system where inks are supplied from the ink tanks 2 located outside the liquid discharge head 1.

As illustrated in FIG. 8A, the circulation units 54 include a black ink circulation unit 54B, a cyan ink circulation unit 54C, a magenta ink circulation unit 54M, and a yellow ink circulation unit 54Y. The circulation units have substantially the same configurations, and in the present embodiment, will all be referred to as circulation units 54 when not distinguished in particular. While the liquid discharge head 1 illustrated in FIG. 8A includes the four circulation units 54 corresponding to the four types of inks, the liquid discharge head 1 may only include circulation units 54 corresponding to the types of liquids to be discharged. Moreover, the liquid discharge head 1 may include a plurality of circulation units 54 for the same type of liquid. In other words, the liquid discharge head 1 may be configured to include one or more circulation units 54. The liquid discharge head 1 may be configured to circulate at least one ink rather than circulating all the four types of inks.

In FIGS. 7 and 8A, the discharge unit 3 includes two discharge modules 300, a first support member 4, a second support member 7, an electrical wiring member (electrical wiring tape) 5, and an electrical contact substrate 6. As illustrated in FIG. 8B, each discharge module 300 includes a 0.5- to 1.0-mm-thick silicon substrate 310 and a plurality of discharge elements 15 disposed on one surface of the silicon substrate 310. In the present embodiment, the discharge elements 15 are composed of electrothermal transducers (heaters) that generate thermal energy as discharge energy for discharging liquid. Each discharge element 15 is electrically powered via electrical wiring formed on the silicon substrate 310 by film deposition techniques.

A nozzle formation member 320 is formed on the surface (in FIG. 8B, bottom surface) of the silicon substrate 310. A plurality of pressure chambers 12 corresponding to the plurality of discharge elements 15 and a plurality of nozzles 13 for discharging ink are formed in the nozzle formation member 320 by photolithographic techniques. Common supply channels 18 and common recovery channels 19 are also formed in the silicon substrate 310. Moreover, supply connection channels 323 for establishing communication between the common supply channels 18 and the respective pressure chambers 12 and recovery connection channels 324 for establishing communication between the common recovery channels 19 and the respective pressure chambers 12 are formed in the silicon substrate 310. In the present embodiment, each discharge module 300 is configured to discharge two types of inks. More specifically, between the two discharge modules 300 illustrated in FIG. 8A, the one located to the left in the diagram discharges black ink and cyan ink. The one located to the right in the diagram discharges magenta ink and yellow ink. Such combinations are merely an example, and the inks may be combined in any way. One discharge module 300 may be configured to discharge one type of ink or discharge three types of inks. The two discharge modules 300 may not discharge the same numbers of types of inks. The liquid discharge head 1 may be equipped with one discharge module 300, or may include three or more discharge modules 300. In the example illustrated in FIGS. 8A and 8B, two nozzle rows extending in the Y direction are formed for one color ink. The pressure chambers 12, common supply channels 18, and common recovery channels 19 are formed for the respective nozzles 13 constituting the nozzle rows.

Ink supply ports and ink recovery ports to be described below are formed in the back (in FIG. 8B, top surface) of the silicon substrate 310. The ink supply ports supply ink from the ink supply channels 48 to the plurality of common supply channels 18. The ink recovery ports recover ink from the plurality of common recovery channels 19 to the ink recovery channels 49.

As employed herein, the ink supply ports and the ink recovery ports refer to openings for supplying and recovering ink during forward ink circulation to be described below. In other words, during the forward ink circulation, ink is supplied from the ink supply ports to the respective common supply channels 18, and recovered from the common recovery channels 19 to the ink recovery ports. However, ink circulation may also be performed such that ink flows in a reverse direction. In this case, ink is supplied from the foregoing ink recovery ports to the common recovery channels 19, and recovered from the common supply channels 18 to the ink supply ports.

As illustrated in FIG. 8A, the discharge modules 300 are adhesively bonded and fixed to one surface (in FIG. 8A, bottom surface) of the first support member 4 at their back (in FIG. 8A, top surfaces).

The ink supply channels 48 and ink recovery channels 49 are formed in the first support member 4 to run through from the one surface to the other surface. One opening of each of the ink supply channels 48 communicates with the corresponding ink support port of the silicon substrate 310. One opening of each of the ink recovery channels 49 communicates with the corresponding ink recovery port of the silicon substrate 310. The ink supply channels 48 and the ink recovery channels 49 are provided for respective types of inks independently.

The second support member 7, which has openings 7a (see FIG. 7) for the discharge modules 300 to be inserted through, is adhesively bonded and fixed to one surface (in FIG. 8A, bottom surface) of the first support member 4.

The second support member 7 holds the electrical wiring member 5 electrically connected to the discharge modules 300. The electrical wiring member 5 is a member for applying electrical signals for discharging ink to the discharge modules 300. Electrical connections of the discharge modules 300 and the electrical wiring member 5 are sealed by a sealing member (not illustrated) and thus protected from corrosion by ink and external impact.

The electrical contact substrate 6 is thermally welded to an end portion 5a (see FIG. 7) of the electrical wiring member 5 using a not-illustrated anisotropic conductive film, whereby the electrical wiring member 5 and the electrical contact substrate 6 are electrically connected. The electrical contact substrate 6 includes external signal input terminals (not illustrated) for receiving electrical signals from the liquid discharge apparatus 50.

A joint member 8 (FIG. 8A) is disposed between the first support member 4 and the circulation units 54. Supply ports 88 and recovery ports 89 for respective ink types are formed in the joint member 8. The supply ports 88 and the recovery ports 89 establish communication between the ink supply channels 48 and ink recovery channels 49 of the first support member 4 and channels formed in the circulation units 54. In FIG. 8A, a supply port 88B and a recovery port 89B correspond to black ink. A supply port 88C and a recovery port 89C correspond to cyan ink. A supply port 88M and a recovery port 89M correspond to magenta ink. A supply port 88Y and a recovery port 89Y correspond to yellow ink.

The opening at one end of each of the ink supply channels 48 and ink recovery channels 49 in the first support member 4 has a small opening area matching the corresponding ink supply port or ink recovery port in the silicon substrate 310. By contact, the openings at the other ends of the ink supply channels 48 and ink recovery channels 49 of the first support member 4 are expanded to the same opening areas as the large opening areas of the joint member 8, which are shaped to the channels of the circulation units 54. Such a configuration can suppress increases in flow resistance of ink collected from the recovery channels. However, the opening shapes of each of the ink supply channels 48 and ink recovery channels 49 at one end and the other end are not limited to the foregoing example.

In the liquid discharge head 1 having the foregoing configuration, ink supplied to the circulation units 54 passes through the supply ports 88 of the joint member 8 and the ink supply channels 48 of the first support member 4, and flows from the ink supply ports of the discharge modules 300 into the common supply channels 18. The ink then flows from the common supply channels 18 into the pressure chambers 12 via the supply connection channels 323. Part of the ink flowed into the pressure chambers 12 is discharged from the nozzles 13 by the driving of the discharge elements 15. The remaining undischarged ink passes through the pressure chambers 12, the recovery connection channels 324, and the common recovery channels 19, and flows from the ink recovery ports into the ink recovery channels 49 of the first support member 4. The ink entered the ink recovery channels 49 then flows into the circulation units 54 through the recovery ports 89 of the joint member 8 for recovery.

### <Components of Circulation Unit>

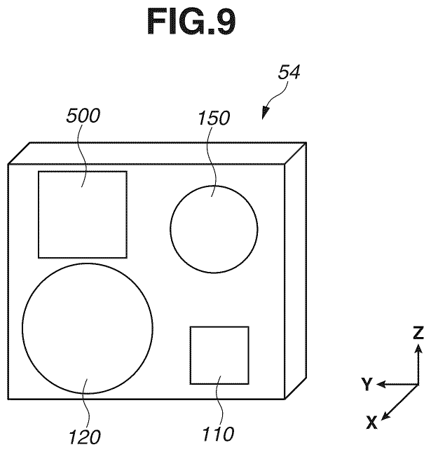

FIG. 9 is a schematic external view of a circulation unit 54 corresponding to one type of ink applied to the liquid discharge apparatus 50 according to the present embodiment. The circulation unit 54 includes a filter 110, a first pressure adjustment unit 120, a second pressure adjustment unit 150, and a circulation pump 500.

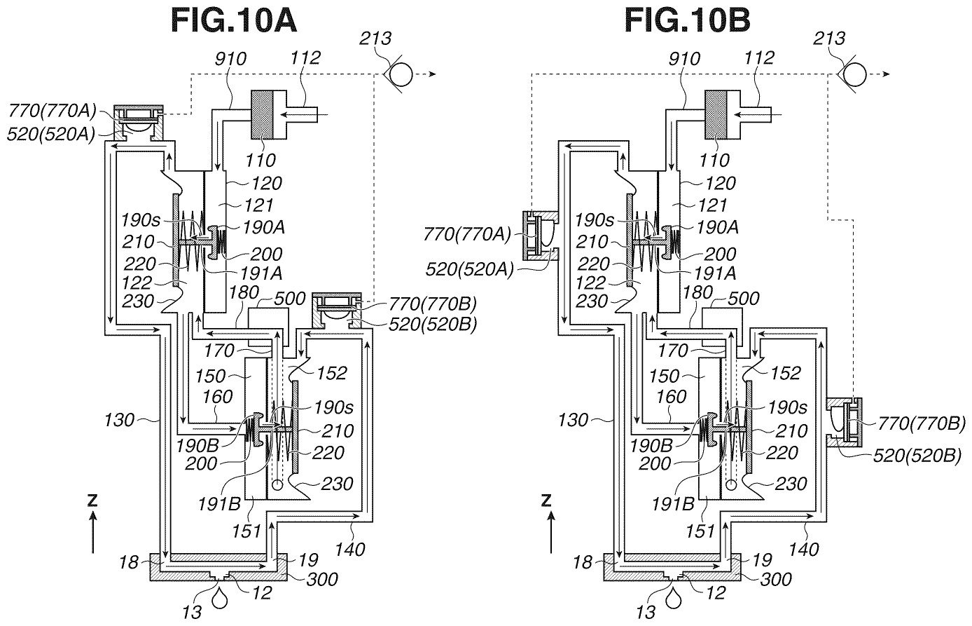

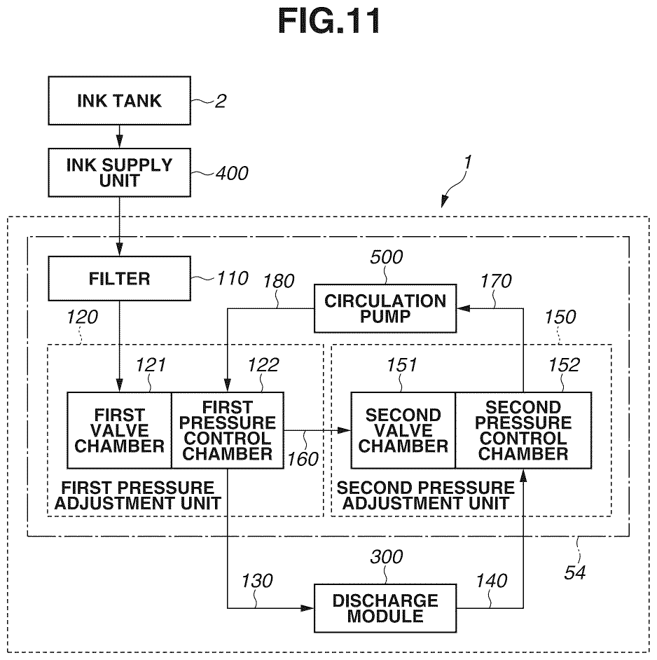

These components are connected by channels as illustrated in FIGS. 10A, 10B, and 11, whereby a circulation path for supplying and recovering ink to/from the discharge module 300 is constituted within the liquid discharge head 1.

### <Circulation Path in Liquid Discharge Head>

FIGS. 10A and 10B are longitudinal sectional views schematically illustrating the circulation path for one type of ink (one color ink), constituted within the liquid discharge head 1. For clearer description of the circulation path, the relative positions of the components in FIGS. 10A and 10B (such as the first pressure adjustment unit 120, the second pressure adjustment unit 150, and the circulation pump 500) are simplified. The relative positions of the components are therefore different from those in FIG. 9. FIG. 11 is a block diagram schematically illustrating the circulation path illustrated in FIGS. 10A and 10B. As illustrated in FIGS. 10A, 10B, and 11, the first pressure adjustment unit 120 includes a first valve chamber 121 and a first pressure control chamber 122. The second pressure adjustment unit 150 includes a second valve chamber 151 and a second pressure control chamber 152. The first pressure adjustment unit 120 is configured so that its control pressure is higher than that of the second pressure adjustment unit 150. In the present embodiment, the two pressure adjustment units 120 and 150 are used to implement circulation in the circulation path within a certain pressure range. The circulation path is configured so that ink flows through the pressure chamber 12 (discharge element 15) at a flow rate corresponding to a pressure difference between the first pressure adjustment unit 120 and the second pressure adjustment unit 150. The circulation path in the liquid discharge head 1 and the ink flow within the circulation path will now be described with reference to FIGS. 10A, 10B, and 11. The arrows in the diagrams indicate the flowing direction of the ink.

In the present embodiment, the debubbling units 770 are disposed within the liquid discharge head 1, and configured to exhaust bubbles occurring in the liquid discharge head 1 out of the liquid discharge head 1. FIGS. 10A and 10B illustrate a configuration where there are two debubbling units 770, which are located at respective different positions. However, the number of debubbling units 770 may be one, and its layout is not limited to this configuration, either, as long as bubbles can be exhausted out of the liquid discharge head 1. A specific configuration of the debubbling units 770 will be described below.

In the example illustrated in FIGS. 10A and 10B, one of the two debubbling units 770 will be referred to as a first debubbling unit 770A, and the other of the two debubbling units 770 will be referred to as a second debubbling unit 770B. As described above, the number of debubbling units 770 is not limited to two. The liquid discharge head 1 may include only one debubbling unit 770, or three or more debubbling units 770. The first debubbling unit 770A and the second debubbling unit 770B each include a bubble accumulation chamber 520 to be described below. The bubble accumulation chamber 520 included in the first debubbling unit 770A will be referred to as a first bubble accumulation chamber 520A, and the bubble accumulation chamber 520 included in the second debubbling unit 770B will be referred to as a second bubble accumulation chamber 520B. In FIG. 11, the debubbling units 770 and the gas channels connected to the debubbling units 770 (such as the third air channel 113) are omitted.

The connection of the components in the liquid discharge head 1 will initially be described.

The ink supply unit 400 that supplies the ink stored in the ink tank 2 located outside the liquid discharge head 1 to the liquid discharge head 1 is connected to the circulation unit 54 via the second supply path 112 (see FIG. 26). The filter 110 is disposed in the ink channel located upstream of the circulation unit 54. The ink supply path (third supply path 910) located downstream of the filter 110 is connected to the first valve chamber 121 of the first pressure adjustment unit 120. The first valve chamber 121 communicates with the first pressure control chamber 122 via a communication port 191A that can be opened and closed by a valve 190A illustrated in FIGS. 10A and 10B.

The first pressure control chamber 122 is connected to a supply channel 130, a bypass channel 160, and a pump outlet channel 180 of the circulation pump 500. The supply channel 130 is connected to the common supply channel 18 via the foregoing ink supply port provided in the discharge module 300. The bypass channel 160 is connected to the second valve chamber 151 included in the second pressure adjustment unit 150. The second valve chamber 151 communicates with the second pressure control chamber 152 via a communication port 191B that is opened and closed by a valve 190B illustrated in FIGS. 10A and 10B. FIGS. 10A, 10B, and 11 illustrate an example where one end of the bypass channel 160 is connected to the first pressure control chamber 122 of the first pressure adjustment unit 120, and the other end of the bypass channel 160 is connected to the second valve chamber 151 of the second pressure adjustment unit 150. However, one end of the bypass channel 160 may be connected to the supply channel 130, and the other end of by bypass channel 160 may be connected to the second valve chamber 151.

The second pressure control chamber 152 is connected to a first recovery channel 140. The first recovery channel 140 is connected to the common recovery channel 19 via the foregoing ink recovery port formed in the discharge module 300. The second pressure control chamber 152 is also connected to the circulation pump 500 via a pump inlet channel 170.

Next, the ink flow in the liquid discharge head 1 having the foregoing configuration will be described. As illustrated in FIG. 11, the ink stored in the ink tank 2 is pressurized by the one-way pump 404 (see FIG. 2) of the ink supply unit 400 included in the liquid discharge apparatus 50, and supplied to the circulation unit 54 of the liquid discharge head 1 as a positive-pressure ink flow.

The ink supplied to the circulation unit 54 is passed through the filter 110 for removal of bubbles and foreign objects such as dust, and flows into the first valve chamber 121 included in the first pressure adjustment unit 120. The ink decreases in pressure due to a pressure loss when passing through the filter 110, whereas the ink pressure at this phase is still positive. The ink entered the first valve chamber 121 then flows into the first pressure control chamber 122 through the communication port 191A when the valve 190A is open. The pressure loss in passing through the communication port 191A causes the ink flowing into the first pressure control chamber 122 to change from positive pressure to negative pressure.

Next, the ink flow within the circulation path will be described. The circulation pump 500 operates to deliver the ink suctioned from the pump inlet channel 170 upstream to the pump outlet channel 180 downstream. This pump inlet channel 170 is located vertically below the second pressure adjustment unit 150, so that bubbles flowing from bypass channel 160 into the second pressure adjustment unit 150 are not carried by the ink flow but move up and are accumulated vertically above the second pressure adjustment unit 150. The pump inlet channel 170 may not be located vertically below the second pressure adjustment unit 150, and any configuration may be employed as long as the bubbles flowed into the second pressure adjustment unit 150 move up and are collected in the second bubble accumulation chamber 520B. When the circulation pump 500 is driven, the ink supplied to the first pressure control chamber 122 flows into the supply channel 130 and the bypass channel 160 along with the ink delivered from the pump outlet channel 180. As will be described in detail below, in the present embodiment, a piezoelectric diaphragm pump with a piezoelectric element attached to a diaphragm as its drive source is used as the circulation pump 500 capable of liquid delivery. The piezoelectric diaphragm pump is a pump that delivers liquid by inputting a driving voltage to the piezoelectric element to change the volume of the pump chamber so that two check valves operate alternately due to pressure variations.

The ink entered the supply channel 130 flows from the ink supply port of the discharge module 300 into the pressure chamber 12 via the common supply channel 18, and part of the ink is discharged from the nozzle 13 by the driving (heat generation) of the discharge element 15. The remaining ink not used for discharge flows through the pressure chamber 12, passes the common recovery channel 19, and flows into the first recovery channel 140 connected to the discharge module 300. The ink entered the first recovery channel 140 flows into the second pressure control chamber 152 of the second pressure adjustment unit 150.

Meanwhile, the ink entered the bypass channel 160 from the first pressure control chamber 122 flows into the second valve chamber 151 and then flows into the second pressure control chamber 152 through the communication port 191B. The ink flowed into the second pressure control chamber 152 via the bypass channel 160 and the ink recovered from the first recovery channel 140 are suctioned into the circulation pump 500 through the pump inlet channel 170 by the driving of the circulation pump 500. The ink suctioned into the circulation pump 500 is then sent to the pump outlet channel 180 and flows into the first pressure control chamber 122 again. Subsequently, the ink entered the second pressure control chamber 152 from the first pressure control chamber 122 via the supply channel 130 and discharge module 300 and the ink entered the second pressure control chamber 152 via the bypass channel 160 flow into the circulation pump 500. The ink is then delivered from the circulation pump 500 to the first pressure control chamber 122. In such a manner, ink circulation within the circulation path is performed.

Here, a channel for establishing communication between the first pressure adjustment unit 120 and the pressure chamber 12 will be referred to as a first channel. A channel for establishing communication between the pressure chamber 12 and the circulation pump 500 will be referred to as a second channel. In other words, the supply channel 130 is referred to as a first channel. The first recovery channel 140, the second pressure adjustment unit 150, and the pump inlet channel 170 are referred to collectively as a second channel. The second channel may not include the second pressure adjustment unit 150 or the pump inlet channel 170. The pump outlet channel 180 will also be referred to as a third channel. In the present embodiment, the ink thus flows through the circulation path consisting of the circulation pump 500, the third channel, the first pressure adjustment unit 120, the first channel, the pressure chamber 12, the second channel, and the circulation pump 500 in order.

As described above, in the present embodiment, the circulation pump 500 can circulate liquid (ink) along the circulation path formed within the liquid discharge head 1. This can prevent ink thickening and deposition of settling components of colorant ink within the discharge module 300, whereby the ink fluidity in the discharge module 300 and the discharge characteristics of the nozzle 13 can be favorably maintained.

In the present embodiment, the circulation paths are configured to be complete within the liquid discharge head 1. Compared to the case where ink is circulated between the liquid discharge head 1 and the ink tanks 2 located outside the liquid discharge head 1, the circulation path lengths can therefore be significantly reduced. This enables ink circulation with small-sized circulation pumps.

Moreover, the connection channels between the liquid discharge head 1 and the ink tanks 2 consist only of ink-supplying channels. In other words, this configuration may not use channels for recovering ink from the liquid discharge head 1 to the ink tanks 2. For this reason, only ink supply tubes may be provided to connect the ink tanks 2 and the liquid discharge head 1, without the need to provide ink recovery tubes. The interior of the liquid discharge apparatus 50 can thus be simplified in configuration with a reduced number of tubes, and the entire liquid discharge apparatus 50 can be miniaturized. Moreover, the reduced number of tubes can reduce fluctuations in ink pressure due to swinging of the tubes associated with the main scanning of the liquid discharge head 1. The swinging of the tubes during the main scanning of the liquid discharge head 1 also causes a driving load on the carriage motor 105 that drives the carriage 60. The reduction in the number of tubes thus reduces the driving load on the carriage motor 105, whereby the main scanning mechanism including the carriage motor 105 can be simplified. Furthermore, since ink recovery from the liquid discharge head 1 to the ink tanks 2 is not needed, the one-way pump 404 (see FIG. 2) of the ink supply unit 400 can also be miniaturized. According to the present embodiment, the liquid discharge apparatus 50 can thus be reduced in size and cost.

### <Pressure Adjustment Units>

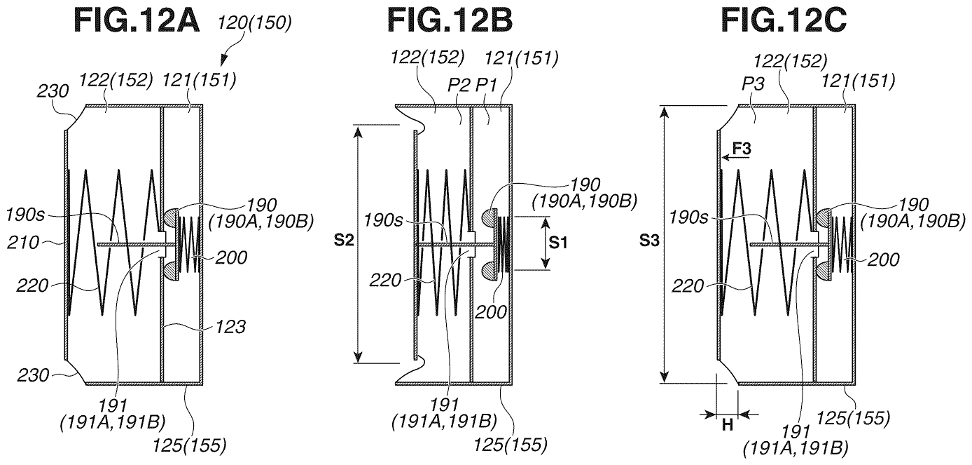

FIGS. 12A to 12C are sectional views illustrating an example of the pressure adjustment units. The configuration and function of the pressure adjustment units (first pressure adjustment unit 120 and second pressure adjustment unit 150) built in the foregoing liquid discharge head 1 will be described in more detail with reference to FIGS. 12A to 12C. The first pressure adjustment unit 120 and the second pressure adjustment unit 150 have substantially the same configurations. The following description will therefore be given by using the first pressure adjustment unit 120 as an example. As for the second pressure adjustment unit 150, the reference numerals of portions corresponding to those of the first pressure adjustment unit 120 will merely be illustrated in FIGS. 12A to 12C. For the second pressure adjustment unit 150, the first valve chamber 121 described below should be read as the second valve chamber 151, and the first pressure control chamber 122 as the second pressure control chamber 152.

The first pressure adjustment unit 120 includes the first valve chamber 121 and the first pressure control chamber 122, which are formed within a cylindrical housing 125. The first valve chamber 121 and the first pressure control chamber 122 are partitioned by a partition wall 123 located inside the cylindrical housing 125. Note that the first valve chamber 121 communicates with the first pressure control chamber 122 via a communication port 191 formed in the partition wall 123. The first valve chamber 121 is equipped with a valve 190 that switches between communication and shutoff of the first valve chamber 121 and the first pressure control chamber 122 at the communication port 191. The valve 190 is held at a position opposed to the communication port 191 by a valve spring 200, and configured so that it can be brought into close contact with the partition wall 123 by the biasing force of the valve spring 200. The close contact of the valve 190 with the partition wall 123 interrupts ink flow at the communication port 191. To enhance the tightness of contact with the partition wall 123, the portion of the valve 190 that contacts the partition wall 123 is desirably formed of an elastic member. A valve shaft 190s to be inserted through the communication port 191 is protruded from the central part of the valve 190. Pressing the valve shaft 190s against the biasing force of the valve spring 200 separates the valve 190 from the partition wall 123, whereby ink can flow through the communication port 191. The state where the valve 190 interrupts the ink flow at the communication port 191 will hereinafter be referred to as a “closed state”, and the state where ink can flow through the communication port 191 will be referred to as an “open state”.

The opening of the cylindrical housing 125 is closed by a flexible member 230 and a pressure plate 210. The flexible member 230, the pressure plate 210, the peripheral wall of the housing 125, and the partition wall 123 form the first pressure control chamber 122. The first pressure control chamber 122 is variable in volume, and the pressure plate 210 is configured to be displaceable with the displacement of the flexible member 230.

The materials of the pressure plate 210 and the flexible member 230 are not limited in particular. For example, the pressure plate 210 can be formed of a resin molded part, and the flexible member 230 can be formed of a resin film. In such a case, the pressure plate 210 can be fixed to the flexible member 230 by thermal welding.

A pressure adjustment spring 220 (biasing member) is disposed between the pressure plate 210 and the partition wall 123. As illustrated in FIG. 12A, the pressure plate 210 and the flexible member 230 are biased by the biasing force of the pressure adjustment spring 220 in a direction of increasing the volume of the first pressure control chamber 122. As the pressure in the first pressure control chamber 122 decreases, the pressure plate 210 and the flexible member 230 are displaced in a direction of reducing the volume of the first pressure control chamber 122 against the biasing force of the pressure adjustment spring 220. When the volume of the first pressure control chamber 122 decreases to a certain amount, the pressure plate 210 comes into contact with the valve shaft 190s of the valve 190. As the volume of the first pressure control chamber 122 decreases further, the valve 190 moves with the valve shaft 190s against the biasing force of the valve spring 200 and separates from the partition wall 123. This brings the communication port 191 into the open state (state of FIG. 12B).

In the present embodiment, connection settings within the circulation path are configured so that the pressure of the first valve chamber 121 is higher than that of the first pressure control chamber 122 when the communication port 191 is in the open state.

With the communication port 191 in the open state, ink therefore flows from the first valve chamber 121 into the first pressure control chamber 122. This inflow of ink displaces the flexible member 230 and the pressure plate 210 in a direction of increasing the volume of the first pressure control chamber 122. As a result, the pressure plate 210 is separated from the valve shaft 190s of the valve 190, and the valve 190 is brought into close contact with the partition wall 123 by the biasing force of the valve spring 200, whereby the communication port 191 enters the closed state (state of FIG. 12C).

As described above, in the first pressure adjustment unit 120 of the present embodiment, when the pressure in the first pressure control chamber 122 falls to or below a certain pressure (for example, negative pressure increases), ink flows in from the first valve chamber 121 via the communication port 191. The first pressure adjustment unit 120 is thereby configured so that the pressure of the first pressure control chamber 122 does not decrease further. The first pressure control chamber 122 is thus controlled within a certain range of pressure.

Next, the pressure of the first pressure control chamber 122 will be described in more detail.

Suppose, as described above, that the flexible member 230 and the pressure plate 210 are displaced depending on the pressure of the first pressure control chamber 122, and the pressure plate 210 comes into contact with the valve shaft 190s and the communication port 191 enters the open state (state of FIG. 12B). The relationship of forces acting on the pressure plate 210 here is expressed by the following Eq. (1):

$$P 2 \times S 2 + F 2 + ( P 1 - P 2 ) \times S 1 + F 1 = 0 , \qquad ( 1 )$$

where P1: Pressure in the first valve chamber 121 (gauge pressure)
P2: Pressure in the first pressure control chamber 122 (gauge pressure)
F1: Spring force of the valve spring 200
F2: Spring force of the pressure adjustment spring 220
S1: Pressure-receiving area of the valve 190
S2: Pressure-receiving area of the pressure plate 210

Rearranging Eq. (1) for P2 yields the following Eq. (2):

$$P 2 = - ( F 1 + F 2 + P 1 \times S 1 ) / ( S 2 - S 1 ) . \qquad ( 2 )$$

Here, the spring force F1 of the valve spring 200 and the spring force F2 of the pressure adjustment spring 220 are positive when in the direction of pressing the valve 190 and the pressure plate 210 (leftward in FIG. 12). The pressure P1 of the first valve chamber 121 and the pressure P2 of the first pressure control chamber 122 are configured to satisfy the relationship P1≥P2.

The pressure P2 of the first pressure control chamber 122 when the communication port 191 enters the open state is determined by Eq. (2). When the communication port 191 is in the open state, ink flows from the first valve chamber 121 to the first pressure on chamber 122 due to the configuration satisfying the relationship P1≥P2. As a result, the pressure P2 of the first pressure control chamber 122 does not decrease any further and is maintained within a certain range of pressure.

As illustrated in FIG. 12C, when the pressure plate 210 is no longer in contact with the valve shaft 190s and the communication port 191 enters the closed state, the relationship of the forces acting on the pressure plate 210 is expressed by the following Eq. (3):

$$P 3 \times S 3 + F 3 = 0 , \qquad ( 3 )$$

where F3: Spring force of the pressure adjustment spring 220 when the pressure plate 210 and the valve shaft 190s are not in contact
P3: Pressure in the first pressure control chamber 122 (gauge pressure) when the pressure plate 210 and the valve shaft 190s are not in contact
S3: Pressure-receiving area of the pressure plate 210 and the flexible member 230 when the pressure plate 210 and the valve shaft 190s are not in contact

Rearranging Eq. (3) for P3 yields the following Eq. (4):

$$P 3 = - F 3 / S 3. \qquad ( 4 )$$

FIG. 12C illustrates a state where the pressure plate 210 and the flexible member 230 have been displaced leftward in the diagram up to their displaceable limit. As the pressure plate 210 and the flexible member 230 are displaced to the state of FIG. 12C, the pressure P3 of the first pressure control chamber 122, the spring force F3 of the pressure adjustment spring 220, and the pressure-receiving area S3 of the pressure plate 210 and the flexible member 230 change with the amount of displacement. Specifically, when the pressure plate 210 and the flexible member 230 are located to the right compared to FIG. 12C, the pressure-receiving area S3 of the pressure plate 210 and the flexible member 230 decreases and the spring force F3 of the pressure adjustment spring 220 increases. As a result, the pressure P3 of the first pressure control chamber 122 decreases from the relationship of Eq. (4).

From Eqs. (2) and (4), the pressure in the first pressure control chamber 122 gradually increases (that is, the negative pressure weakens and approaches positive pressure in value) during the transition from the state of FIG. 12B to the state of FIG. 12C. More specifically, while the pressure plate 210 and the flexible member 230 gradually move leftward from the state where the communication port 191 is in the open state until the volume of the first pressure control chamber 122 reaches the displaceable limit, the pressure in the first pressure control chamber gradually increases. In other words, the negative pressure weakens. In the present embodiment, the first pressure adjustment unit 120 adjusts the pressure of the liquid in the first channel, and the second pressure adjustment unit 150 adjusts the pressure of the liquid in the pump inlet channel 170 (inlet channel).

### <Circulation Pump>

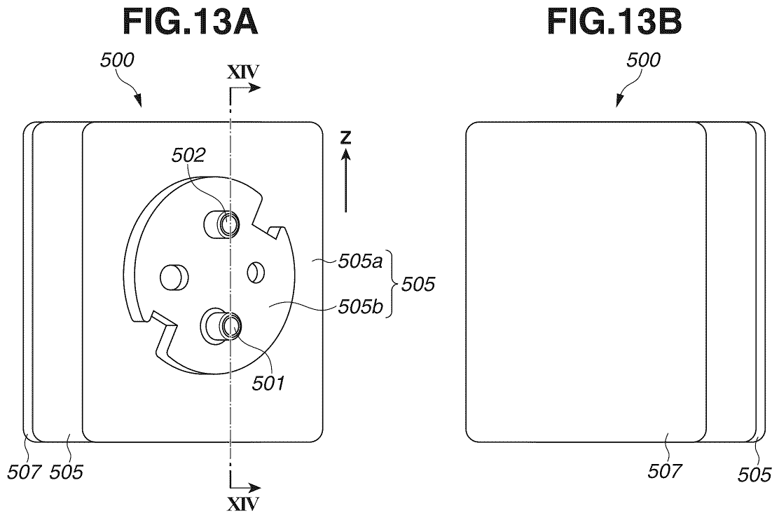

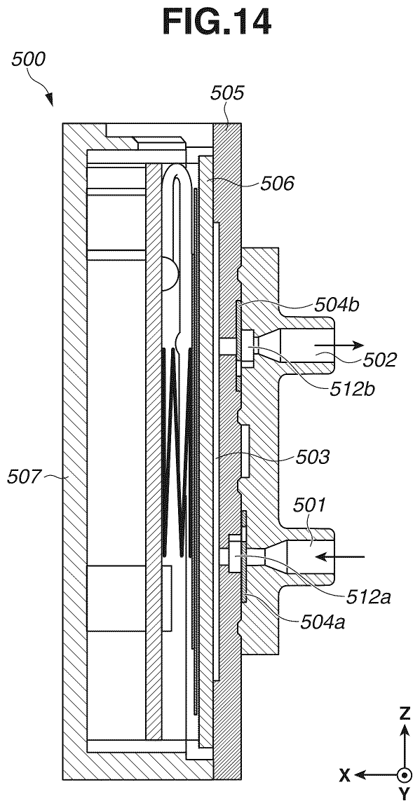

Next, the configuration and operation of the circulation pump 500 built in the foregoing liquid discharge head 1 will be described in detail with reference to FIGS. 13A, 13B, and 14.

FIGS. 13A and 13B are external perspective views of the circulation pump 500. FIG. 13A is an external perspective view illustrating the front side of the circulation pump 500. FIG. 13B is an external perspective view illustrating the rear side of the circulation pump 500. The outer shell of the circulation pump 500 includes a pump housing 505 and a cover 507 fixed to the pump housing 505. The pump housing 505 includes a housing main body 505a and a channel connection member 505b adhesively bonded and fixed to the outer surface of the housing main body 505a. The housing main body 505a and the channel connection member 505b have pairs of mutually communicating through holes formed at respective different positions. The pair of through holes formed at one of the positions forms a pump supply hole 501. The pair of through holes formed at the other position forms a pump exhaust hole 502. The pump supply hole 501 is connected to the pump inlet channel 170 connected to the second pressure control chamber 152. The pump exhaust hole 502 is connected to the pump outlet channel 180 connected to the first pressure control chamber 122. The ink supplied from the pump supply hole 501 is passed through a pump chamber 503 to be described below (see FIG. 14) and exhausted from the pump exhaust hole 502.

FIG. 14 is a sectional view of the circulation pump 500 illustrated in FIG. 13A, taken along line XIV-XIV.

A diaphragm 506 is bonded to the inner surface of the pump housing 505. The pump chamber 503 is formed between this diaphragm 506 and a recess formed in the inner surface of the pump housing 505. The pump chamber 503 communicates with the pump supply hole 501 and the pump exhaust hole 502 formed in the pump housing 505. A check valve 504a is disposed partway in the pump supply hole 501. A check valve 504b is disposed partway in the pump exhaust hole 502. In other words, the circulation pump 500 includes check valves disposed in the channel that establishes communication between the second channel and the third channel. Specifically, the check valve 504a is located to be partly movable leftward in the diagram within a space 512a formed partway in the pump supply hole 501. The check valve 504b is located to be partly movable rightward in the diagram within a space 512b formed partway in the pump exhaust hole 502.

When the diaphragm 506 is displaced to increase the volume of the pump chamber 503 and thereby depressurize the pump chamber 503, the check valve 504a separates from the opening of the pump supply hole 501 in the space 512a (i.e., moves leftward in the diagram). The separation of the check valve 504a from the opening of the pump supply hole 501 in the space 512a opens the pump supply hole 501 to allow ink flow. When the diaphragm 506 is displaced to reduce the volume of the pump chamber 503 and thereby pressurize the pump chamber 503, the check valve 504a comes into close contact with the wall surface around the opening of the pump supply hole 501. As a result, the pump supply hole 501 is closed to interrupt the ink flow.

Meanwhile, when the pump chamber 503 is depressurized, the check valve 504b comes into contact with the wall surface around the opening of the pump housing 505 and closes the pump exhaust hole 502 to interrupt ink flow. When the pump chamber 503 is pressurized, the check valve 504b separates from the opening of the pump housing 505 and moves toward the space 512b (i.e., moves rightward in the diagram), and allows ink flow through the pump exhaust hole 502.

The check valves 504a and 504b may be formed of any materials that can be deformed by the pressure in the pump chamber 503. For example, the check valves 504a and 504b can be formed of elastic members such as ethylene propylene diene Monomer (EPDM) and elastomer, or films or thin plates of polypropylene etc. However, these are not restrictive.

As described above, the pump chamber 503 is formed by bonding the pump housing 505 and the diaphragm 506. The pressure in the pump chamber 503 therefore changes as the diaphragm 506 deforms. For example, when the diaphragm 506 is displaced toward the pump housing 505 (in the diagram, displaced to the right) and the volume of the pump chamber 503 decreases, the pressure in the pump chamber 503 increases. This opens the check valve 504b opposed to the pump exhaust hole 502, and the ink in the pump chamber 503 is exhausted. Here, the check valve 504a opposed to the pump supply hole 501 comes into close contact with the wall surface around the pump supply hole 501, whereby ink backflow from the pump chamber 503 to the pump supply hole 501 is prevented.

On the other hand, when the diaphragm 506 is displaced in the direction of expanding the pump chamber 503, the pressure in the pump chamber 503 decreases. This opens the check valve 504a opposed to the pump supply hole 501, and ink is supplied to the pump chamber 503. Here, the check valve 504b disposed in the pump exhaust hole 502 comes into close contact with the wall surface around the opening formed in the pump housing 505 and closes the opening. Ink backflow from the pump exhaust hole 502 to the pump chamber 503 is thereby prevented.

In such a manner, the circulation pump 500 suctions and exhausts ink by the diaphragm 506 deforming to change the pressure in the pump chamber 503. If bubbles enter the pump chamber 503 here, the displacement of the diaphragm 506 expands and compresses the bubbles, and the amount of liquid delivery decreases because of smaller pressure changes in the pump chamber 503. In view of this, the pump chamber 503 is situated parallel to the direction of gravity to facilitate accumulation of bubbles having entered the pump chamber 503 at the upper part of the pump chamber 503. Moreover, the pump exhaust hole 502 is located above the center of the pump chamber 503. This can improve the exhaustibility of bubbles in the circulation pump 500 and stabilize the flow rate.

### <Ink Flow in Liquid Discharge Head>

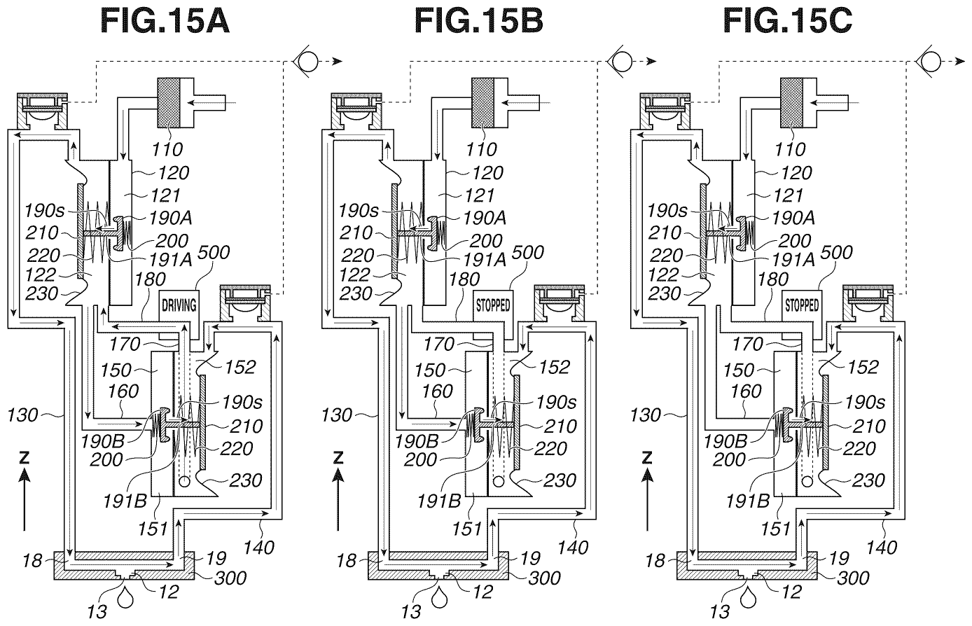

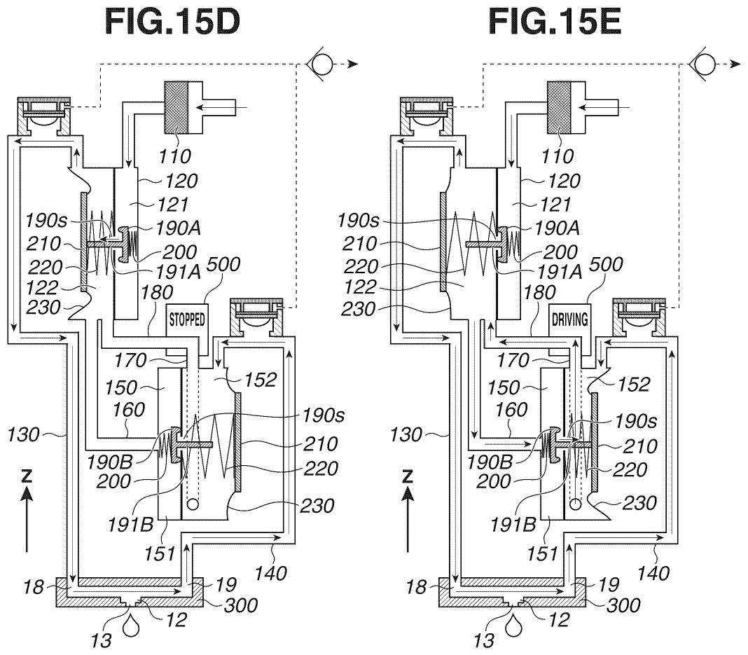

FIGS. 15A to 15E are diagrams for describing ink flow in the liquid discharge head 1. The circulation of ink in the liquid discharge head 1 will be described with reference to FIGS. 15A to 15E. For clearer description of the ink circulation path, the relative positions of the components in FIGS. 15A to 15E (such as the first pressure adjustment unit 120, the second pressure adjustment unit 150, and the circulation pump 500) are simplified. The relative positions of the components are therefore different from those in FIG. 9. FIG. 15A schematically illustrates the ink flow during a recording operation where ink is discharged from the nozzle 13 for recording. The arrows in the diagram represent the ink flow. In the present embodiment, in performing a recording operation, both the ink supply unit 400 and the circulation pump 500 start to be driven. The ink supply unit 400 and the circulation pump 500 may be driven regardless of recording operation. The ink supply unit 400 and the circulation pump 500 need not be driven in an interlocked manner, and may be separately driven independent of each other.

During the recording operation, the circulation pump 500 is ON (driving state), and the ink flowing out from the first pressure control chamber 122 flows into the supply channel 130 and the bypass channel 160. The ink flowed into the supply channel 130 passes through the discharge module 300 and then flows into the first recovery channel 140, and is then supplied to the second pressure control chamber 152.

Meanwhile, the ink entered the bypass channel 160 from the first pressure control chamber 122 flows into the second pressure control chamber 152 through the second valve chamber 151. The ink flowed into the second pressure control chamber 152 passes through the pump inlet channel 170, the circulation pump 500, and the pump outlet channel 180, and then flows into the first pressure control chamber 122 again. Here, the control pressure of the first valve chamber 121 is set higher than that of the first pressure control chamber 122 based on the relationship of the foregoing Eq. (2). The ink in the first pressure control chamber 122 therefore does not flow to the first valve chamber 121 and is supplied to the discharge module 300 via the supply channel 130 again. The ink flowed into the discharge module 300 passes through the first recovery channel 140, the second pressure control chamber 152, the pump inlet channel 170, the circulation pump 500, and the pump outlet channel 180, and flows into the first pressure control chamber 122 again. This implements the ink circulation that is complete within the liquid discharge head 1.

In the foregoing ink circulation, the circulation amount (flow rate) of ink in the discharge module 300 is determined by a differential pressure between the control pressures of the first pressure control chamber 122 and the second pressure control chamber 152. This differential pressure is set to implement a circulation amount that can prevent ink thickening near the nozzle 13 in the discharge module 300. Moreover, ink as much as consumed by recording is supplied from the ink tank 2 to the first pressure control chamber 122 via the filter 110 and the first valve chamber 121. The mechanism for supplying as much ink as consumed will be described in detail. When the ink in the circulation path decreases as much as consumed by recording, the pressure in the first pressure control chamber 122 decreases, and as a result, the ink in the first pressure control chamber 122 also decreases. The volume of the first pressure control chamber 122 decreases with the decreasing amount of ink in the first pressure control chamber 122. The decrease in the volume of the first pressure control chamber 122 opens the communication port 191A, and ink is supplied from the first valve chamber 121 to the first pressure control chamber 122. The supplied ink undergoes a pressure loss when passing through the communication port 191A from the first valve chamber 121, and the positive-pressure ink flowing into the first pressure control chamber 122 turns to negative pressure. The inflow of ink from the first valve chamber 121 into the first pressure control chamber 122 increases the pressure in the first pressure control chamber 122, whereby the volume of the first pressure control chamber 122 increases and the communication port 191A is closed. As the ink is consumed, the communication port 191A is thus opened and closed repeatedly. When the ink is not consumed, the communication port 191A is maintained closed.

FIG. 15B schematically illustrates the ink flow immediately after the recording operation ends and the circulation pump 500 is turned off (stopped state). At the point in time when the recording operation ends and the circulation pump 500 is turned off, both the pressure of the first pressure control chamber 122 and the pressure of the second pressure control chamber 152 are at the control pressures during recording operation. Ink movement illustrated FIG. 15B thus occurs depending on the difference pressure between the pressures of the first pressure control chamber 122 and the second pressure control chamber 152. Specifically, ink continues to flow so that the ink is supplied from the first pressure control chamber 122 to the discharge module 300 via the supply channel 130 and then reaches the second pressure control chamber 152 through the first recovery channel 140. Ink also continues to flow from the first pressure control chamber 122 to the second pressure control chamber 152 through the bypass channel 160 and the second valve chamber 151.

Ink as much as moved from the first pressure control chamber 122 to the second pressure control chamber 152 through such ink flows is supplied from the ink tank 2 to the first pressure control chamber 122 through the filter 110 and the first valve chamber 121. The content of the first pressure control chamber 122 is thus maintained constant. From the relationship of the foregoing Eq. (2), when the content of the first pressure control chamber 122 is constant, the spring force F1 of the valve spring 200, the spring force F2 of the pressure adjustment spring 220, the pressure-receiving area S1 of the valve 190, and the pressure-receiving area S2 of the pressure plate 210 are maintained constant. The pressure of the first pressure control chamber 122 is thus determined depending on a change in the pressure (gauge pressure) P1 of the first valve chamber 121. When the pressure P1 of the first valve chamber 121 remains unchanged, the pressure P2 of the first pressure control chamber 122 is thus maintained at the same pressure as the control pressure during recording operation.

Meanwhile, the pressure of the second pressure control chamber 152 changes over time with changes in the content due to the ink inflow from the first pressure control chamber 122. Specifically, while the state of FIG. 15B transitions to the state illustrated in FIG. 15C where the communication port 191 is closed and the second valve chamber 151 and the second pressure control chamber 152 no longer communicate, the pressure of the second pressure control chamber 152 changes according to Eq. (2). The pressure plate 210 and the valve shaft 190s then lose contact, and the communication port 191 is closed. As illustrated in FIG. 15D, ink then flows from the first recovery channel 140 into the second pressure control chamber 152. While this inflow of ink displaces the pressure plate 210 and the flexible member 230 until the second pressure control chamber 152 reaches its maximum volume, the pressure of the second pressure control chamber 152 changes according to Eq. (4). In other words, the pressure of the second pressure control chamber 152 increases.

In the state of FIG. 15C, no ink flows from the first pressure control chamber 122 to the second pressure control chamber 152 through the bypass channel 160 and the second valve chamber 151. After the ink in the first pressure control chamber 122 is supplied to the discharge module 300 via the supply channel 130, ink therefore flows only to the second pressure control chamber 152 through the first recovery channel 140. As described above, the ink movement from the first pressure control chamber 122 to the second pressure control chamber 152 occurs depending on the differential pressure between the pressures in the first pressure control chamber 122 and the second pressure control chamber 152. The ink movement thus stops when the pressure in the second pressure control chamber 152 becomes the same as that in the first pressure control chamber 122.

In the state where the pressure in the second pressure control chamber 152 is the same as that in the first pressure control chamber 122, the second pressure control chamber 152 is expanded up to the state illustrated in FIG. 15D. When the second pressure control chamber 152 is expanded as illustrated in FIG. 15D, the second pressure control chamber 152 forms a storage portion capable of storing ink. The transition from the stop of the circulation pump 500 to the state of FIG. 15D takes approximately one to two minutes, depending on the shapes and sizes of the channels and the ink properties. When the circulation pump 500 is driven from the state illustrated in FIG. 15D where ink is stored in the storage portion, the ink in the storage portion is supplied to the first pressure control chamber 122 by the circulation pump 500. This increases the amount of ink in the first pressure control chamber 122 as illustrated in FIG. 15E, and the flexible member 230 and the pressure plate 210 are displaced in the expanding direction. When the circulation pump 500 continues to be driven, the internal state of the circulation path changes as illustrated in FIG. 15A.

In the foregoing description, FIG. 15A is described to illustrate an example during a recording operation. However, as described above, ink may be circulated without performing recording operations. Even in such a case, ink flows as illustrated in FIGS. 15A to 15E depending on the driving and stop of the circulation pump 500.

As described above, in the present embodiment, the communication port 191B of the second pressure adjustment unit 150 opens when the circulation pump 500 is driven to circulate ink, and closes when the ink circulation is stopped. However, such an example is not restrictive. The control pressures may be set so that the communication port 191B of the second pressure adjustment unit 150 closes even while the circulation pump 500 is driven to circulate ink. A specific description will now be given in conjunction with the role of the bypass channel 160.

The bypass channel 160 connecting the first pressure adjustment unit 120 and the second pressure adjustment unit 150 is provided to prevent the discharge module 300 from being affected when the negative pressure occurring in the circuit path becomes stronger than a predetermined value, for example. The bypass channel 160 is also provided to supply ink to the pressure chamber 12 both from the supply channel 130 and the first recovery channel 140.

Initially, an example where the provision of the bypass channel 160 prevents the discharge module 300 from being affected by negative pressure that exceeds a predetermined value will be described. For example, ink properties (such as viscosity) may vary due to changes in environmental temperature. When the ink viscosity changes, the pressure loss within the circulation path also changes. For example, when the ink viscosity decreases, the pressure loss within the circulation path decreases. As a result, the flow rate of the circulation pump 500 driven at a constant driving amount increases, and the flow rate through the discharge module 300 increases. Meanwhile, the discharge module 300 is maintained at a constant temperature by a not-illustrated temperature adjustment mechanism, and the viscosity of the ink in the discharge module 300 is maintained constant regardless of changes in the environmental temperature. Since the viscosity of the ink in the discharge module 300 remains unchanged while the flow rate of the ink flowing through the discharge module 300 increases, the negative pressure in the discharge module 300 increases accordingly because of channel resistance. If the negative pressure in the discharge module 300 thus becomes stronger than a predetermined value, the meniscus at the nozzle 13 may be destroyed and outside air may be drawn into the circulation path, whereby normal discharge can fail to be performed. Even if the meniscus is not destroyed, the negative pressure in the pressure chamber 12 can be stronger than a predetermined value and discharge can be affected.

In view of this, in the present embodiment, the bypass channel 160 is formed within the circulation path. The provision of the bypass channel 160 can maintain the pressure of the discharge module 300 constant, since ink also flows through the bypass channel 160 if the negative pressure is stronger than the predetermined value. For example, the communication port 191B of the second pressure adjustment unit 150 may be configured with a control pressure that maintains the closed state even when the circulation pump 500 is being driven. The control pressure of the second pressure adjustment unit 150 then may be set so that the communication port 191 of the second pressure adjustment unit 150 opens when the negative pressure is stronger than the predetermined value. In other words, if the meniscus does not collapse or a predetermined negative pressure is maintained despite changes in the pump flow rate due to environmental changes such as viscosity change, the communication port 191B may be in the closed state while the circulation pump 500 is being driven.

Next, an example where the bypass channel 160 is provided to supply ink to the pressure chamber 12 from both the supply channel 130 and the first recovery channel 140 will be described. The pressure in the circulation path can also vary because of discharge operations by the discharge element 15. The reason is that the discharge operations produce force to draw ink into the pressure chamber 12.

The following describes how ink is supplied to the pressure chamber 12 from both the supply channel 130 and the first recovery channel 140 when high-duty recording is continued. Duty can be defined differently depending on various conditions. As employed herein, a state where one 4-pl ink droplet is discharged to record a 1200-dpi grid will be referred to as 100% duty. High-duty recording refers to recording performed at 100% duty, for example.

When high-duty recording is continued, the amount of ink flowing from the pressure chamber 12 into the second pressure control chamber 152 through the first recovery channel 140 decreases. Meanwhile, the circulation pump 500 sends out ink at a constant rate. This makes the inflow and outflow to/from the second pressure control chamber 152 imbalanced. The ink in the second pressure control chamber 152 decreases, the negative pressure in the second pressure control chamber 152 becomes stronger, and the second pressure control chamber 152 contracts. The strong negative pressure in the second pressure control chamber 152 increases the amount of ink flowing into the second pressure control chamber 152 via the bypass channel 160, and the second pressure control chamber 152 stabilizes with the inflow and outflow balanced. In this way, the negative pressure in the second pressure control chamber 152 consequently becomes stronger with the duty. Moreover, in the foregoing configuration where the communication port 191B is closed when the circulation pump 500 is being driven, the communication port 191B opens depending on the duty, and ink flows into the second pressure control chamber 152 from the bypass channel 160.

As high-duty recording is continued further, the amount of inflow from the pressure chamber 12 to the second pressure control chamber 152 through the first recovery channel 140 decreases, and the amount of inflow from the bypass channel 160 to the second pressure control chamber 152 via the communication port 191B increases instead. When this state advances further, the amount of ink flowing from the pressure chamber 12 into the second pressure control chamber 152 through the first recovery channel 140 becomes zero, and all the ink flowing into the circulation pump 500 passes through the communication port 191B. When this state advances further, the ink then flows back from the second pressure control chamber 152 to the pressure chamber 12 through the first recovery channel 140. In this state, both the inks flowed out from the second pressure control chamber 152 to the circulation pump 500 and to the pressure chamber 12 flow into the second pressure control chamber 152 through the bypass channel 160 and the communication port 191B. In such a case, the pressure chamber 12 is filled with ink from the supply channel 130 and ink from the first recovery channel 140, and the filled ink is discharged.

This backflow of ink at high recording duty is a phenomenon that occurs because of the provision of the bypass channel 160. While in the foregoing description the communication port 191B of the second pressure adjustment unit 150 is described to open in response to the ink backflow, ink backflow can also occur when the communication port 191B of the second pressure adjustment unit 150 is in the open state. Even in a configuration without the second pressure adjustment unit 150, the foregoing ink backflow can also occur because of the provision of the bypass channel 160. The bypass channel 160 may only establish communication between at least either the first channel or the first pressure adjustment unit 120 and the second channel without the intermediary of the pressure chamber 12.

### <Configuration of Discharge Unit>

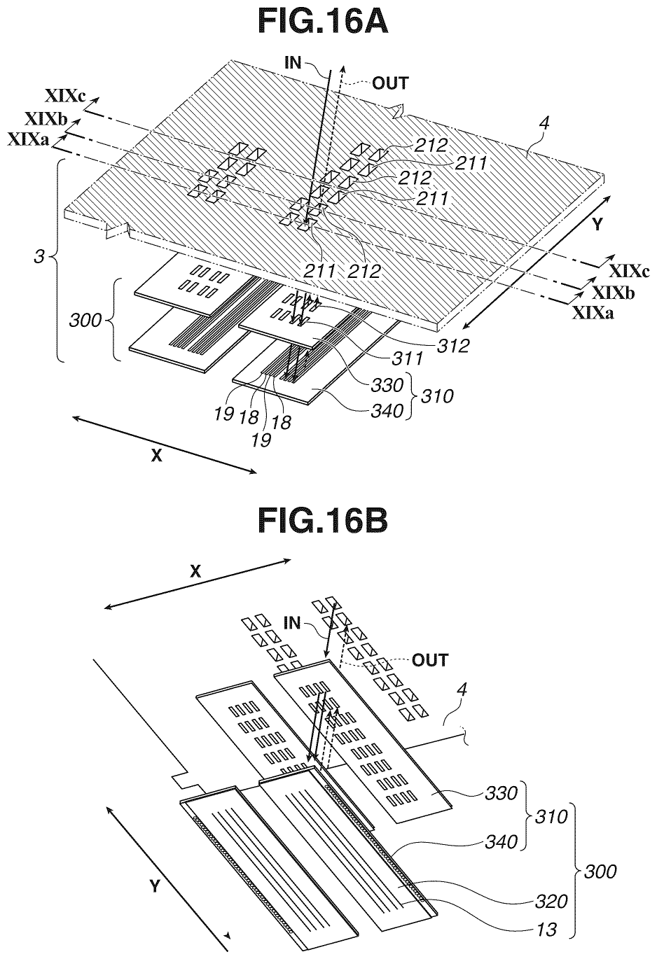

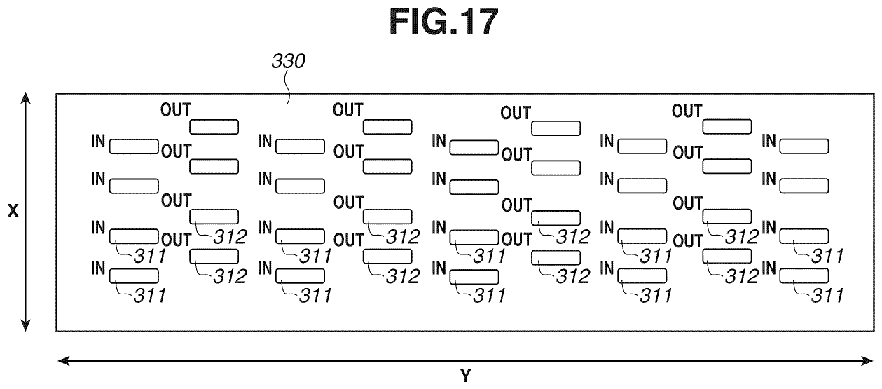

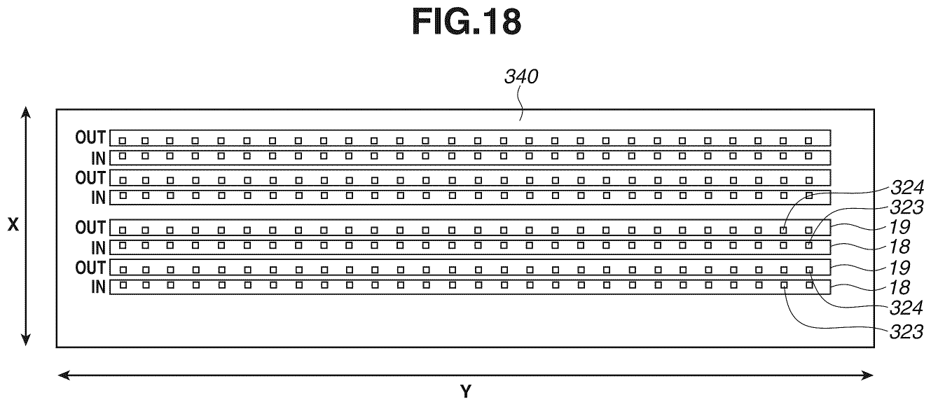

FIGS. 16A and 16B are schematic diagrams illustrating a circulation path for one color ink in the discharge unit 3 according to the present embodiment. FIG. 16A is an exploded perspective view of the discharge unit 3 seen from the first support member 4 side. FIG. 16B is an exploded perspective view of the discharge unit 3 seen from the discharge module 300 side. In the diagrams, the arrows denoted by IN and OUT represent the ink flow. While the flow of only one color ink is described, the same applies to the flow of the other color inks. In FIGS. 16A and 16B, the second support member 7 and the electrical wiring member 5 are omitted, and a description thereof is also omitted in the following description of the configuration of the discharge unit 3. FIG. 16A illustrates the first support member 4 in a cross section taken along line XVI-XVI of FIG. 8. As described above, each discharge module 300 includes a silicon substrate 310 and a plurality of discharge elements 15. The silicon substrate 310 includes a discharge element substrate 340 and an opening plate 330. FIG. 17 is a diagram illustrating the opening plate 330. FIG. 18 is a diagram illustrating the discharge element substrate 340.

The discharge unit 3 is supplied with ink from the circulation unit 54 via the joint member 8 (see FIG. 8A). The ink path after the ink passes through the joint member 8 until the ink returns to the joint member 8 will be described. In the drawings referred to below, the joint member 8 is omitted.

The discharge module 300 includes the discharge element substrate 340 and the opening plate 330 that constitute the silicon substrate 310, and further includes the nozzle formation member 320. The discharge element substrate 340, the opening plate 330, and the nozzle formation member 320 constitute the discharge module 300 by being stacked and bonded so that the ink channels for each ink communicate, and are supported on the first support member 4. The discharge unit 3 is formed by the discharge modules 300 being supported on the first support member 4. The nozzle formation member 320 is disposed on the surface (in FIG. 16B, bottom surface) of the discharge element substrate 340. The nozzle formation member 320 includes a plurality of nozzle rows where a plurality of nozzles 13 are arranged in rows, and discharges part of ink supplied via the ink channels in the discharge module 300 from the nozzles 13. Ink left undischarged is recovered via the ink channels in the discharge module 300.

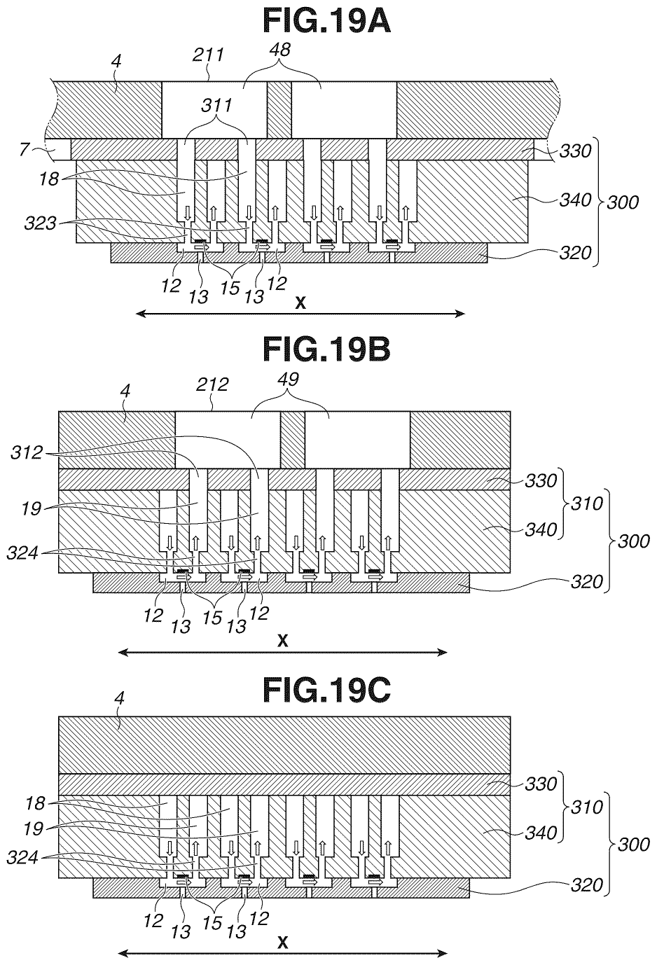

As illustrated in FIGS. 16A, 16B, and 17, the opening plate 330 includes an array of a plurality of ink supply ports 311 and an array of a plurality of ink recovery ports 312. As illustrated in FIGS. 18 and 19A to 19C, the discharge element substrate 340 includes an array of a plurality of supply connection channels 323 and an array of a plurality of recovery connection channels 324. The discharge element substrate 340 further includes a common supply channel 18 communicating with the plurality of supply connection channels 323 and a common recovery channel 19 communicating with the plurality of recovery connection channels 324. The ink path within the discharge unit 3 is formed by establishing communication between the ink supply channel 48 and ink recovery channel 49 (see FIG. 8A) formed in the first support member 4 and the channels formed in the discharge module 300. Support member supply ports 211 are sectional openings constituting the ink supply channel 48. Support member recovery ports 212 are sectional openings constituting the ink recovery channel 49.

The ink to be supplied to the discharge unit 3 is supplied to the ink supply channel 48 (see FIG. 8A) of the first support member 4 from the circulation unit 54 (see FIG. 8A). The ink flowing through the support member supply ports 211 within the ink supply channel 48 is supplied to the common supply channel 18 of the discharge element substrate 340 via the ink supply channel 48 (see FIG. 8A) and the ink supply ports 311 of the opening plate 330, and enters the supply connection channels 323. The path so far constitutes a supply-side channel. The ink then flows through the pressure chambers 12 (see FIG. 8B) of the nozzle formation member 320 to the recovery connection channels 324 that are a recover-side channel. Details of the ink flow in the pressure chambers 12 will be described below.

In the recovery-side channel, the ink entered the recovery connection channels 324 of the discharge element substrate 340 flows to the common recovery channel 19. The ink then flows from the common recovery channel 19 to the ink recovery channel 49 of the first support member 4 via the ink recovery ports 312 of the opening plate 330, and is recovered into the circulation unit 54 through the support member recovery ports 212.

The regions of the opening plates 330 where neither the ink supply ports 311 nor the ink recovery ports 312 are formed correspond to the regions of the first support member 4 for partitioning the support member supply ports 211 and the support member recovery ports 212. The first support member 4 has no opening in these regions, either. These regions are used as adhesion regions in adhesively bonding the discharge module 300 and the first support member 4.

As illustrated in FIG. 17, the opening plate 330 includes a plurality of opening rows arranged in the Y direction, each including a plurality of openings arranged in the X direction. Supply (IN) openings and recovery (OUT) openings are alternately arranged in the Y direction, with offsets of one-half pitch in the X direction. The ink supply ports 311 form supply (IN) openings, and the ink recovery ports 312 form recovery (OUT) openings. As illustrated in FIG. 18, the discharge element substrate 340 includes common supply channels 18 and common recovery channels 19 alternately arranged in the X direction. The common supply channels 18 communicate with a plurality of supply connection channels 323 arranged in the Y direction. The common recovery channels 19 communicate with a plurality of recovery connection channels 324 arranged in the Y direction. The common supply channels 18 and the common recovery channels 19 are divided by ink type. The numbers of common supply channels 18 and common recovery channels 19 to be arranged are determined by the number of nozzle rows of each color.

The supply connection channels 323 and the recovery connection channel 324 are provided in numbers correspond to the nozzles 13. This may not mean one-to-one correspondence, and one supply connection channel 323 and one recovery connection channel 324 may correspond to a plurality of nozzles 13.

Such an opening plate 330 and the discharge element substrate 340 are stacked and bonded so that the respective ink channels communicate with each other, whereby the discharge module 300 is constituted. The discharge module 300 is supported on the first support member 4 to form ink channels including the foregoing supply channels and recovery channels.

FIG. 19A to 19C are sectional views illustrating ink flow in different portions of the discharge unit 3. FIG. 19A is a sectional view taken along line XIXa-XIXa of FIG. 16A, and illustrates a cross section of a portion of the discharge unit 3 where the ink supply channels 48 and inks supply ports 311 communicate with each other.

FIG. 19B illustrates a sectional view taken along line XIXb-XIXb of FIG. 16A, and illustrates a cross section of a portion of the discharge unit 3 where the ink recovery channels 49 and ink recovery port 312 communicate with each other. FIG. 19C is a sectional view taken along line XIXc-XIXc of FIG. 16A, and illustrates a cross section of a portion where the ink supply ports 311 and the ink recovery ports 312 do not communicate with the channels of the first support member 4.

As illustrated in FIG. 19A, the ink-supplying channels supply ink through the portions where the ink supply channels 48 of the first support member 4 and the ink supply ports 311 of the opening plate 330 overlap and communicate. As illustrated in FIG. 19B, the ink-recovering channels recover ink through the portions where the ink recovery channels 49 of the first support member 4 and the ink recovery ports 312 of the opening plate 330 overlap and communicate. As illustrated in FIG. 19C, in the discharge unit 3, there are regions where the opening plate 330 do not have openings. In such regions, ink supply or recovery is not performed between the discharge element substrate 340 and the first support member 4. Ink supply is performed at the regions provided with the ink supply ports 311 as in FIG. 19A. Ink recovery is performed at the regions provided with the ink recovery ports 312 as in FIG. 19B. In the present embodiment, a configuration using the opening plate 330 has been described as an example. However, a configuration without the opening plate 330 may also be employed. For example, channels corresponding to the ink supply channels 48 and the ink recovery channels 49 may be formed in the first support member 4, and the discharge element substrate 340 may be bonded to the first support member 4.

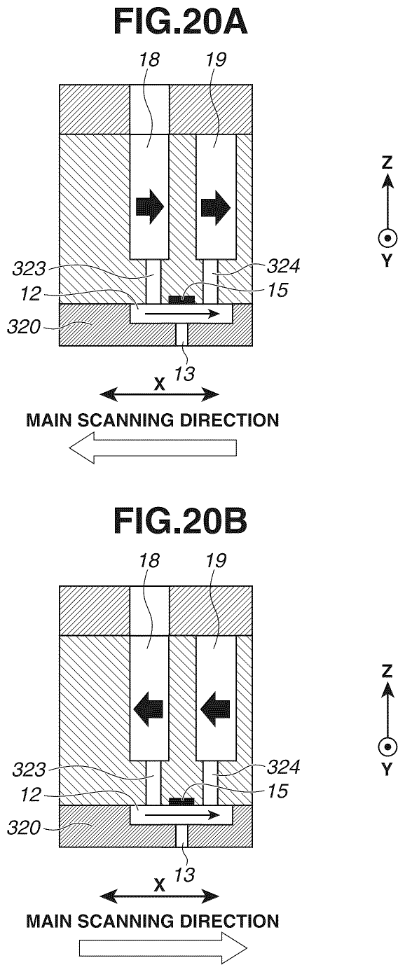

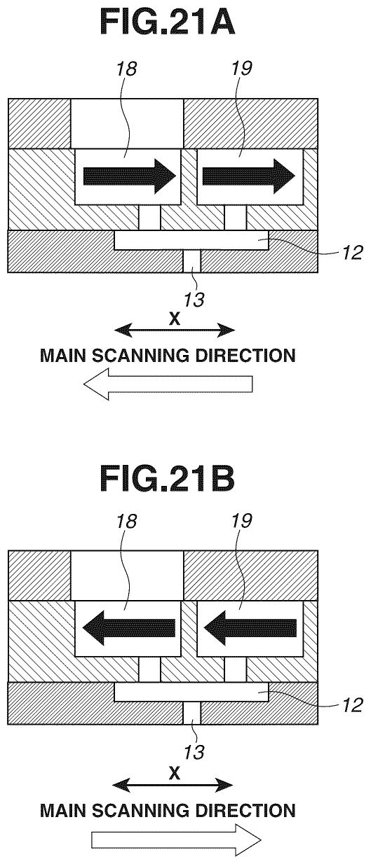

FIGS. 20A and 20B are sectional views illustrating the vicinity of a nozzle 13 in the discharge module 300. FIGS. 21A and 21B are sectional views illustrating a discharge module configured so that the common supply channel 18 and the common recovery channel 19 are extended in the X direction as a comparative example. The thick arrows illustrated in the common supply channel 18 and the common recovery channel 19 in FIGS. 20A, 20B, 21A, and 21B indicate sway of the ink in the configuration using the serial liquid discharge apparatus 50. The ink supplied to the pressure chamber 12 through the common supply channel 18 and the supply connection channel 323 is discharged from the nozzle 13 when the discharge element 15 is driven. When the discharge element 15 is not driven, the ink passes through the pressure chamber 12 and is recovered to the common recovery channel 19 through the recovery connection channel 324.

In the configuration using the serial liquid discharge apparatus 50, when the ink circulating in such a manner is discharged, the ink discharge is considerably affected by the ink sway in the ink channels due to the main scanning of the liquid discharge head 1. Specifically, the effect of the ink way in the ink channels can appear as variations in the ink discharge amount or deviations in the discharge direction. If, as illustrated in FIGS. 21A and 21B, the common supply channel 18 and the common recovery channel 19 have a sectional shape wide in the X direction that is the main scanning direction, the ink in the common supply channel 18 and the common recovery channel 19 is susceptible to inertial force in the main scanning direction, and sways considerably. As a result, the ink discharge from the nozzle 13 can be affected by the ink sway. Moreover, extending the common supply channel 18 and the common recovery channel 19 in the X direction also increases the color-to-color distance, which can possibly lower printing efficiency.

In view of this, the common supply channel 18 and the common recovery channel 19 according to the present embodiment are configured to extend in the Y direction in the cross sections illustrated in FIGS. 20A and 20B, and also extend in the Z direction orthogonal to the X direction that is the main scanning direction. Such a configuration can reduce the channel widths of the common supply channel 18 and the common recovery channel 19 in the main scanning direction. The reduced channel widths of the common supply channel 18 and the common recovery channel 19 in the main scanning direction decrease the ink sway (see the thick black arrows in the diagrams) due to the inertial force in the direction opposite to the main scanning direction, acting on the ink in the common supply channel 18 and the common recovery channel 19 during main scanning. This can reduce the effect of the ink sway on ink discharge. Moreover, extending the common supply channel 18 and the common recovery channel 19 in the Z direction increases the sectional areas of the common supply channel 18 and the common recovery channel 19 for reduced channel pressure loss.

As described above, the common supply channel 18 and the common recovery channel 19 are configured with reduced channel widths in the main scanning direction so that the ink sway in the common supply channel 18 and the common recovery channel 19 during main scanning decreases. However, the ink sway does not disappear. In the present embodiment, to reduce discharge variations between ink types, which still arise from the reduced ink sway, the common supply channel 18 and the common recovery channel 19 are aligned with each other in the X direction.

As described above, in the present embodiment, the supply connection channels 323 and the recovery connection channels 324 are provided to correspond to the nozzles 13, and arranged in the X direction with the nozzles 13 therebetween. If there is a portion where the common supply channel 18 and the common recovery channel 19 do not overlap in the X direction and the correspondence of the supply connection channels 323 and the recovery connection channels 324 in the X direction does not hold, the flow or discharge of ink in the X direction within the pressure chambers 12 is affected. When this is combined with the effect of the ink sway, the ink discharge at each nozzle 13 can be further affected.

With the common supply channel 18 and the common recovery channel 19 aligned in the X direction, ink sways similarly in the common supply channel 18 and the common recovery channel 19 during main scanning, regardless of the positions where the nozzles 13 are arranged in the Y direction. This enables stable discharge without significant variations in pressure difference between the common supply channel 18 side and the common recovery channel 19 side in the pressure chambers 12.

Some ink-circulating liquid discharge heads are configured to supply ink and recover ink using the same channel. In the present embodiment, the common supply channel 18 and the common recovery channel 19 are configured as separate channels. Moreover, the supply connection channels 323 communicate with the pressure chambers 12, the pressure chambers 12 communicate with the recovery connection channels 324, and ink is discharged from the nozzles 13 in the pressure chambers 12. In other words, the pressure chambers 12 that are channels connecting the supply connection channels 323 and the recovery connection channels 324 are configured to include the nozzles 13. In the pressure chambers 12, ink therefore flows from the supply connection channel 323 side to the recovery connection channel 324 side, whereby the ink in the pressure chambers 12 is efficiently circulated. The efficient ink circulation in the pressure chambers 12 can keep fresh the ink in the pressure chambers 12 that is susceptible to the effects of ink evaporation at the nozzles 13.

Since the two common channels, namely, the common supply channel 18 and the common recovery channel 19 communicate with the pressure chambers 12, ink can even be supplied from both channels when discharge needs to be performed at high flow rate. In other words, compared to the configuration where ink is supplied and recovered through a single channel, the configuration of the present embodiment has the advantage of not only enabling efficient circulation but accommodating high flow rate discharge as well.

The closer the common supply channel 18 and the common recovery channel 19 are located in the X direction, the less likely the effects of ink sway are to occur. The common supply channel 18 and the common recovery channel 19 are desirably configured at a channel-to-channel distance of 75 μm to 100 μm (micrometer).

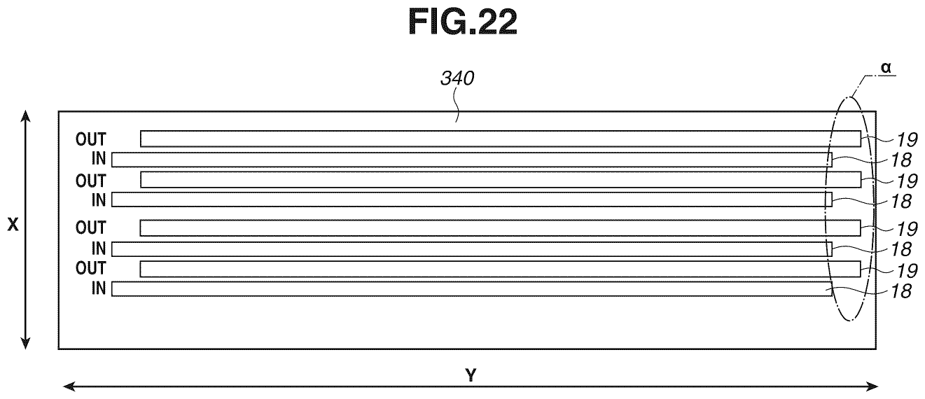

FIG. 22 is a diagram illustrating a discharge element substrate 340 according to a comparative example. In FIG. 22, the supply connection channels 323 and the recovery connection channels 324 are omitted. Since ink undergoing thermal energy of the discharge elements 15 in the pressure chambers 12 flows into the common recovery channels 19, the temperature of the ink flowing in the common recovery channels 19 is relatively high compared to that of the ink in the common supply channels 18. In the comparative example, the discharge element substrate 340 includes a portion where only the common recovery channels 19 exist in the X direction, like portion a surrounded by the dot-dashed line in FIG. 22. In such a case, the locally high temperature in that portion causes temperature unevenness within the discharge module 300, whereby discharge can be affected.

Compared to the common recovery channels 19, ink of a relatively low temperature flows through the common supply channels 18. If the common supply channels 18 and the common recovery channels 19 are adjacent to each other, the temperatures are partly canceled out between the common supply channels 18 and the common recovery channels 19 in their vicinity, which suppresses the temperature increase. The common supply channels 18 and the common recovery channels 19 can therefore have substantially the same lengths, and be located to be aligned in the X direction and adjacent to each other.

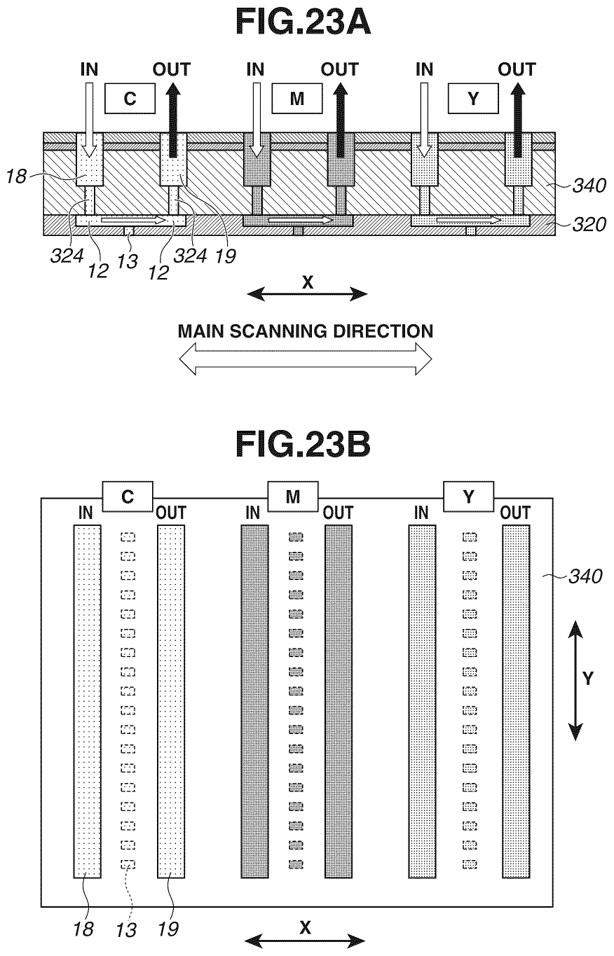

FIGS. 23A and 23B are diagrams illustrating a channel configuration of a liquid discharge head corresponding to C, M, and Y, three types of inks. As illustrated in FIG. 23A, the liquid discharge head corresponding to the three types of inks include circulation paths for the respective types of inks. The pressure chambers 12 are disposed along the X direction that is the main scanning direction of the liquid discharge head. As illustrated in FIG. 23B, the common supply channels 18 and the common recovery channels 19 are located along nozzle rows in which nozzles 13 are arranged, and are disposed to extend in the Y direction with the nozzle rows therebetween.

### <Ink Backflow Near Nozzles>

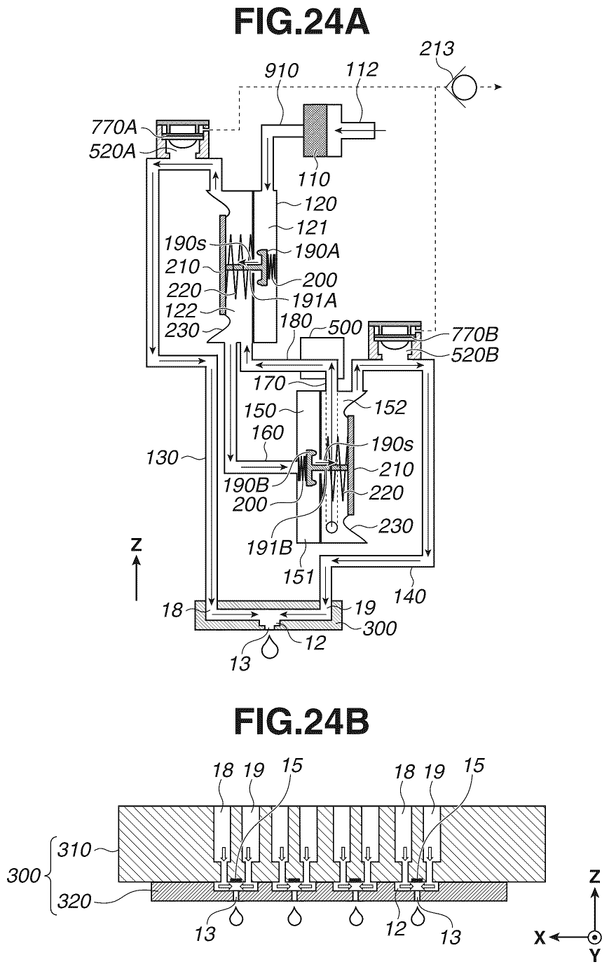

FIGS. 24A and 24B are diagrams schematically illustrating ink backflow near nozzles 13. FIG. 24A is a longitudinal sectional view schematically illustrating ink backflow occurring in the circulation path illustrated in FIG. 10A. FIG. 24B is an enlarged view schematically illustrating ink backflow occurring in the discharge module 300 illustrated in FIG. 8B. FIGS. 24A and 24B illustrate how ink flows from the common supply channel 18 and the common recovery channel 19 into the pressure chambers 12, passes through the pressure chambers 12, and flows out from the nozzles 13. As described above, when high-duty recording is continued, ink also flows backward from the first recovery channel 140 side to the pressure chambers 12. In other words, as illustrated in FIGS. 24A and 24B, the pressure chambers 12 are refilled with ink from both the supply channels 130 (common supply channels 18) and the first recovery channels 140 (common recovery channels 19).

More specifically, the ink supplied from the first pressure control chamber 122 to the bypass channel 160 is supplied to the second pressure control chamber 152 via the second valve chamber 151 of the second pressure adjustment unit 150. Part of the ink supplied to the second pressure control chamber 152 is then supplied to the first recovery channel 140, and supplied to the nozzle 13 via the common recovery channel 19.

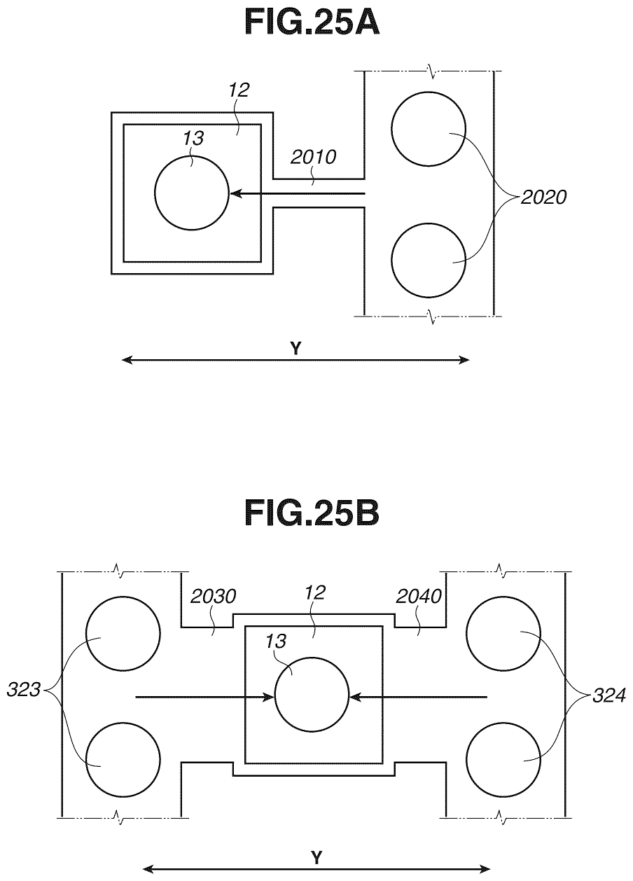

FIGS. 25A and 25B are diagrams for describing ink supply within the discharge module 300. FIG. 25A is a diagram illustrating a channel configuration near the pressure chamber 12, illustrating a comparative example different from the present embodiment. In FIG. 25A, the pressure chamber 12 communicates with a channel 2010 at only one side. In this configuration, the ink supply to the pressure chamber 12 is a one-sided supply only through the channel 2010. In the configuration of FIG. 25A, independent supply ports 2020 communicating with the pressure chamber 12 are connected to the common supply channel 18 or the common recovery channel 19, or both. If the discharge element 15 is a thermal discharge element in particular, ink is discharged from the nozzle 13 through bubble formation within the pressure chamber 12. The pressure chamber 12 is then refilled with ink through bubble collapse associated with the bubble formation. In such a channel configuration, backward resistance during bubble formation is increased by reducing the width or increasing the length of the channel 2010 connected to the pressure chamber 12. This makes the bubble formation more symmetrical and improves droplet formation. However, in the configuration of FIG. 25A, the supply performance deteriorates because of the increased backward resistance in refilling the pressure chamber 12 with ink upon bubble collapse after discharge. With the channel configuration illustrated in FIG. 25A, the refill frequency is thus typically difficult to improve. In particular, in performing recording operations at high duty, the amount of ink supplied to the nozzle 13 decreases and the discharge stability may deteriorate.

FIG. 25B is a diagram illustrating the channel configuration near the pressure chamber 12 according to the present embodiment. The supply connection channels 323 that are first independent supply ports connect a first liquid channel 2030 leading to the pressure chamber 12 with the common supply channel 18. The recovery connection channels 324 that are second independent supply ports connect a second liquid channel 2040 leading to the pressure chamber 12 with the common recovery channel 19. As described above, in the present embodiment, as much ink as discharged from the nozzle 13 is refilled from the first liquid channel 2030 and the second liquid channel 2040. As illustrated in FIG. 25B, the pressure chamber 12 has a two-sided supply configuration communicating with the first liquid channel 2030 and the second liquid channel 2040 at both sides. With such a configuration, as illustrated in FIG. 25B, bubble formation tends to be more symmetrical because of the symmetrical backward resistances during the bubble formation even if the channels leading to the pressure chamber 12 are increased in width or reduced in length. This makes the formation of ink droplets easier to improve. Moreover, since the backward resistances do not need to be increased, the ink supply performance can be improved in refilling the pressure chamber 12 with ink upon bubble collapse after discharge. According to the present embodiment, the discharge stability can thus be improved even when recording operations are performed at high duty. In other words, droplet formation and refill frequency both can be improved in a compatible manner.

While the foregoing embodiment has mainly dealt with the case of using thermal discharge elements, piezoelectric discharge elements may be used. However, the present embodiment is more suitable for thermal discharge elements, since thermal discharge elements are more difficult to improve both droplet formation and refill frequency in a compatible manner.

### <Connection of Main Body Unit and Liquid Discharge Head>

FIG. 26 is a schematic diagram illustrating how the ink tank 2 and the ink supply unit 400 provided in a main body unit of the liquid discharge apparatus 50 according to the present embodiment are connected to the liquid discharge head 1. The liquid discharge apparatus 50 according to the present embodiment has a configuration that enables easy replacement of only the liquid discharge head 1 in the event of a malfunction of the liquid discharge head 1. Specifically, the main body-side control member 470 and the head-side connection member 800 are provided that facilitate the connection and disconnection of the second supply paths 112 and the third air channel 113 connected to the ink supply unit 400 to/from the liquid discharge head 1. The liquid discharge head 1 alone can thus be easily attached to and detached from the liquid discharge apparatus 50.

As illustrated in FIG. 26, the head-side connection member 800 is detachably attached to the head housing 53 of the liquid discharge head 1. The head-side connection member 800 is connected to the ink supply paths (third supply paths 910) in the circulation units 54 via the filters 110. The head-side connection member 800 is also connected to the first debubbling units 770A and the second debubbling units 770B via degassing channels 541 in the circulation units 54.

The main body-side connection member 470 is disposed at the ends of the second supply paths 112 and the third air channel 113. The second supply paths 112 are also referred to as ink supply tubes 450. The third air channel 113 is also referred to as a degassing tube 460. The main body-side connection member 470 is connected to the second supply paths 112 (ink supply tubes 450) and the third air channel 113 (degassing tube 460).

The main body-side connection member 470 is detachably connected to the head-side connection member 800 attached to the head housing 53. With the main body-side connection member 470 connected to the head-side connection member 800, the second supply paths 112 communicate with the ink supply paths (third supply paths 910) in the circulation units 54 via the filters 110. With the main body-side connection member 470 connected to the head-side connection member 800, the third air channel 113 communicates with the degassing channels 541 in the circulation units 54. The second supply paths 112 (ink supply tubes 450) and the third air channel 113 (degassing tube 460) leading to the ink supply unit 400 can thus be easily connected to and disconnected from the liquid discharge head 1. This facilitates the attachment, detachment, and replacement operations of the liquid discharge head 1.

### <Configuration of Debubbling Units>

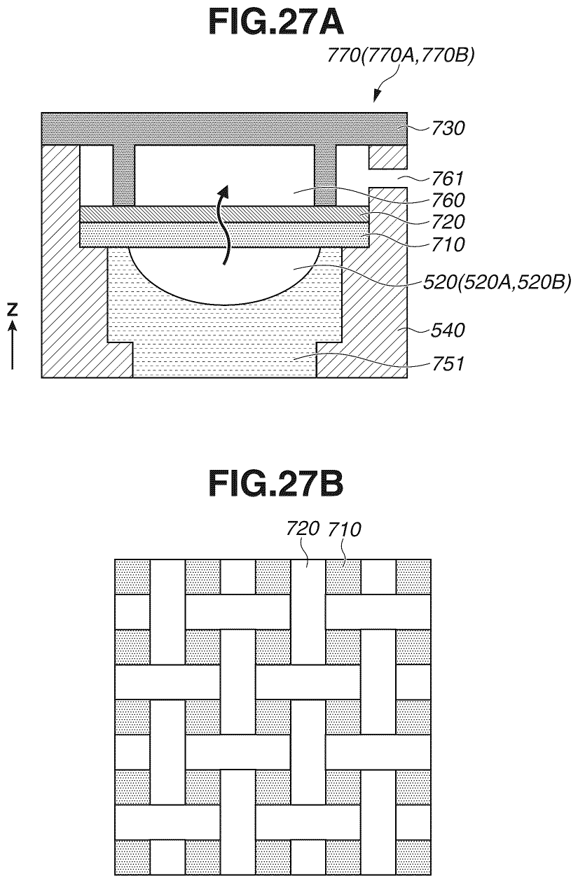

FIGS. 27A and 27B are schematic diagrams illustrating a debubbling unit 770. FIG. 27A is a sectional view of the debubbling unit 770. FIG. 27B is a schematic diagram illustrating a deformation suppression member 720 of the debubbling unit 770. The second debubbling unit 770B has a configuration similar to that of the first debubbling unit 770A. The second bubble accumulation chamber 520B has a configuration similar to that of the first bubble accumulation chamber 520A. The first debubbling unit 770A and the second debubbling unit 770B may therefore be described collectively as a debubbling unit 770. The first bubble accumulation chamber 520A and the second bubble accumulation chamber 520B may be described collectively as a bubble accumulation chamber 520. As illustrated in FIG. 27A, the debubbling unit 770 (first debubbling unit 770A and second debubbling unit 770B) includes the bubble accumulation chamber 520 (first bubble accumulation chamber 520A and second bubble accumulation chamber 520B) and a depressurization chamber 760. The debubbling unit 770 also includes a gas permeable membrane 710, the deformation suppression member 720, a first communication port 751 for establishing communication between the bubble accumulation chamber 520 and a liquid channel or liquid chamber, and a second communication port 761 for establishing communication between the depressurization chamber 760 and the ink supply unit 400.

The debubbling unit 770 (first debubbling unit 770A and second debubbling unit 770B) communicates with the ink supply unit 400 disposed in the main body unit of the liquid discharge apparatus 50, and is depressurized by the operation of the ink supply unit 400. A third check valve 213 is disposed between the debubbling unit 770 and the ink supply unit 400, whereby the depressurized state is maintained to enable debubbling operation without the liquid discharge apparatus 50 operating constantly. Third check valves 213 may be disposed in the respective branches of the third air channel 113 between the ink supply unit 400 and the first and second debubbling units 770A and 770B. A third check valve 213 may be disposed in the integral portion of the third air channel 113 between the ink supply unit 400 and the first and second debubbling units 770A and 770B.

As illustrated in FIG. 10A, the first debubbling unit 770A is disposed vertically above the supply channel 130, and the second debubbling unit 770B is disposed vertically above the first recovery channel 140. However, this is not restrictive. For example, only one debubbling unit 770 (first debubbling unit 770A) may be disposed on the supply channel 130. The debubbling unit 770 may be disposed vertically above the ink tank 2, the first supply path 111, the second supply path 112, the third supply path 910, the filter 110, the pump inlet channel 170, the pump outlet channel 180, the bypass channel 160, the pressure chamber 12, or the like. As illustrated in FIG. 10B, the first bubble accumulation chamber 520A may communicate with the supply channel 130 sideways, and the first debubbling unit 770A may be formed to extend sideways from the first bubble accumulation chamber 520A. The second bubble accumulation chamber 520B may communicate with the first recovery channel 140 sideways, and the second debubbling unit 770B may be formed to extend sideways from the second bubble accumulation chamber 520B. The bubble accumulation chamber 520 may communicate sideways with a fluid communication portion other than the supply channel 130 and the first recovery channel 140, and the debubbling unit 770 may be formed to extend sideways from the bubble accumulation chamber 520 as long as the configuration can collect bubbles and cause the bubbles to contact the gas permeable membrane 710.

In other words, the debubbling unit 770 may be formed to extend horizontally from the bubble accumulation chamber 520 instead of vertically above the bubble accumulation chamber 520.

### <Gas Permeable Membrane>

As illustrated in FIG. 27A, the gas permeable membrane 710 is disposed in the housing portion of the circulation unit 54 that forms the bubble accumulation chamber 520 so that the bubble accumulation chamber 520 is separated from the depressurization chamber 760. The housing portion of the circulation unit 54 that forms the bubble accumulation chamber 520 will hereinafter be referred to as a unit housing 540.

The gas permeable membrane 710 is adhesively bonded to the unit housing 540 by an adhesive bonding method such as thermal welding, ultrasonic welding, and laser welding. Any of the adhesive bonding methods including the thermal bonding, ultrasonic bonding, and laser bonding can be used as long as the bubble accumulation chamber 520 is sealed so that the liquid (ink) therein will not leak to the depressurization chamber 760. The gas permeable member 710 is desirably formed of a resin material. Specifically, examples of the material of the gas permeable membrane 710 include polypropylene (PP), polymethylpentene (TPX), and polytetrafluoroethylene (PTFE). For enhanced debubbling efficiency, the material of the gas permeable membrane 710 desirably has high gas permeability. To obtain debubbling efficiency needed for products, a certain level of gas permeability may be used of the material of the gas permeable membrane 710. Productivity such as ease of thermal welding to the unit housing 540 may also be used of the material of the gas permeable membrane 710. Reliability against tearing of the gas permeable membrane 710, peeling of the gas permeable membrane 710, and the like may be used of the material of the gas permeable membrane 710. Reliability as wetted material may be used of the material of the gas permeable membrane 710. The material of the gas permeable membrane 710 is thus desirably selected in view of the gas permeability, the production method (productivity), and reliability.

Examples of bubbles flowing into the bubble accumulation chamber 520 include initial bubbles (0.2 cc or so) remaining after initial filling, tank replacement bubbles (approximately 0.015 cc or so per month) that flow in during normal use, and permeation bubbles (0.001 cc/day or so) that enter through gas permeation from the outside. To process these bubbles, the debubbling operation needs to be performed with a bubble permeation amount of 0.01 cc/day or more. As defined in “Japanese Industrial Standards (JIS) K7126-1”, the amount of gas permeation via the gas permeable membrane 710 can be verified by a pressure sensor method or the like. The pressure sensor method is a method for measuring gas permeability by maintaining one side (low-pressure side) separated by a test piece under vacuum, introducing test gas to the other side (high-pressure side), and measuring a pressure increase on the low-pressure side. The pressure sensor method enables calculating a gas permeation coefficient from the gas permeability and the thickness of the test piece. By measuring the gas permeability using the pressure sensor method with the gas permeable membrane 710 as the test piece, the amount of gas permeation via the gas permeable membrane 710 can be verified. During initial filling for normal suction to be described below, the liquid discharge head 1 is filled with ink, and left standing at room temperature and atmospheric pressure in a state where bubbles in the bubble accumulation chamber 520 contact the entire gas permeable membrane 710 and the gas pressure in the depressurization chamber 760 is maintained at a negative pressure of 50 kPa (kilopascal) or so by the ink supply unit 400. In such a series of operations, the amount of bubble (gas) permeation via the gas permeable membrane 710 can be verified by measuring the volume of bubbles in the bubble accumulation chamber 520 in a time-series manner using computed tomography (CT) imaging or the like. To seal the bubble accumulation chamber 520 by welding the gas permeable membrane 710 to the unit housing 540, the material of the gas permeable membrane 710 desirably has high reliability for welding and high reliability as wetted material. To achieve a bubble permeation amount of 0.01 cc/day or more, the gas permeable membrane 710 desirably has a thickness of 0.1 mm or less.

### <Bubble Accumulation Chamber>

As illustrated in FIG. 10A, the first bubble accumulation chamber 520A is disposed vertically above the supply channel 130 to fluidly communicate with the supply channel 130 via the first communication port 751. The second bubble accumulation chamber 520B is disposed vertically above the first recovery channel 140 to fluidly communicate with the first recovery channel 140 via the first communication port 751. Bubbles mixed in the ink in the first pressure adjustment unit 120, second pressure adjustment unit 150, supply channel 130, first recovery channel 140, and the like can thus be collected in the bubble accumulation chamber 520 during circulation and discharge operations, and expelled from the ink by debubbling operation. Examples of bubbles mixed in the ink include upstream bubbles that enter the channels through replacement of the ink tank 2, evolved bubbles that occur within the channels due to environmental changes, and unexpected bubbles that occur within the channels unexpectedly. The types of bubbles to be expelled by the debubbling operation are not limited thereto. Any types of bubbles mixed in the ink can be exhausted to the outside of the liquid discharge head 1 as long as the bubbles can be collected in the bubble accumulation chamber 520 in amounts for which a sufficient debubbling speed can be obtained.

Examples of the material of the unit housing 540 constituting the bubble accumulation chamber 520 include PP and polyethylene (PE). In view of the welding reliability of the gas permeable membrane 710 and handleability, the material of the unit housing 540 is desirably PP.

### <Depressurization Chamber>

As illustrated in FIG. 27A, the depressurization chamber 760 has an opening where the gas permeable membrane 710 is located, an opening that is opposed to this opening and is for welding the gas permeable membrane 710, and the second communication port 761. The depressurization chamber 760 is formed by being enclosed by the unit housing 540, the gas permeable membrane 710, and a cover member 730. The second communication port 761 is formed through a side portion of the unit housing 540, and establishes communication between the depressurization chamber 760 and the degassing channel 541 (see FIG. 26). The opening for welding the gas permeable membrane 710 is sealed by adhesively bonding the cover member 730, which is a separate member, to the unit housing 540. Examples of the method for adhesively bonding the cover member 730 include thermal welding, ultrasonic welding, and laser welding. Examples of the material of the cover member 730 include PP and PE. In view of the welding reliability and handleability of the cover member 730, the cover member 730 is desirably formed of a material similar to that of the unit housing 540 forming the bubble accumulation chamber 520.

### <Deformation Suppression Member>

As illustrated in FIG. 27B, the deformation suppression member 720 is formed of a stainless steel (SUS) mesh filter having a mesh-like configuration. In FIG. 27B, the gas permeable membrane 710 is illustrated in a dot pattern to facilitate understanding of the deformation suppression member 720. Note that the dot pattern applied to the gas permeable membrane 710 in FIG. 27B does not represent a cross section of the gas permeable membrane 710. As the depressurization chamber 760 is depressurized by the ink supply unit 400, the gas permeable membrane 710 tends to deform toward the depressurization chamber 760. The deformation suppression member 720 makes contact with the gas permeable membrane 710 tending to deform toward the depressurization chamber 760, and thereby suppresses the deformation of the gas permeable membrane 710 and prevents tearing or peeling of the gas permeable membrane 710. The deformation suppression member 720 is disposed at the ends of the cover member 730. For example, the deformation suppression member 720 is adhesively bonded to the ends of the cover member 730 by an adhesive bonding method such as thermal welding, ultrasonic welding, and laser welding. With the cover member 730 adhesively bonded to the unit housing 540, the deformation suppression member 720 is located to cover the gas permeable membrane 710 at a position in contact with the gas permeable membrane 710 or at a position a certain distance away from the gas permeable membrane 710. Examples of the material of the deformation suppression member 720 aside from stainless steel (SUS) include nickel (Ni). The deformation suppression member 720 is desirably formed of a material having high welding reliability and high handleability.

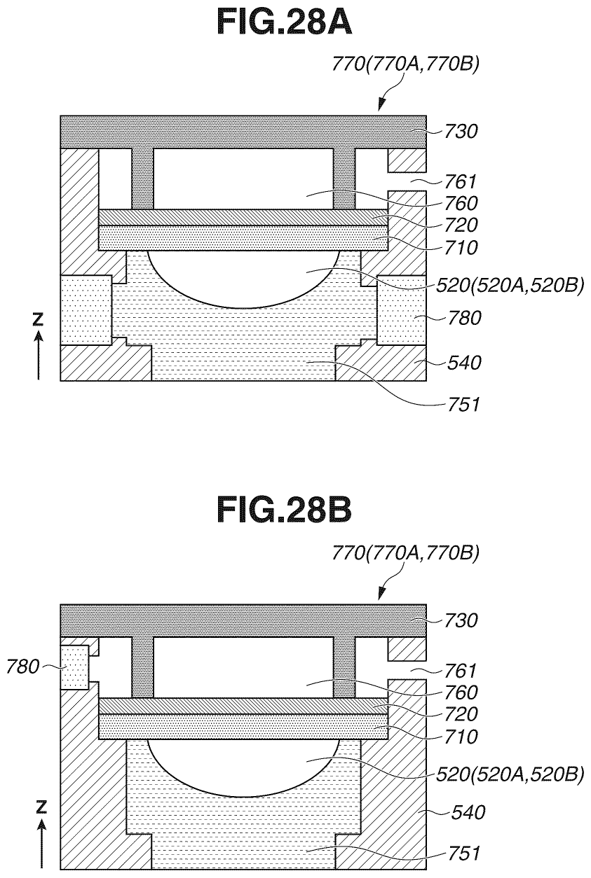

The bubble accumulation chamber 520 is formed by the unit housing 540. However, this is not restrictive. FIGS. 28A and 28B are diagrams illustrating modifications of the debubbling unit 770. FIG. 28A illustrates an example where a side film 780 is used as a part of the bubble accumulation chamber 520. FIG. 28B illustrates an example where a side film 780 is used as a part of the depressurization chamber 760. As illustrated in FIG. 28A, the bubble accumulation chamber 520 may be partly formed of the side film 780 welded to the unit housing 540. To suppress an increase in bubbles in the bubble accumulation chamber 520, liquid channels, liquid chambers, and the like, the side film 780 is desirably formed of a resin having gas barrier properties, such as polyethylene terephthalate (PET) and nylon (Ny). The bubble accumulation chamber 520 may only have a volume capable of collecting bubbles in an amount determined by the product's bubble design.

As illustrated in FIG. 28B, the depressurization chamber 760 may be partly formed of the side film 780 welded to the unit housing 540. To reduce a decrease in the degree of depressurization of the depressurization chamber 760, the side film 780 is desirably formed of a resin having high gas barrier properties, such PET and Ny. The gas permeable membrane 710 may be disposed with an elastic member interposed between the gas permeable membrane 710 and the unit housing 540 of the bubble accumulation chamber 520 or between the gas permeable membrane 710 and the unit housing 540 of the depressurization chamber 760. In such a case, the gas permeable membrane 710 may not be welded to the bubble accumulation chamber 520. This eliminates the need for the opening of the depressurization chamber 760 and the cover member 730 that seals the opening, and the depressurization chamber 760 may be formed of the unit housing 540 or the side film 780. The depressurization chamber 760 needs to have a volume capable of collecting bubbles in an amount determined by the product's bubble design.

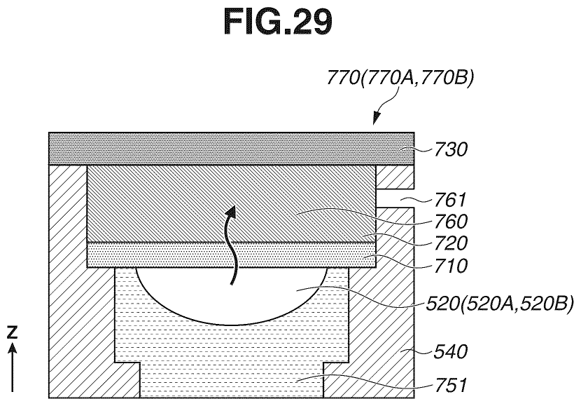

FIG. 29 is a diagram illustrating a first modification of the deformation suppression member 720. The deformation suppression member 720 is not limited to a mesh filter, and may be formed of a nonwoven fabric member with densely packed fibers as illustrated in FIG. 29. In such a case, to prevent the nonwoven fabric member from being sucked to the ink supply unit 400 when the depressurization chamber 760 is depressurized, it may be helpful to either use a nonwoven fabric member having a hardness of a certain value or more, or keep the degree of depressurization of the depressurization chamber 760 at a certain value or less. The nonwoven fabric member has a certain elasticity. With the size of the deformation suppression member 720 designed approximately the same as the volume of the depressurization chamber 760, the deformation suppression member 720 can thus be arranged within the depressurization chamber 760 without extending the cover member 730 into the depressurization chamber 760.

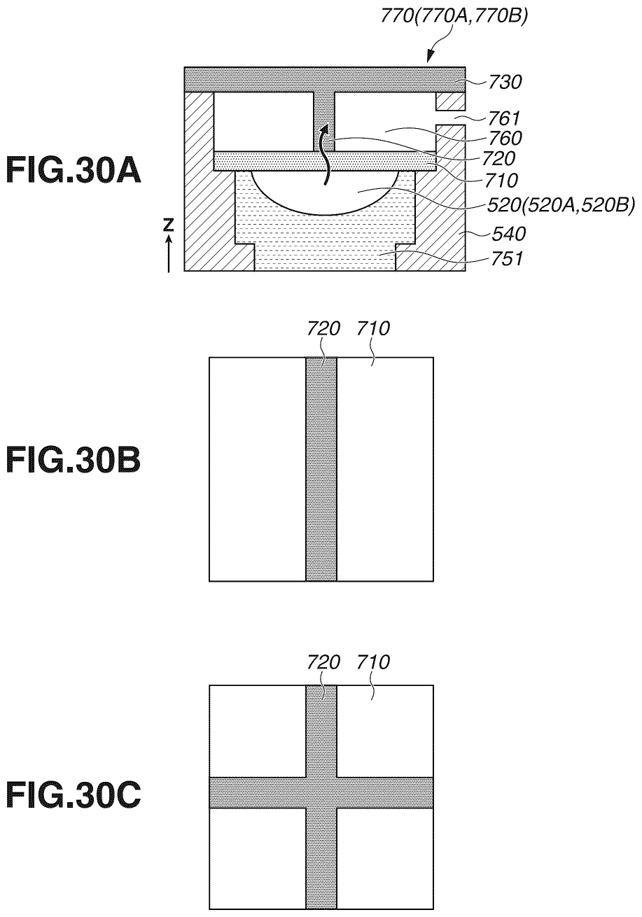

FIGS. 30A to 30C are schematic diagrams illustrating other modifications of the deformation suppression member 720. FIG. 30A is a sectional view illustrating a second modification of the deformation suppression member 720. FIG. 30B is a schematic diagram illustrating the second modification of the deformation suppression member 720. FIG. 30C is a schematic diagram illustrating a third modification of the deformation suppression member 720. As illustrated in FIG. 30A, the deformation suppression member 720 may be a rib-shaped member formed integrally with the cover member 730. The deformation suppression member 720 may have a straight rib shape as illustrated in

FIG. 30B. The deformation suppression member 720 is not limited to a straight rib shape, and may have a lattice-like rib shape as illustrated in FIG. 30C. In such a case, to reduce the maximum deformation amount of the gas permeable membrane 710, the deformation suppression member 720 desirably has a rib shape that contacts near the center of the gas permeable membrane 710. To reduce the maximum deformation amount of the gas permeable membrane 710, the number of ribs constituting the deformation suppression member 720 is desirably increased. In the case where the deformation suppression member 720 is located at the end of the cover member 730, the contact of the deformation suppression member 720 with part of the gas permeable membrane 710 reduces the effective area for bubbles to permeate the gas permeable membrane 710. This may result in adjustments to the configuration of other members and the product's bubble design. If the depressurization chamber 760 is configured to not use the cover member 730, the deformation suppression member 720 may be disposed in the portion of the unit housing 540 where the bubble accumulation chamber 520 is formed, or disposed in the portion of the unit housing 540 where the depressurization chamber 760 is formed.

### <Principle of Debubbling>

During debubbling operation, the depressurization chamber 760 is depressurized so that bubbles permeate the gas permeable membrane 710 due to a pressure difference between the bubble pressure in the bubble accumulation chamber 520 and the gas pressure in the depressurization chamber 760. The amount of permeation in the debubbling operation is expressed by the following Eq. (5):

$$Q = P \times p \times S \times t / L , \qquad ( 5 )$$

where Q: Amount of gas permeation
P: Permeation coefficient
p: Degree of depressurization (gauge pressure)
S: Bubble contact area
t: Time
L: Thickness of the gas permeable membrane 710

The amount of gas permeation represented by Q is the permeated amount of gas included in bubbles due to the debubbling operation. The permeation coefficient represented by P is a numerical value determined by the material properties of the gas permeable membrane 710, and expresses the basic speed of the debubbling operation. The degree of depressurization represented by p is the degree of depressurization (gauge pressure) of the depressurization chamber 760. The bubble contact area represented by S is the area where bubbles contact the gas permeable membrane 710. The numerical value represented by L is the thickness of the gas permeable membrane 710.

### <Initial Filling>

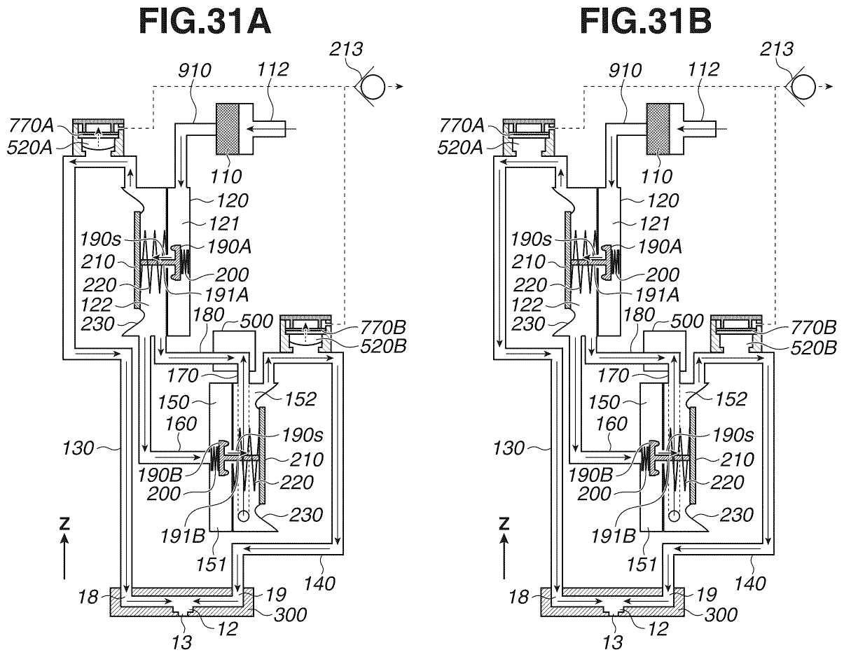

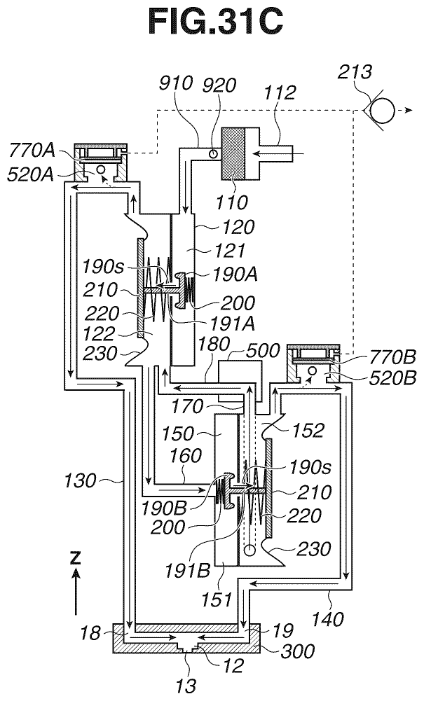

FIGS. 31A to 31C are schematic diagrams illustrating initial filling and the operation of the debubbling units 770. FIG. 31A is a schematic diagram illustrating ink flow and remaining bubbles when the liquid discharge head 1 is initially filled with ink.

The initial filling is performed by bringing the cap member into close contact with the nozzle surface of the liquid discharge head 1 where the nozzles 13 are formed, and forcefully suctioning ink from the nozzles 13. Here, negative pressure from a negative pressure source connected to the cap member is applied to the nozzles 13, whereby the ink is forcefully suctioned from the nozzles 13. During the initial filling, there may be locations where ink flow stagnates because of molding or assembly variations of parts, and small amounts of bubbles may adhere and remain on the wall surfaces etc. Suction operations include normal suction and choke suction, and the filling state of the debubbling units 770 varies with the method of suction operation. In normal suction, during which suction is performed without any special operation, gas-liquid exchange occurs in the ink channels illustrated in FIG. 31A as ink is supplied from upstream of the ink channels. Most of the ink channels are thereby filled with ink. However, since the bubble accumulation chamber 520 (first bubble accumulation chamber 520A and second bubble accumulation chamber 520B) does not serve as an ink channel, no gas-liquid exchange occurs and bubbles remain in most of the bubble accumulation chamber 520. In choke suction, the channel upstream of the ink channels is closed with a valve or the like, and the entire liquid discharge head 1 is sufficiently depressurized by a suction operation. Then, the upstream valve or the like is opened to pass ink into the liquid discharge head 1 from upstream of the ink channels. As a result, most of the ink channels illustrated in FIG. 31A are filled with the ink as in normal suction, while the bubble accumulation chamber 520 is filled with more ink the higher the degree of depressurization in the depressurized state by the suction operation. For example, choke suction at −50 kPa (gauge pressure) fills the bubble accumulation chamber 520 approximately by half.

### <Operation of Debubbling Units>

FIG. 31B is a schematic diagram illustrating the state inside the circulation unit 54 after initial filling. FIG. 31C is a schematic diagram illustrating the state of residual bubbles after initial filling. After initial filling, bubbles are accumulated in the bubble accumulation chamber 520 (first bubble accumulation chamber 520A and second bubble accumulation chamber 520B). The depressurization chamber 760 is therefore depressurized to perform debubbling. Since gas constantly penetrates into the bubble accumulation chamber 520 from outside through the unit housing 540 or the side film 780, debubbling operation needs to be performed based on the product's bubble design. The depressurization chamber 760 is depressurized into a depressurized state by the ink supply unit 400 in the main body unit of the liquid discharge apparatus 50 through the second communication port 761. The higher the degree of depressurization, the greater the amount of bubble permeation. To obtain a sufficient amount of bubble permeation to process bubbles occurring during normal use, the degree of depressurization is desirably set to at least 10 kPa or more. Moreover, since an excessively high degree of depressurization can significantly deform the gas permeable membrane 710 toward the depressurization chamber 760 and cause peeling at the welded portion of the gas permeable membrane 710, the degree of depressurization is desirably set to approximately 70 kPa or less. The ink supply unit 400 for depressurizing the depressurization chamber 760 diverts the pressurization unit (for example, the foregoing one-way pump 404) in the upstream channel, and the degree of depressurization of the depressurization chamber 760 is thus affected by the operation or output of the pressurization unit. As can be seen from the foregoing description, the degree of depressurization appropriate for the operation of the ink supply unit 400, at which the amount of bubble permeation is sufficient and the reliability of the gas permeable membrane 710 is high, is desirably 50 kPa or so. The depressurization state of the depressurization chamber 760 can be maintained by constantly operating the liquid discharge apparatus 50. When the main body unit of the liquid discharge apparatus 50 is not being operated, the third check valve 213 disposed between the second communication port 761 (see FIG. 27A) and the ink supply unit 400 is used. The third check valve 213 hermetically seals the depressurization chamber 760 once the depressurization chamber 760 reaches a certain degree of depressurization. The depressurized state of the depressurization chamber 760 is thus maintained even with the main body unit of the liquid discharge apparatus 50 in a non-operating state, whereby the debubbling operation can be continued to handle bubbles that increase during long-term storage, for example. As illustrated in FIG. 31A, the depressurization chamber 760 is brought into the depressurized state by the ink supply unit 400 after initial filling, and the depressurized state is then maintained by the third check valve 213. This allows bubbles in the bubble accumulation chamber 520 to permeate, whereby the bubbles are expelled from the ink. When discharge operation is performed, ink flows in from upstream, and bubbles lying upstream also flow in at the same time. Depending on the discharge operation and circulation operation, unexpected bubbles and the like such as small amounts of bubbles remaining in stagnant areas of ink flow during initial filling also flow in. As illustrated in FIG. 31C, bubbles can be collected through the first communication port 751 (see FIG. 27A) of the debubbling unit 770 by utilizing the buoyancy of the bubbles, and expelled from the ink by bringing the depressurization chamber 760 into the depressurized state for debubbling operation. Repetition of such debubbling operation prevents new bubbles occurring during normal use from flowing into the pressure chamber 12, and can reduce the possibility of discharge failure. When the depressurized state of the depressurization chamber 760 is maintained using the third check valve 213, the debubbling efficiency decreases as the debubbling operation is performed, since bubbles permeate into the depressurization chamber 760 and the degree of depressurization of the depressurization chamber 760 decreases. The amount of decrease in the degree of depressurization is expressed by the following Eq. (6):

$$( p 2 \times Q + p 1 \times Q 1 ) / V , \qquad ( 6 )$$

where p1: Atmospheric pressure (absolute pressure)
p2: Internal bubble pressure (absolute pressure)
v: Volume of the depressurization chamber 760
Q1: Amount of permeation from outside

The internal bubble pressure represented by p2 is the same as the ink pressure. The greater the volume of the depressurization chamber 760 represented by v, the smaller the amount of decrease in the degree of depressurization by the debubbling operation is and the more the decrease in the debubbling efficiency can be suppressed. The amount of permeation from outside represented by Q1 is the amount of gas permeating from outside into the depressurization chamber 760, and is determined by the material of the unit housing 540 forming the depressurization chamber 760, the surface area of the portion of the unit housing 540 contacting the outside air, and the thickness of the unit housing 540.

When the degree of depressurization of the depressurization chamber 760 decreases, the debubbling efficiency can be maintained by operating the third check valve 213 and the ink supply unit 400 to increase the degree of depressurization of the depressurization chamber 760. The operation for increasing the degree of depressurization (for example, the foregoing debubbling depressurization operation) may be performed on a regular basis using a timer. The degree of depressurization of the depressurization chamber 760 may be detected using a sensor, and the operation for increasing the degree of depressurization may be performed with a predetermined decrease in the degree of depressurization as a trigger. When the depressurization chamber 760 is depressurized and the gas permeable membrane 710 deforms toward the depressurization chamber 760, the deformation suppression member 720 contacts the gas permeable membrane 710 from the depressurization chamber 760 side. The deformation suppression member 720 suppresses the deformation of the gas permeable membrane 710 by pressing the gas permeable membrane 710 in a direction of suppressing the deformation of the gas permeable membrane 710. Suppressing the deformation of the gas permeable membrane 710 reduces the load on the welded portion of the gas permeable membrane 710, and can reduce the possibility of peeling of the gas permeable membrane 710.

In the present embodiment, the operation of the debubbling unit 770 is described by using the configuration where the debubbling unit 770 (first debubbling unit 770A and second debubbling unit 770B) includes the bubble accumulation chamber 520 (first bubble accumulation chamber 520A and second bubble accumulation chamber 520B) as an example. However, this is not restrictive.

If the path between the pressure chamber 12 and the depressurization chamber 760 is configured as a liquid storage chamber for supplying liquid (ink) to the pressure chamber 12, a part of the liquid storage chamber may be configured to accumulate bubbles.

In such a case, the gas permeable membrane 710 is formed at a position in contact with the liquid storage chamber, and the depressurization chamber 760 adjoins the liquid storage chamber via the gas permeable membrane 710.

The configuration of the circulation path according to the present embodiment is not limited to the foregoing. A first configuration example and a second configuration example of the ink path and various modifications of the circulation path will be described as other configurations of the circulation path.

### <First Configuration Example of Ink Path>

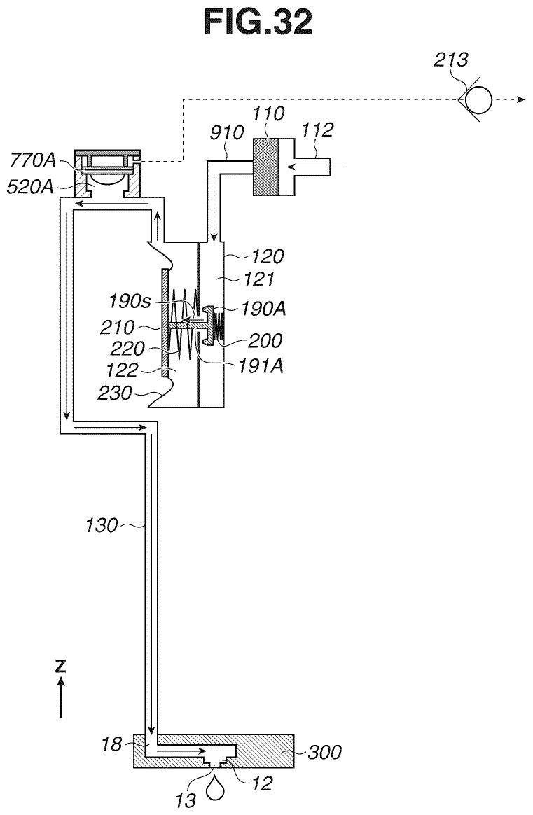

FIG. 32 is a diagram schematically illustrating the first configuration example of the ink path. The first configuration example of the ink path is an example without the second pressure adjustment unit 150, the second bubble accumulation chamber 520B, the circulation pump 500, the bypass channel 160, and the first recovery channel 140. In the first configuration example of the ink path, ink circulation is not performed, and the ink supplied from the second supply path 112 flows through the first pressure adjustment unit 120, the supply channel 130, and the pressure chamber 12 in order, and is discharged from the nozzle 13. The first pressure control chamber 122, the supply channel 130, and the pressure chamber 12 are pressure-controlled by the first pressure adjustment unit 120, whereby stable ink discharge is achieved.

The first bubble accumulation chamber 520A is disposed vertically above the supply channel 130 to fluidly communicate with the supply channel 130. The first debubbling unit 770A is formed to extend vertically above the first bubble accumulation chamber 520A. Bubbles mixed in the ink in the first pressure adjustment unit 120, the supply channel 130, or the like can thus be collected in the first bubble accumulation chamber 520A through circulation and discharge operations, and expelled from the ink by debubbling operation. Examples of the bubbles mixed in the ink include the foregoing upstream bubbles, evolved bubbles, and unexpected bubbles. However, this is not restrictive, and bubbles in an amount that can be collected in the bubble accumulation chamber 520 and for which a sufficient debubbling speed is obtainable can be expelled from the ink. This can significantly reduce the possibility of intrusion of bubbles to the nozzle 13.

The first debubbling unit 770A communicates with the ink supply unit 400 in the main body unit of the liquid discharge apparatus 50, and is depressurized by the operation of the ink supply unit 400. Moreover, the third check valve 213 is disposed between the debubbling unit 770 and the ink supply unit 400, and the depressurized state is maintained even without the main body unit of the liquid discharge apparatus 50 constantly operating. This enables debubbling operation.

The third check valve 213 may be disposed in the third air channel 113 between the first debubbling unit 770A and the ink supply unit 400.

Two or more bubble accumulation chambers 520 and two or more debubbling units 770 may be provided. The bubble accumulation chamber 520 and the debubbling unit 770 may not even be disposed on the supply channel 130.

For example, the bubble accumulation chamber 520 and the debubbling unit 770 may be disposed vertically above the ink tank 2, the first supply path 111, the second supply path 112, the third supply path 910, the filter 110, the pressure chamber 12, or the like. The bubble accumulation chamber 520 and the debubbling unit 770 may not necessarily be disposed vertically above a fluid communication portion such as the supply channel 130. The bubble accumulation chamber 520 may communicate with the fluid communication portion sideways and the debubbling unit 770 may be formed to extend sideways from the bubble accumulation chamber 520 as long as the configuration can collect bubbles and cause the bubbles to contact the gas permeable membrane 710. The same applies to cases where bubble accumulation chambers 520 and debubbling units 770 are disposed at a plurality of locations on fluid communication portions other than the supply channel 130 and the first recovery channel 140.

### <First Modification of Circulation Path>

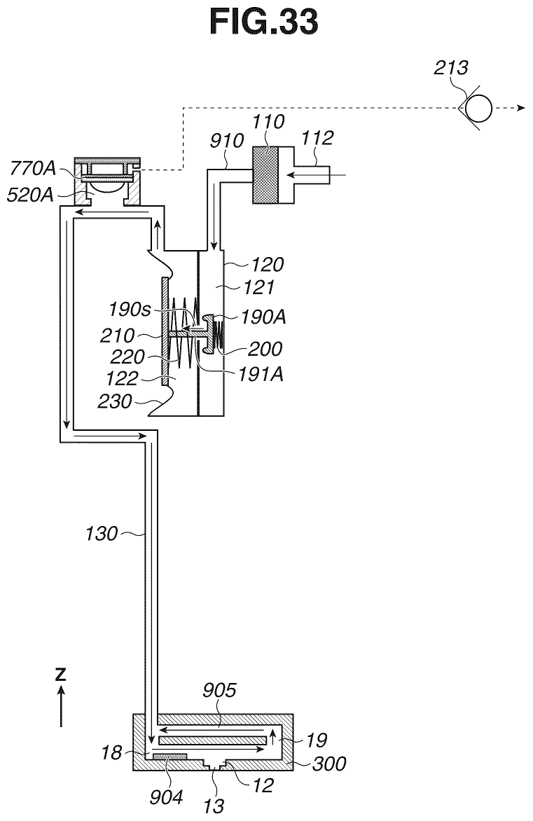

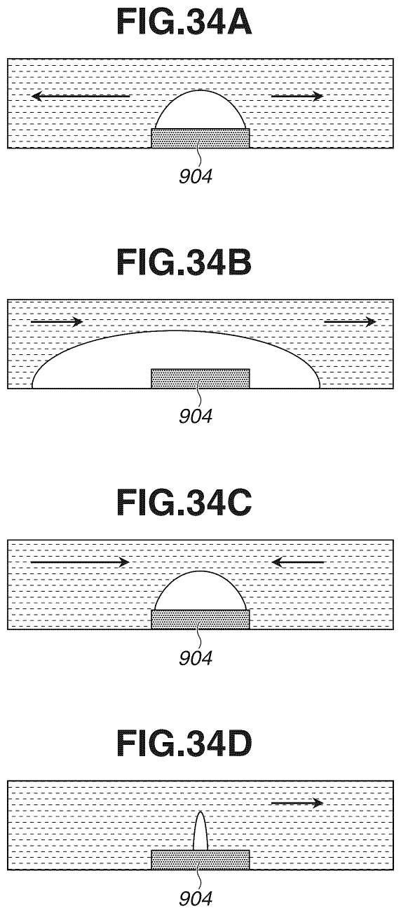

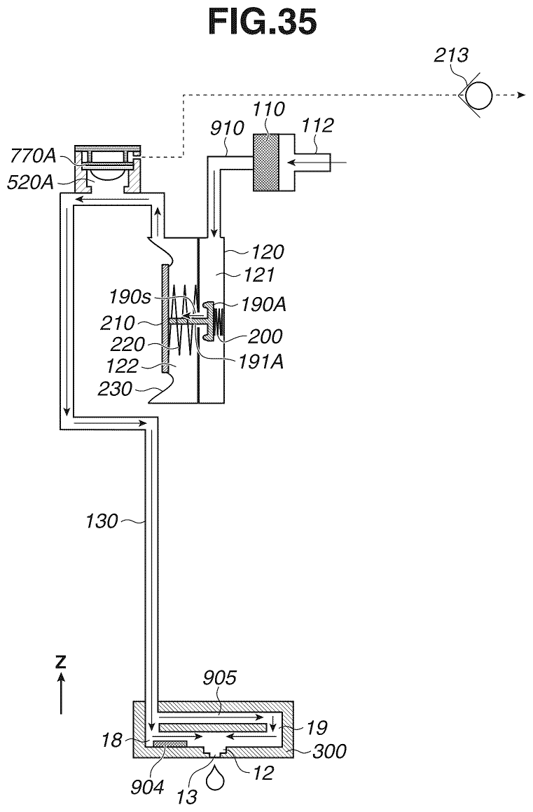

FIGS. 33 and 35 are diagrams schematically illustrating a first modification of the circulation path. FIG. 33 illustrates the circulation path when circulation is performed without discharge. FIG. 35 illustrates the circulation path when high-duty recording is performed. FIGS. 34A to 34D are diagrams schematically illustrating the vicinity of a heating circulation pump 904. FIGS. 34A, 34B, 34C, and 34D illustrate an overview of liquid delivery by the heating circulation pump 904.

The first modification of the circulation path is an example without the second pressure adjustment unit 150, the second bubble accumulation chamber 520B, the circulation pump 500, the bypass channel 160, and the first recovery channel 140. The first modification of the circulation path is an example where the heating circulation pump 904 disposed between the supply channel 130 and the pressure chamber 12 and a second recovery channel 905 establishing communication between the pressure chamber 12 and the supply channel 130 are provided instead of the circulation pump 500 and the like. In the first modification of the circulation path, during circulation as illustrated in FIG. 33, ink is circulated within the discharge module 300 by the heating circulation pump 904. During the discharge operation as illustrated in FIG. 35, the ink supplied from the second supply path 112 flows through the first pressure adjustment unit 120, the supply channel 130 or second recovery channel 905, and the pressure chamber 12 in order, and is discharged from the nozzle 13. When high-duty recording is performed, the ink in the second recovery channel 905 flows in the direction opposite to that during circulation, whereby the pressure chamber 12 and the nozzle 13 are supplied with ink from both the supply channel 130 and the second recovery channel 905. The first pressure control chamber 122, the supply channel 130, and the pressure chamber 12 are pressure-controlled by the first pressure adjustment unit 120, whereby stable ink discharge is achieved.

The first bubble accumulation chamber 520A is disposed vertically above the supply channel 130 to fluidly communicate with the supply channel 130. The first debubbling unit 770A is formed to extend vertically above the first bubble accumulation chamber 520A. Bubbles mixed in the ink in the first pressure adjustment unit 120, the supply channel 130, the second recovery channel 905, and the like can thus be collected in the bubble accumulation chamber 520 through circulation and discharge operations, and expelled from the ink by debubbling operation. Examples of the bubbles mixed in the ink include the foregoing upstream bubbles, evolved bubbles, and unexpected bubbles. However, this is not restrictive, and bubbles in an amount that can be collected in the bubble accumulation chamber 520 and for which a sufficient debubbling speed is obtainable can be expelled from the ink. This can significantly reduce the possibility of intrusion of bubbles to the nozzle 13.

The first debubbling unit 770A communicates with the ink supply unit 400 in the main body unit of the liquid discharge apparatus 50, and is depressurized by the operation of the ink supply unit 400. Moreover, the third check valve 213 is disposed between the debubbling unit 770 and the ink supply unit 400, and the depressurized state is maintained even without the main body unit of the liquid discharge apparatus 50 constantly operating. This enables debubbling operation.

The third check valve 213 may be disposed in the third air channel 113 between the first debubbling unit 770A and the ink supply unit 400.

Two or more bubble accumulation chambers 520 and two or more debubbling units 770 may be provided. The bubble accumulation chamber 520 and the debubbling unit 770 may not even be disposed on the supply channel 130.

For example, the bubble accumulation chamber 520 and the debubbling unit 770 may be disposed vertically above the ink tank 2, the first supply path 111, the second supply path 112, the third supply path 910, the filter 110, the pressure chamber 12, the second recovery channel 905, or the like. The bubble accumulation chamber 520 and the debubbling unit 770 may not necessarily be disposed vertically above a fluid communication portion such as the supply channel 130.

The bubble accumulation chamber 520 may communicate with the fluid communication portion sideways and the debubbling unit 770 may be formed to extend sideways from the bubble accumulation chamber 520 as long as the configuration can collect bubbles and cause the bubbles to contact the gas permeable membrane 710. The same applies to cases where bubble accumulation chambers 520 and debubbling units 770 are disposed at a plurality of locations on fluid communication portions other than the supply channel 130 and the first recovery channel 140.

The heating circulation pump 904 includes a heater member capable of heating ink, and sends out ink by heating the ink to produce a bubble from the heater portion. As illustrated in FIG. 34A, the heater member constituting the heating circulation pump 904 initially heats the ink rapidly, whereby a bubble occurs and expands through film boiling. Here, the amount of bubble expansion differs between the upstream side and downstream side of the ink. Next, as illustrated in FIG. 34B, the heater stops heating when the bubble expands to a certain value. Next, as illustrated in FIG. 34C, the bubble contracts since the heating is stopped. Here, the amount of bubble contraction differs between the upstream side and downstream side of the ink. Finally, as illustrated in FIG. 34D, the bubble contracts completely and collapses. This produces an ink flow from the upstream side to the downstream side. The process illustrated in FIGS. 34A, 34B, 34C, and 34D is repeated to produce a steady ink flow from the supply channel 130 to the second recovery channel 905 through the pressure chamber 12. The heating circulation pump 904 may not be disposed between the supply channel 130 and the pressure chamber 12, and may be disposed between the pressure chamber 12 and the second recovery channel 905.

### <Second Modification of Circulation Path>

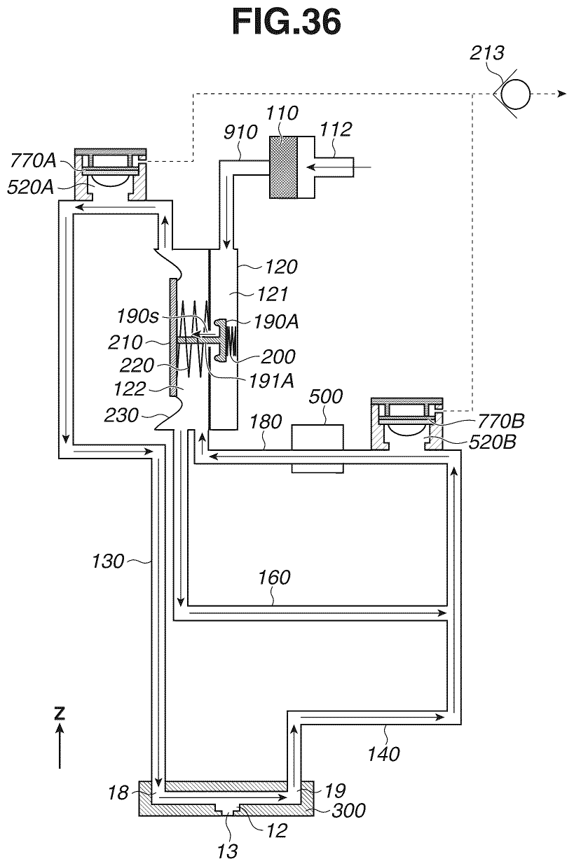

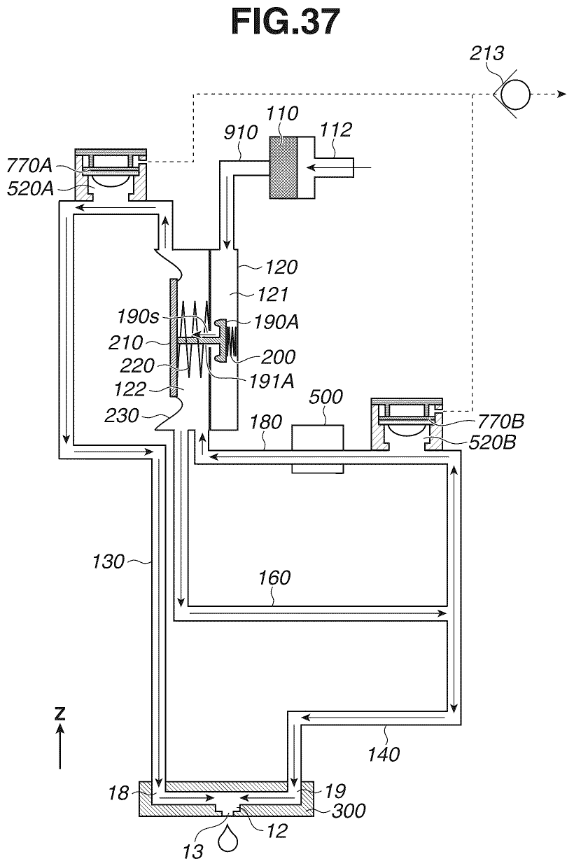

FIGS. 36 and 37 are diagrams schematically illustrating a second modification of the circulation path. FIG. 36 illustrates the circulation path when circulation is performed without discharge. FIG. 37 illustrates the circulation path when high-duty recording is performed. The second modification of the circulation path is an example where the second pressure adjustment unit 150 is not provided, and the bypass channel 160 and the first recovery channel 140 are directly connected.

In the second modification of the circulation path, assume that the channel resistance of the channel where ink flows to the first recovery channel 140 via the bypass channel 160 is R1, and the channel resistance of the channel where ink flows from the supply channel 130 to the first recovery channel 140 via the discharge module 300 is R2. Since the flow rate of ink flowing through each channel is inversely proportional to the channel resistance, the ratio of the flow rate of ink through the channel via the bypass channel 160 to that of ink through the channel via the discharge module 300 is R2 to R1. Based on this relationship, the channel resistances are set to implement an amount of circulation that can prevent ink thickening near the nozzle 13 in the discharge module 300. More specifically, the channel resistances are set so that the ink flow speed in the pressure chamber 12 is higher than or equal to a predetermined flow speed. The channel resistance R1 of the channel via the bypass channel 160 is controlled by changing the cross-sectional area or length of the channel, by providing a restriction in the channel, etc.

Even in the second modification of the circulation path, when recording operations are performed at high duty, the pressure chamber 12 is supplied with ink from both sides as illustrated in FIG. 37. More specifically, the ink supplied from the first pressure control chamber 122 to the supply channel 130 is supplied to the nozzle 13 via the common supply channel 18 of the discharge module 300. Meanwhile, part of the ink supplied from the first pressure control chamber 122 to the bypass channel 160 is supplied to the first pressure control chamber 122 via the circulation pump 500 and the pump outlet channel 180. Part of the ink supplied to the bypass channel 160 is supplied to the first recovery channel 140, and supplied to the nozzle 13 via the common recovery channel 19 of the discharge module 300. The ink to be discharged from the nozzle 13 is thus supplied from both the supply channel 130 and the first recovery channel 140.

The first bubble accumulation chamber 520A is disposed vertically above the supply channel 130 to fluidly communicate with the supply channel 130. The first debubbling unit 770A is formed to extend vertically above the first bubble accumulation chamber 520A. The second bubble accumulation chamber 520B is disposed vertically above the first recovery channel 140 to fluidly communicate with the first recovery channel 140. The second debubbling unit 770B is formed to extend vertically above the second bubble accumulation chamber 520B. Bubbles mixed in the ink in the first pressure adjustment unit 120, the supply channel 130, the first recovery channel 140, and the like can thus be collected in the bubble accumulation chamber 520 through circulation and discharge operations, and expelled from the ink by debubbling operation. Examples of the bubbles mixed in the ink include the foregoing upstream bubbles, evolved bubbles, and unexpected bubbles. However, this is not restrictive, and bubbles in an amount that can be collected in the bubble accumulation chamber 520 and for which a sufficient debubbling speed is obtainable can be expelled from the ink. This can significantly reduce the possibility of intrusion of bubbles to the nozzle 13.

The first debubbling unit 770A and the second debubbling unit 770B communicate with the ink supply unit 400 in the main body unit of the liquid discharge apparatus 50, and are depressurized by the operation of the ink supply unit 400.

Moreover, the third check valve 213 is disposed between the debubbling unit 770 and the ink supply unit 400, and the depressurized state is maintained even without the main body unit of the liquid discharge apparatus 50 constantly operating. This enables debubbling operation. Third check valves 213 may be disposed at the respective branches of the third air channel 113 between the ink supply unit 400 and the first and second debubbling units 770A and 770B. A third check valve 213 may be disposed at the integral portion of the third air channel 113 between the ink supply unit 400 and the first and second debubbling units 770A and 770B.

The bubble accumulation chamber 520 and the debubbling unit 770 may not be disposed on both the supply channel 130 and the first recovery channel 140, and may be disposed on the supply channel 130 alone or the first recovery channel 140 alone. Three or more bubble accumulation chambers 520 and three or more debubbling units 770 may be provided. The bubble accumulation chambers 520 and the debubbling units 770 may not even be disposed on the supply channel 130 or the first recovery channel 140. For example, the bubble accumulation chamber 520 and the debubbling unit 770 may be disposed vertically above the ink tank 2, the first supply path 111, the second supply path 112, the third supply path 910, or the like. The bubble accumulation chamber 520 and the debubbling unit 770 may be disposed vertically above the filter 110, the pump outlet channel 180, the bypass channel 160, the pressure chamber 12, or the like. The bubble accumulation chamber 520 and the debubbling unit 770 may not necessarily be disposed vertically above a fluid communication portion such as the supply channel 130. The bubble accumulation chamber 520 may communicate with the fluid communication portion sideways and the debubbling unit 770 may be formed to extend sideways from the bubble accumulation chamber 520 as long as the configuration can collect bubbles and cause the bubbles to contact the gas permeable membrane 710. The same applies to cases where bubble accumulation chambers 520 and debubbling units 770 are disposed at a plurality of locations on fluid communication portions other than the supply channel 130 and the first recovery channel 140.

### <Third Modification of Circulation Path>

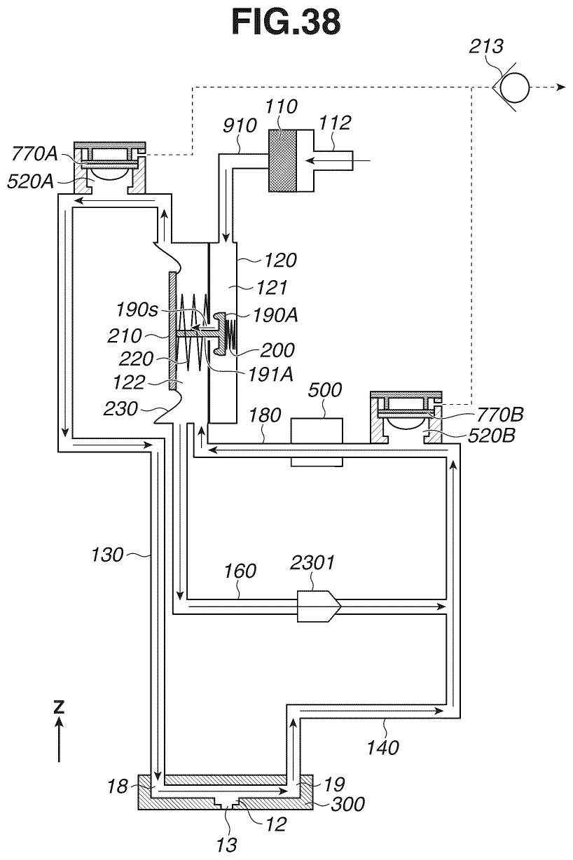

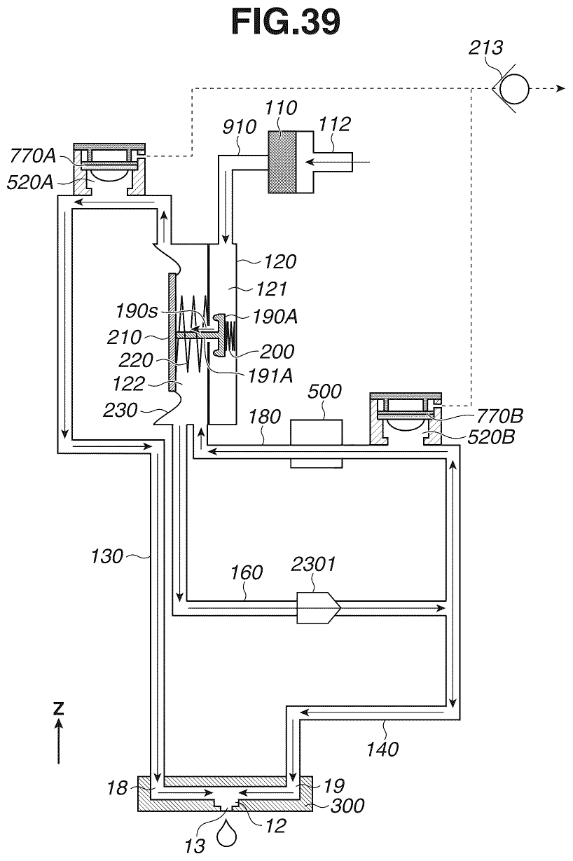

FIGS. 38 and 39 are diagrams schematically illustrating a third modification of the circulation path. FIG. 38 illustrates the circulation path when circulation is performed without discharge. FIG. 39 illustrates the circulation path when high-duty recording is performed. The third modification of the circulation path is an example where the second pressure adjustment unit 150 is not provided, the bypass channel 160 and the first recovery channel 140 are directly connected, and a relief valve 2301 is disposed in the bypass channel 160.

The relief valve 2301 is configured so that ink flows in from upstream to downstream of the relief valve 2301 when the ink pressure downstream of the relief valve 2301 falls to or below a certain value. In other words, the relief valve 2301 is configured to open when the ink pressure on the recovery channel side of the relief valve 2301 is lower than the ink pressure on the supply channel side of the relief valve 2301 by a certain value or more. As illustrated in FIGS. 38 and 39, the ink flow in the third modification of the circulation path is basically the same as when the second pressure adjustment unit 150 is provided. The amount of circulation within the discharge module 300 is determined by a differential pressure between the control pressure of the first pressure control chamber 122 and that of the relief valve 2301. The control pressure of the relief valve 2301 is set to implement an amount of circulation that can prevent ink thickening near the nozzle 13 in the discharge module 300.

Even in the third modification of the circulation path, when recording operations are performed at high duty, the pressure chamber 12 is supplied with ink from both sides as illustrated in FIG. 39. More specifically, the ink supplied from the first pressure control chamber 122 to the supply channel 130 is supplied to the nozzle 13 via the common supply channel 18 of the discharge module 300. Meanwhile, part of the ink supplied from the first pressure control chamber 122 to the bypass channel 160 is passed through the relief valve 2301 and supplied to the first pressure control chamber 122 via the circulation pump 500 and the pump outlet channel 180. Part of the ink supplied to the bypass channel 160 is supplied to the first recovery channel 140 through the relief valve 2301, and supplied to the nozzle 13 via the common recovery channel 19 of the discharge module 300. The ink to be discharged from the nozzle 13 is thus supplied from both the supply channel 130 and the first recovery channel 140.

The first bubble accumulation chamber 520A is disposed vertically above the supply channel 130 to fluidly communicate with the supply channel 130. The first debubbling unit 770A is formed to extend vertically above the first bubble accumulation chamber 520A. The second bubble accumulation chamber 520B is disposed vertically above the first recovery channel 140 to fluidly communicate with the first recovery channel 140. The second debubbling unit 770B is formed to extend vertically above the second bubble accumulation chamber 520B. Bubbles mixed in the ink in the first pressure adjustment unit 120, the supply channel 130, the first recovery channel 140, and the like can thus be collected in the bubble accumulation chamber 520 through circulation and discharge operations, and expelled from the ink by debubbling operation. Examples of the bubbles mixed in the ink include the foregoing upstream bubbles, evolved bubbles, and unexpected bubbles. However, this is not restrictive, and bubbles in an amount that can be collected in the bubble accumulation chamber 520 and for which a sufficient debubbling speed is obtainable can be expelled from the ink. This can significantly reduce the possibility of intrusion of bubbles to the nozzle 13.

The first debubbling unit 770A and the second debubbling unit 770B communicate with the ink supply unit 400 in the main body unit of the liquid discharge apparatus 50, and are depressurized by the operation of the ink supply unit 400.

Moreover, the third check valve 213 is disposed between the debubbling unit 770 and the ink supply unit 400, and the depressurized state is maintained even without the main body unit of the liquid discharge apparatus 50 constantly operating. This enables debubbling operation. Third check valves 213 may be disposed at the respective branches of the third air channel 113 between the ink supply unit 400 and the first and second debubbling units 770A and 770B. A third check valve 213 may be disposed at the integral portion of the third air channel 113 between the ink supply unit 400 and the first and second debubbling units 770A and 770B.

The bubble accumulation chamber 520 and the debubbling unit 770 may not be disposed on both the supply channel 130 and the first recovery channel 140, and may be disposed on the supply channel 130 alone or the first recovery channel 140 alone. Three or more bubble accumulation chambers 520 and three or more debubbling units 770 may be provided. The bubble accumulation chamber 520 and the debubbling unit 770 may not even be disposed on the supply channel 130 or the first recovery channel 140. For example, the bubble accumulation chamber 520 and the debubbling unit 770 may be disposed vertically above the ink tank 2, the first supply path 111, the second supply path 112, the third supply path 910, or the like. The bubble accumulation chamber 520 and the debubbling unit 770 may be disposed vertically above the filter 110, the pump outlet channel 180, the bypass channel 160, the pressure chamber 12, or the like. The bubble accumulation chamber 520 and the debubbling unit 770 may not necessarily be disposed vertically above a fluid communication portion such as the supply channel 130. The bubble accumulation chamber 520 may communicate with the fluid communication portion sideways and the debubbling unit 770 may be formed to extend sideways from the bubble accumulation chamber 520 as long as the configuration can collect bubbles and cause the bubbles to contact the gas permeable membrane 710. The same applies to cases where bubble accumulation chambers 520 and debubbling units 770 are disposed at a plurality of locations on fluid communication portions other than the supply channel 130 and the first recovery channel 140.

### <Second Configuration Example of Ink Path>

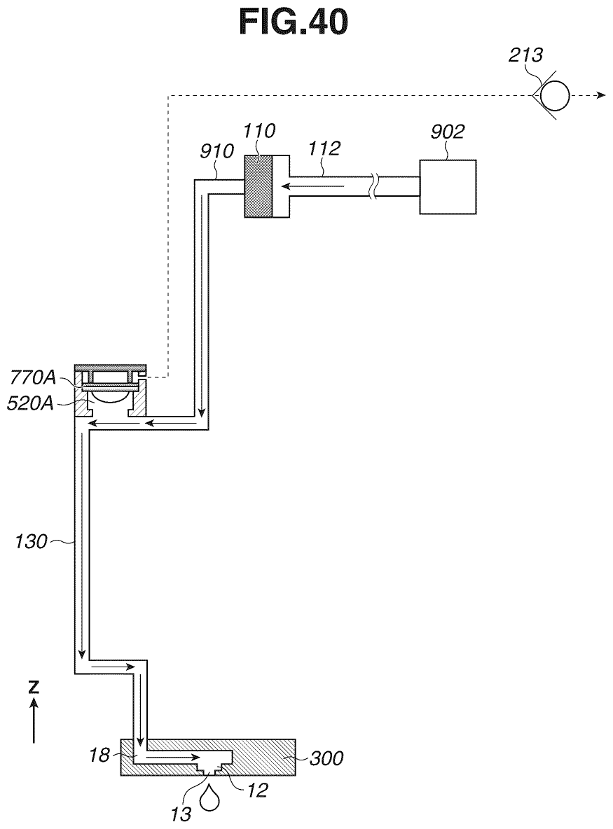

FIG. 40 is a diagram schematically illustrating a second configuration example of the ink path. The second configuration example of the ink path is an example without the first pressure adjustment unit 120, the second pressure adjustment unit 150, the second bubble accumulation chamber 520B, the circulation pump 500, the bypass channel 160, and the first recovery channel 140.

The second configuration example of the ink path is an example where a third pressure adjustment unit 902 communicating with the second supply path 112 is provided instead of the first pressure adjustment unit 120, the second pressure adjustment unit 150, and the like. In the second configuration example of the ink path, ink circulation is not performed, and the ink supplied from the second supply path 112 flows through the supply channel 130 and the pressure chamber 12 in order and is discharged from the nozzle 13. The second supply path 112, the third supply path 910, the supply channel 130, and the pressure chamber 12 are pressure-controlled by the third pressure adjustment unit 902, whereby stable ink discharge is achieved.

The third pressure adjustment unit 902 is located outside the liquid discharge head 1, and communicates with the third supply path 910 of the liquid discharge head 1 via the second supply path 112. An example of the third pressure adjustment unit 902 is a hydraulic head system using hydraulic head difference. However, any other appropriate system can also be applied. This modification is applicable to both ink cartridge systems and ink supply systems such as a continuous ink supply system (CISS).

The first bubble accumulation chamber 520A is disposed vertically above the supply channel 130 to fluidly communicate with the supply channel 130. The first debubbling unit 770A is formed to extend vertically above the first bubble accumulation chamber 520A. Bubbles mixed in the ink in the supply channel 130 and the like can thus be collected in the first bubble accumulation chamber 520A through circulation and discharge operations, and expelled from the ink by debubbling operation. Examples of the bubbles mixed in the ink include the foregoing upstream bubbles, evolved bubbles, and unexpected bubbles. However, this is not restrictive, and bubbles in an amount that can be collected in the bubble accumulation chamber 520 and for which a sufficient debubbling speed is obtainable can be expelled from the ink. This can significantly reduce the possibility of intrusion of bubbles to the nozzle 13.

The first debubbling unit 770A communicates with the ink supply unit 400 in the main body unit of the liquid discharge apparatus 50, and is depressurized by the operation of the ink supply unit 400. Moreover, the third check valve 213 is disposed between the debubbling unit 770 and the ink supply unit 400, and the depressurized state is maintained even without the main body unit of the liquid discharge apparatus 50 constantly operating. This enables debubbling operation.

The third check valve 213 may be disposed in the third air channel 113 between the first debubbling unit 770A and the ink supply unit 400.

Two or more bubble accumulation chambers 520 and two or more debubbling units 770 may be provided. The bubble accumulation chamber 520 and the debubbling unit 770 may not even be disposed on the supply channel 130.

For example, the bubble accumulation chamber 520 and the debubbling unit 770 may be disposed vertically above the ink tank 2, the first supply path 111, the second supply path 112, the third supply path 910, the filter 110, the pressure chamber 12, or the like. The bubble accumulation chamber 520 and the debubbling unit 770 may not necessarily be disposed vertically above a fluid communication portion such as the supply channel 130. The bubble accumulation chamber 520 may communicate with the fluid communication portion sideways and the debubbling unit 770 may be formed to extend sideways from the bubble accumulation chamber 520 as long as the configuration can collect bubbles and cause the bubbles to contact the gas permeable membrane 710. The same applies to cases where bubble accumulation chambers 520 and debubbling units 770 are disposed at a plurality of locations on fluid communication portions other than the supply channel 130 and the first recovery channel 140.

### <Fourth Modification of Circulation Path>

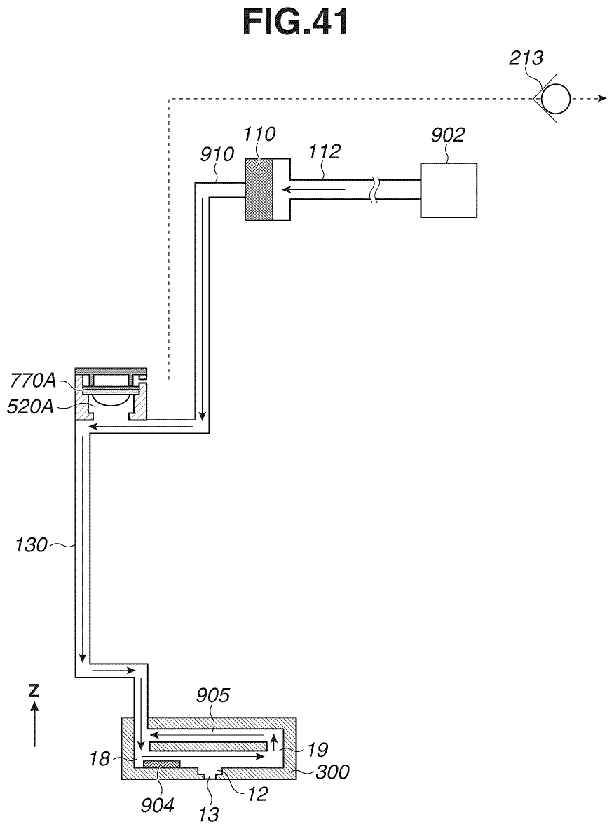

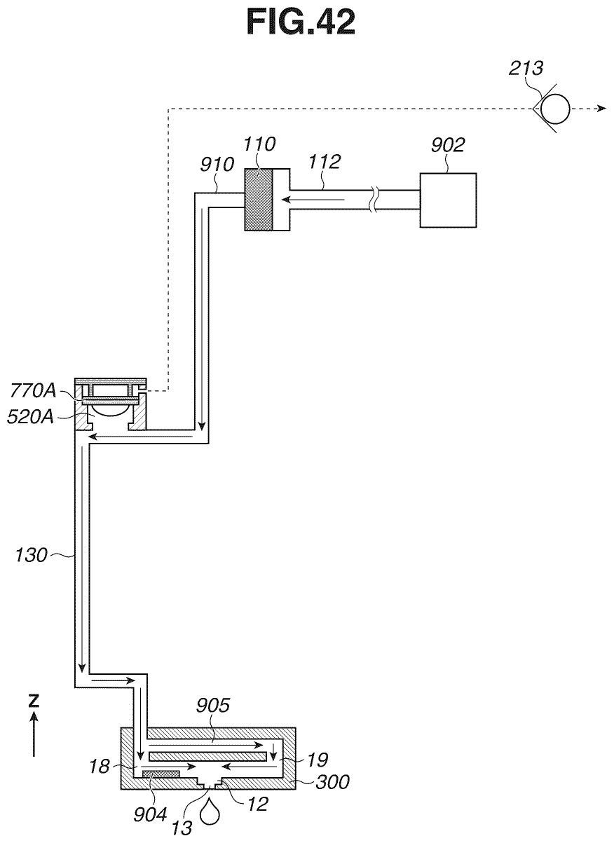

FIGS. 41 and 42 are diagrams schematically illustrating a fourth modification of the circulation path. FIG. 41 illustrates the circulation path when circulation is performed without discharge. FIG. 42 illustrates the circulation path when high-duty recording is performed. The fourth modification of the circulation path is an example without the first pressure adjustment unit 120, the second pressure adjustment unit 150, the second bubble accumulation chamber 520B, the circulation pump 500, the bypass channel 160, and the first recovery channel 140. The fourth modification of the circulation path is an example where the third pressure adjustment unit 902 communicating with the second supply path 112, the heating circulation pump 904 located between the supply channel 130 and the pressure chamber 12, and the second recovery channel 905 establishing communication between the pressure chamber 12 and the supply channel 130 are provided. In the fourth modification of the circulation path, ink flow similar to that in FIGS. 33 and 35 occurs. The second supply path 112, the third supply path 910, the supply channel 130, and the pressure chamber 12 are pressure-controlled by the third pressure adjustment unit 902, whereby stable ink discharge is achieved.

The third pressure adjustment unit 902 is located outside the liquid discharge head 1, and communicates with the third supply path 910 of the liquid discharge head 1 via the second supply path 112. An example of the third pressure adjustment unit 902 is a hydraulic head system using hydraulic head difference. However, any other appropriate system can also be applied. This modification is applicable to both ink cartridge systems and ink supply systems such as CISS.

The first bubble accumulation chamber 520A is disposed vertically above the supply channel 130 to fluidly communicate with the supply channel 130. The first debubbling unit 770A is formed to extend vertically above the first bubble accumulation chamber 520A. Bubbles mixed in the ink in the first pressure adjustment unit 120, the supply channel 130, the second recovery channel 905, and the like can thus be collected in the bubble accumulation chamber 520 through circulation and discharge operations, and expelled from the ink by debubbling operation. Examples of the bubbles mixed in the ink include the foregoing upstream bubbles, evolved bubbles, and unexpected bubbles. However, this is not restrictive, and bubbles in an amount that can be collected in the bubble accumulation chamber 520 and for which a sufficient debubbling speed is obtainable can be expelled from the ink. This can significantly reduce the possibility of intrusion of bubbles to the nozzle 13.

The first debubbling unit 770A communicates with the ink supply unit 400 in the main body unit of the liquid discharge apparatus 50, and is depressurized by the operation of the ink supply unit 400. Moreover, the third check valve 213 is disposed between the debubbling unit 770 and the ink supply unit 400, and the depressurized state is maintained even without the main body unit of the liquid discharge apparatus 50 constantly operating. This enables debubbling operation.

The third check valve 213 may be disposed in the third air channel 113 between the first debubbling unit 770A and the ink supply unit 400.

Two or more bubble accumulation chambers 520 and two or more debubbling units 770 may be provided. The bubble accumulation chamber 520 and the debubbling unit 770 may not even be disposed on the supply channel 130.

For example, the bubble accumulation chamber 520 and the debubbling unit 770 may be disposed vertically above the ink tank 2, the first supply path 111, the second supply path 112, the third supply path 910, the filter 110, the pressure chamber 12, the second recovery channel 905, or the like. The bubble accumulation chamber 520 and the debubbling unit 770 may not necessarily be disposed vertically above a fluid communication portion such as the supply channel 130.

The bubble accumulation chamber 520 may communicate with the fluid communication portion sideways and the debubbling unit 770 may be formed to extend sideways from the bubble accumulation chamber 520 as long as the configuration can collect bubbles and cause the bubbles to contact the gas permeable membrane 710. The same applies to cases where bubble accumulation chambers 520 and debubbling units 770 are disposed at a plurality of locations on fluid communication portions other than the supply channel 130 and the first recovery channel 140.

The heating circulation pump 904 performs ink delivery through a similar operation as in FIGS. 34A to 34D. The heating circulation pump 904 may not be disposed between the supply channel 130 and the pressure chamber 12, and may be disposed between the pressure chamber 12 and the second recovery channel 905.

### <Fifth Modification of Circulation Path>

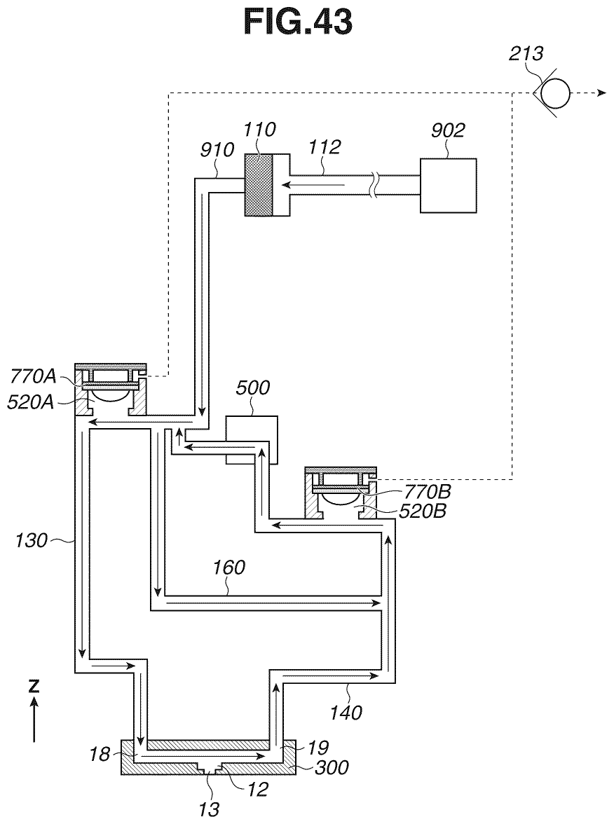

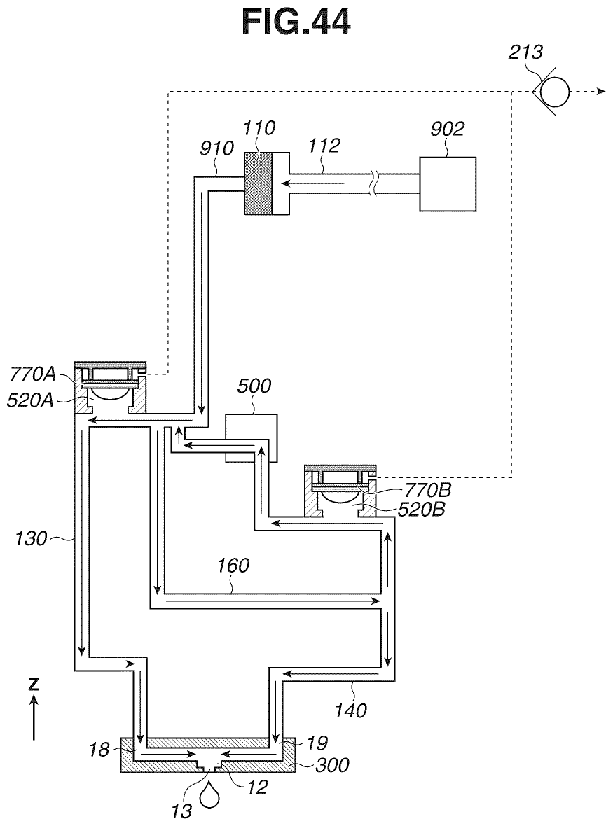

FIGS. 43 and 44 are diagrams schematically illustrating a fifth modification of the circulation path. FIG. 43 illustrates the circulation path when circulation is performed without discharge. FIG. 44 illustrates the circulation path when high-duty recording is performed. The fifth modification of the circulation path is an example where the first pressure adjustment unit 120 and the second pressure adjustment unit 150 are not provided, and the bypass channel 160 and the first recovery channel 140 are directly connected.

In the fifth embodiment of the circulation path, assume that the channel resistance of the channel where ink flows to the first recovery channel 140 via the bypass channel 160 is R1, and the channel resistance of the channel where ink flows from the supply channel 130 to the first recovery channel 140 via the discharge module 300 is R2. Since the flow rate of ink flowing through each channel is inversely proportional to the channel resistance, the ratio of the flow rate of ink through the channel via the bypass channel 160 to that of ink through the channel via the discharge module 300 is R2 to R1. Based on this relationship, the channel resistances are set to implement an amount of circulation that can prevent ink thickening near the nozzle 13 in the discharge module 300. More specifically, the channel resistances are set so that the ink flow speed in the pressure chamber 12 is higher than or equal to a predetermined flow speed. The channel resistance R1 of the channel via the bypass channel 160 is controlled by changing the cross-sectional area or length of the channel, by providing a restriction in the channel, etc.

Even in the fifth modification of the circulation path, when recording operations are performed at high duty, the pressure chamber 12 is supplied with ink from both sides as illustrated in FIG. 44. More specifically, the ink supplied from the third supply path 910 to the supply channel 130 is supplied to the nozzle 13 of the discharge module 300. Meanwhile, part of the ink supplied from the third supply path 910 to the bypass channel 160 is supplied to the third supply path 910 via the circulation pump 500. Part of the ink supplied from the third supply path 910 to the bypass channel 160 is supplied to the first recovery channel 140, and supplied to the nozzle 13 of the discharge module 300. The ink to be discharged from the nozzle 13 is thus supplied from both the supply channel 130 and the first recovery channel 140.

The third pressure adjustment unit 902 is located outside the liquid discharge head 1, and communicates with the third supply path 910 of the liquid discharge head 1 via the second supply path 112. An example of the third pressure adjustment unit 902 is a hydraulic head system using hydraulic head difference. However, any other appropriate system can also be applied. This modification is applicable to both ink cartridge systems and ink supply systems such as CISS.

The first bubble accumulation chamber 520A is disposed vertically above the supply channel 130 to fluidly communicate with the supply channel 130. The first debubbling unit 770A is formed to extend vertically above the first bubble accumulation chamber 520A. The second bubble accumulation chamber 520B is disposed vertically above the first recovery channel 140 to fluidly communicate with the first recovery channel 140. The second debubbling unit 770B is formed to extend vertically above the second bubble accumulation chamber 520B. Bubbles mixed in the ink in the supply channel 130, the first recovery channel 140, the pump inlet channel 170, the pump outlet channel 180, and the like can thus be collected in the bubble accumulation chambers 520 through circulation and discharge operations, and expelled from the ink by debubbling operation. Examples of the bubbles mixed in the ink include the foregoing upstream bubbles, evolved bubbles, and unexpected bubbles. However, this is not restrictive, and bubbles in an amount that can be collected in the bubble accumulation chamber 520 and for which a sufficient debubbling speed is obtainable can be expelled from the ink. This can significantly reduce the possibility of intrusion of bubbles to the nozzle 13.

The first debubbling unit 770A and the second debubbling unit 770B communicate with the ink supply unit 400 in the main body unit of the liquid discharge apparatus 50, and are depressurized by the operation of the ink supply unit 400.

Moreover, the third check valve 213 is disposed between the debubbling units 770 and the ink supply unit 400, and the depressurized state is maintained even without the main body unit of the liquid discharge apparatus 50 constantly operating. This enables debubbling operation. Third check valves 213 may be disposed at the respective branches of the third air channel 113 between the ink supply unit 400 and the first and second debubbling units 770A and 770B. A third check valve 213 may be disposed at the integral portion of the third air channel 113 between the ink supply unit 400 and the first and second debubbling units 770A and 770B.

The bubble accumulation chamber 520 and the debubbling unit 770 may not be disposed on both the supply channel 130 and the first recovery channel 140, and may be disposed on the supply channel 130 alone or the first recovery channel 140 alone. Three or more bubble accumulation chambers 520 and three or more debubbling units 770 may be provided. The bubble accumulation chamber 520 and the debubbling unit 770 may not even be disposed on the supply channel 130 or the first recovery channel 140. For example, the bubble accumulation chamber 520 and the debubbling unit 770 may be disposed vertically above the ink tank 2, the first supply path 111, the second supply path 112, the third supply path 910, or the like. The bubble accumulation chamber 520 and the debubbling unit 770 may be disposed vertically above the filter 110, the pump inlet channel 170, the pump outlet channel 180, the bypass channel 160, the pressure chamber 12, or the like. The bubble accumulation chamber 520 and the debubbling unit 770 may not be disposed vertically above a fluid communication portion such as the supply channel 130. The bubble accumulation chamber 520 may communicate with the fluid communication portion sideways and the debubbling unit 770 may be formed to extend sideways from the bubble accumulation chamber 520 as long as the configuration can collect bubbles and cause the bubbles to contact the gas permeable membrane 710. The same applies to cases where bubble accumulation chambers 520 and debubbling units 770 are disposed at a plurality of locations on fluid communication portions other than the supply channel 130 and the first recovery channel 140.

### <Sixth Modification of Circulation Path>

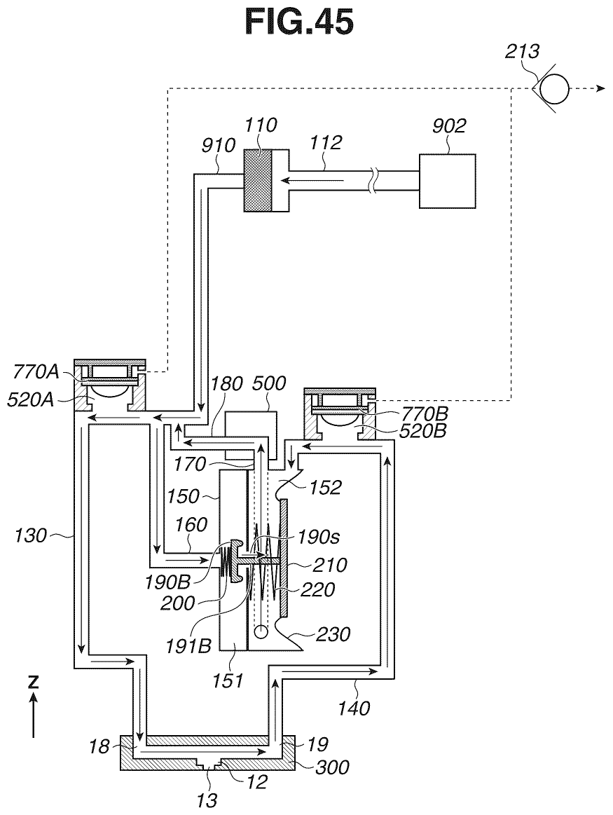

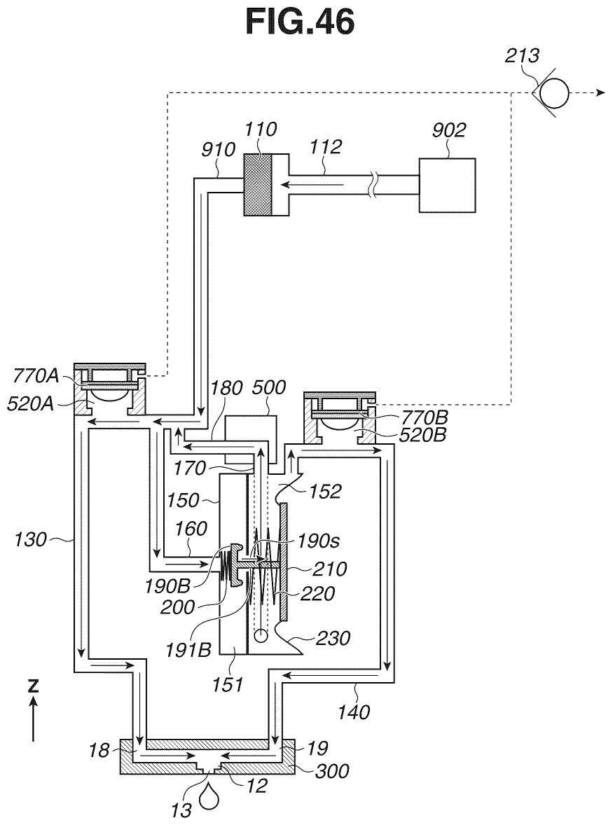

FIGS. 45 and 46 are diagrams schematically illustrating a sixth modification of the circulation path. FIG. 45 illustrates the circulation path when circulation is performed without discharge. FIG. 46 illustrates the circulation path when high-duty recording is performed. The sixth modification of the circulation path is an example where the first pressure adjustment unit 120 is not provided, and the third pressure adjustment unit 902 communicating with the second supply path 112 is provided.

Even in the sixth modification of the circulation path, when recording operations are performed at high duty, the pressure chamber 12 is supplied with ink from both sides as illustrated in FIG. 46. More specifically, the ink supplied from the third supply path 910 to the supply channel 130 is supplied to the nozzle 13 of the discharge module 300. Meanwhile, part of the ink supplied from the third supply path 910 to the bypass channel 160 is supplied to the third supply path 910 via the second pressure adjustment unit 150, the pump inlet channel 170, the circulation pump 500, and the pump outlet channel 180. Part of the ink supplied to the bypass channel 160 is supplied to the first recovery channel 140 via the second pressure adjustment unit 150, and supplied to the nozzle 13 of the discharge module 300. In this state, the ink to be discharged from the nozzle 13 is thus supplied from both the supply channel 130 and the first recovery channel 140.

The third pressure adjustment unit 902 is located outside the liquid discharge head 1, and communicates with the third supply path 910 of the liquid discharge head 1 via the second supply path 112. An example of the third pressure adjustment unit 902 is a hydraulic head system using hydraulic head difference. However, any other appropriate system can also be applied. This modification is applicable to both ink cartridge systems and ink supply systems such as CISS.

The first bubble accumulation chamber 520A is disposed vertically above the supply channel 130 to fluidly communicate with the supply channel 130. The first debubbling unit 770A is formed to extend vertically above the first bubble accumulation chamber 520A. The second bubble accumulation chamber 520B is disposed vertically above the first recovery channel 140 to fluidly communicate with the first recovery channel 140. The second debubbling unit 770B is formed to extend vertically above the second bubble accumulation chamber 520B. Bubbles mixed in the ink in the second pressure adjustment unit 150, the supply channel 130, the first recovery channel 140, the pump outlet channel 180, and the like can thus be collected in the bubble accumulation chambers 520 through circulation and discharge operations, and expelled from the ink by debubbling operation. Examples of the bubbles mixed in the ink include the foregoing upstream bubbles, evolved bubbles, and unexpected bubbles. However, this is not restrictive, and bubbles in an amount that can be collected in the bubble accumulation chamber 520 and for which a sufficient debubbling speed is obtainable can be expelled from the ink. This can significantly reduce the possibility of intrusion of bubbles to the nozzle 13.

The first debubbling unit 770A and the second debubbling unit 770B communicate with the ink supply unit 400 in the main body unit of the liquid discharge apparatus 50, and are depressurized by the operation of the ink supply unit 400.

Moreover, the third check valve 213 is disposed between the debubbling units 770 and the ink supply unit 400, and the depressurized state is maintained even without the main body unit of the liquid discharge apparatus 50 constantly operating. This enables debubbling operation. Third check valves 213 may be disposed at the respective branches of the third air channel 113 between the ink supply unit 400 and the first and second debubbling units 770A and 770B. A third check valve 213 may be disposed at the integral portion of the third air channel 113 between the ink supply unit 400 and the first and second debubbling units 770A and 770B.

The bubble accumulation chamber 520 and the debubbling unit 770 may not be disposed on both the supply channel 130 and the first recovery channel 140, and may be disposed on the supply channel 130 alone or the first recovery channel 140 alone. Three or more bubble accumulation chambers 520 and three or more debubbling units 770 may be provided. The bubble accumulation chamber 520 and the debubbling unit 770 may not even be disposed on the supply channel 130 or the first recovery channel 140. For example, the bubble accumulation chamber 520 and the debubbling unit 770 may be disposed vertically above the ink tank 2, the first supply path 111, the second supply path 112, the third supply path 910, or the like. The bubble accumulation chamber 520 and the debubbling unit 770 may be disposed vertically above the filter 110, the pump inlet channel 170, the pump outlet channel 180, the bypass channel 160, the pressure chamber 12, or the like. The bubble accumulation chamber 520 and the debubbling unit 770 may not be disposed vertically above a fluid communication portion such as the supply channel 130. The bubble accumulation chamber 520 may communicate with the fluid communication portion sideways and the debubbling unit 770 may be formed to extend sideways from the bubble accumulation chamber 520 as long as the configuration can collect bubbles and cause the bubbles to contact the gas permeable membrane 710. The same applies to cases where bubble accumulation chambers 520 and debubbling units 770 are disposed at a plurality of locations on fluid communication portions other than the supply channel 130 and the first recovery channel 140.

### <Other Modifications of Circulation Path>

Next, other examples of the circulation path will be described. As described above, the configuration for allowing ink backflow from the first recovery channel 140 to the pressure chamber 12 may only include the bypass channel 160. Moreover, the configuration for allowing ink backflow from the first recovery channel 140 to the pressure chamber 12 needs to be free of a mechanism that functions as a check valve between the integral portion of the bypass channel 160 and the pressure chamber 12. Any circulation path that can maintain this relationship enables ink supply to the pressure chamber 12 from both sides, whereby discharge stability can be improved.

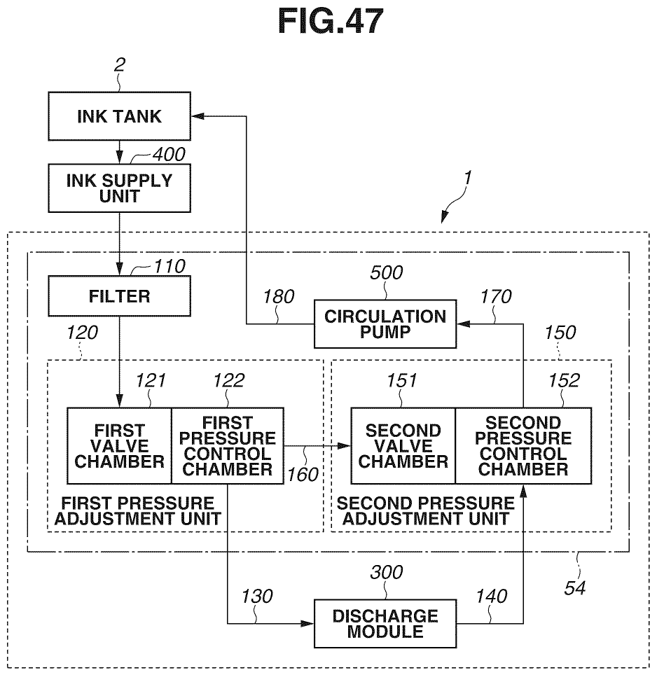

FIGS. 47, 48, and 49 are block diagrams schematically illustrating other modifications of the circulation path. In FIGS. 47, 48, and 49, the debubbling unit 770 and the gas channels connected to the debubbling unit 770 (such as the third air channel 113) are omitted.

FIG. 47 illustrates an example where the pump outlet channel 180 located downstream of the circulation pump 500 is configured to connect to the ink tank 2 rather than to the first pressure control chamber 122. This configuration can also improve discharge stability as with the configurations described so far.

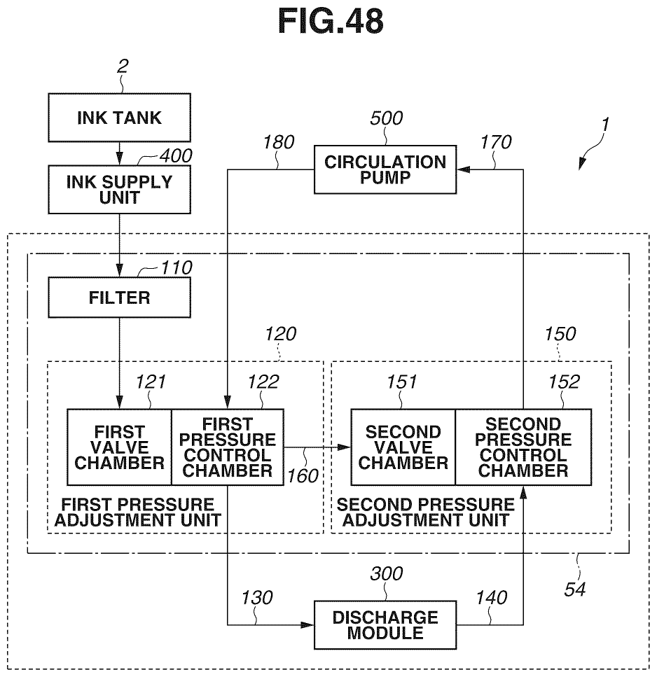

FIG. 48 illustrates an example where the circulation pump 500, which has been included in the liquid discharge head 1, is disposed in the main body unit of the liquid discharge apparatus 50. The pump inlet channel 170 and the pump outlet channel 180 are also located in part outside the liquid discharge head 1. This configuration can also improve discharge stability as with the configurations described so far.

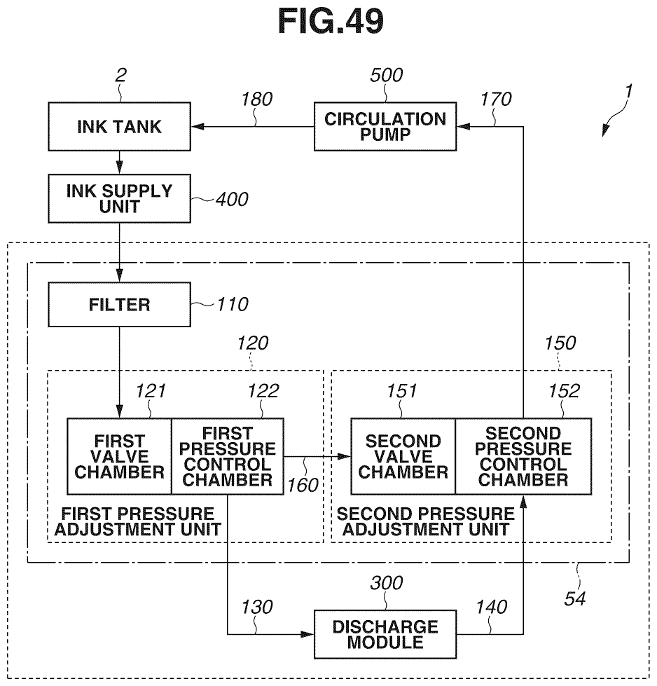

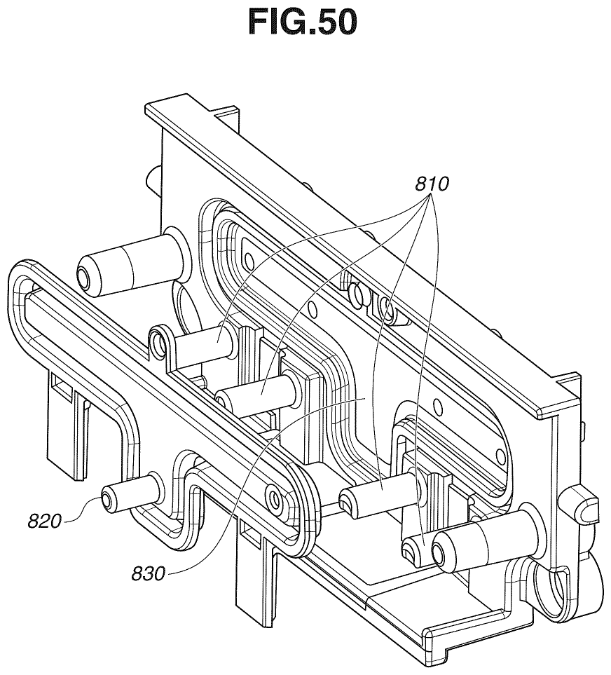

FIG. 49 illustrates an example where the circulation pump 500, which has been included in the liquid discharge head 1, is disposed in the main body unit of the liquid discharge apparatus 50, and the pump outlet channel 180 is connected to the ink tank 2. This configuration can also improve discharge stability as with the configurations described so far.

### Other Modifications

The liquid discharge head 1 illustrated in FIG. 1A is described by using a serial liquid discharge head, which discharges ink while moving in the main scanning direction, as an example. However, this is not restrictive.

The liquid discharge head may be a full-line liquid discharge head in which nozzles are formed across the entire width of the recording medium P and that can discharge ink across the entire width of the recording medium P without moving in the main scanning direction.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-203065, filed Nov. 21, 2024, which is hereby incorporated by reference herein in its entirety.

What is claimed is:

1. A liquid discharge apparatus comprising:
a liquid discharge head including a liquid storage chamber configured to store liquid and a liquid discharge unit configured to discharge the liquid supplied from the liquid storage chamber;
a connection unit for the liquid discharge head; and
a depressurization mechanism communicating with the connection unit,
wherein the connection unit includes a liquid channel configured to supply the liquid to the liquid storage chamber and a gas channel communicating with the depressurization mechanism,
wherein the gas channel includes a valve member configured to switch gas communication between a closed state and an open state, and a biasing member configured to bias the valve member from the open state to the closed state, and
wherein the valve member is configured so that its closed state and open state are switched by the depressurization mechanism pressurizing or depressurizing part of the gas channel.

2. The liquid discharge apparatus according to claim 1, further comprising a control mechanism configured to control pressurization or depressurization of the depressurization mechanism.

3. The liquid discharge apparatus according to claim 2, wherein the control mechanism is configured to switch the valve member from the closed state to the open state against biasing force of the biasing member by depressurizing the part of the gas channel.

4. The liquid discharge apparatus according to claim 1,
wherein the liquid discharge head further includes:
a nozzle configured to discharge the liquid;
a pressure chamber including an energy generation element configured to generate energy for discharging the liquid from the nozzle;
the liquid storage chamber configured to store the liquid to be supplied to the pressure chamber, the liquid storage chamber communicating with an end of the pressure chamber;
a bubble accumulation chamber configured to hold bubbles inside, the bubble accumulation chamber fluidly communicating with the liquid storage chamber, and
a depressurization chamber adjoining the bubble accumulation chamber via a gas permeable membrane, the depressurization chamber being connected to the gas channel.

5. The liquid discharge apparatus according to claim 4, wherein the depressurization mechanism is configured to simultaneously depressurize the depressurization chamber and the gas channel.
